(19) United States
(12) Patent Application Publication
(10) Pub. No.: US 2026/0220939 A1
(43) Pub. Date: Jul. 30, 2026

(54) SYSTEMS AND METHODS FOR LEARNING EMOTION REPRESENTATIONS FROM VERBAL AND NONVERBAL COMMUNICATION

(71) Applicant: THE PENN STATE RESEARCH FOUNDATION, University Park, PA (US)

(72) Inventors: James Z. Wang, State College, PA (US); Chenyan Wu, University Park, PA (US); Sitao Zhang, State College, PA (US); Yimu Pan, State College, PA (US)

(73) Assignee: THE PENN STATE RESEARCH FOUNDATION, University Park, PA (US)

(21) Appl. No.: 19/144,595

(22) PCT Filed: Jan. 2, 2024
(86) PCT No.: PCT/US2024/010057

§ 371 Date: Jun. 30, 2025

Related U.S. Application Data
(60) Provisional application No. 63/478,248, filed on Jan. 3, 2023.

(51) Int. Cl. G06V 20/40; G06F 18/25; G06N 3/0455; G06N 3/048; G06V 40/16

(52) U.S. Cl. CPC G06V 20/41; G06F 18/251; G06N 3/0455; G06N 3/048; G06V 40/174

(57) ABSTRACT

Systems and methods for understanding emotions, including static and dynamically changing emotional states, from verbal and nonverbal communication, using only uncurated data are provided herein. Systems and methods for bodily expressed emotion understanding (BEEU), incorporating motor element analysis, are also provided herein. Systems and methods for context-aware emotion recognition in an uncontrolled real-world setting allowing for simultaneous processing of multiple subjects of interest within a single scene are also provided herein.

### CROSS REFERENCE TO RELATED APPLICATION

This application claims priority from provisional Patent Application No. 63/478,248, filed on Jan. 3, 2023, the entire content of which is incorporated herein by reference in their entirety.

### BACKGROUND

If artificial intelligence (AI) can be equipped with emotional intelligence (EQ), it will be a significant step toward developing the next generation of artificial general intelligence. The ability to understand, use, and express emotions will significantly facilitate the interaction of AI with humans and the environment, making it the foundation for a wide variety of HCl, robotics, and autonomous driving.

Facial expression recognition has been well studied in the field of emotion recognition. Recently, with the growing interest in recognizing emotion in the wild, the focus of research has gradually shifted to modeling body language and context. To the best of our knowledge, there are no pre-trained models or effective methods for leveraging unlabeled data in the domain of visual emotion recognition.

With the development of the Body Language Dataset (BoLD), a large-scale in-the-wild dataset for bodily expressed emotion, and the corresponding benchmark deep neural network models, research on emotion recognition has increasingly focused on bodily expressed emotion understanding (BEEU), which aims to automatically recognize emotional expressions from body movements.

BEEU presents a challenging task for artificial emotional intelligence due to several factors. Firstly, it is difficult to collect a large, accurately labeled affective dataset for training deep learning models because emotion interpretation is highly subjective. Secondly, the context, such as surrounding information and activities, must be considered to correctly interpret a person's bodily expressed emotion. Thirdly, emotion interpretation may depend on the demographics of both the observed person and the observer. Fourthly, the concept of emotion is not well-defined in psychology, making it difficult to develop a specific algorithm to detect a specific emotion. As a result, the gap between low-level pixel information and high-level emotion labels is too large for straightforward data-driven approaches, and it is necessary to develop intermediate representations to assist AI in bridging this gap.

Deciphering emotional states within dynamic, unscripted environments is not only a technical challenge but also a foundational step toward enabling machines with the ability to engage in meaningful social interactions.

Conventional approaches to emotion recognition, while effective, face notable limitations that impede their applications in dynamic, real-life environments. A primary issue is the absence of a unified, single-stage approach. Instead of solely using images as inputs, existing methods heavily depend on extra pre-computed features such as depth maps, human poses, facial landmarks, and detected objects.

This multi-stage process diminishes the efficiency and simplicity of the process, deviating from the intuitive way humans perceive emotions. Furthermore, the interaction between multiple individuals in a scene is inadequately modeled. Existing approaches often treat each individual in an image as a separate entity, overlooking the influence of others' emotions on the overall context. They fail to leverage valuable label information during training and are less efficient during inference, as it requires multiple runs for scenes with several individuals. The common practice of isolating individuals from the scene for independent analysis is not only computationally inefficient but also results in a loss of contextual connectivity, further diminishing their effectiveness in practical applications.

### SUMMARY OF THE INVENTION

The present application relates to systems and methods for extracting visual emotion representations and understanding emotions, including static and dynamically changing emotional states, from verbal and nonverbal communication, using only uncurated data, either stored or live visual information. Compared to numerical annotated labels or descriptions used in previous methods, communication naturally contains emotion information. Moreover, learning emotion representations from communication aligns more with the human learning process.

To implement the present systems and methods, a dataset is created containing paired nonverbal and verbal information. Each pair of nonverbal and verbal information is from the same individual. The systems and methods described herein attend to nonverbal emotion cues through subject-aware context encoding taking into account interaction between a subject of interest and a corresponding context and verbal emotion cues utilizing a sentiment-guided contrastive learning to learn a consistency between the nonverbal input and the associated verbal input by minimizing a sentiment-guided contrastive loss [symbol] for understanding emotions. Extensive experiments demonstrate the effectiveness and transferability of the systems and methods described herein; using merely linear-probe evaluation protocol, the systems and methods described herein outperform the state-of-the-art supervised visual emotion recognition methods and competes with many multimodal methods on various benchmarks. The systems and methods described herein address the problem of data scarcity in emotion understanding, thereby promoting the development of related fields.

The nonverbal emotion cues may comprise facial expression, body language, and contextual environment. The verbal emotion cues may comprise utterance and dialogue. Communication can be from stored images or from both stored and live images.

The systems and methods described herein are not limited to humans and may be applied to non-human such as dogs, cats, chimpanzee, etc.

The systems and methods described herein are not limited to understanding static emotional states and can be applied to understand dynamic emotional state changes.

The subject-aware context encoding strategy may comprise applying subject-aware attention masking (SAAM) which avoids redundant encoding or applying subject-aware prompting (SAP) which enable adaptive modeling of interaction between the context and subject by providing necessary prompt indicating location of a subject in a frame.

In one embodiment, the method for processing the nonverbal input comprises a method of bodily expressed emotion understanding (BEEU), using a BEEU dataset consisting of video clips each having emotion category labels, enhanced by using a body motor elements dataset (BoME) consisting of a second set of video clips each annotated with motor element labels as an additional training source. Because the body motor elements have a relationship with emotion categories, a deep neural network can be trained on the BEEU dataset and the BoME dataset to recognize the body motor elements and use the body motor elements as intermediate features to recognize the emotion categories.

The present invention further provides a system, comprising a processing device and a non-transitory, computer-readable storage medium communicatively coupled to the processing device, the non-transitory, computer-readable storage medium comprising one or more programming instructions thereon that, when executed, cause the processing device to perform the method according to any one of claims 1-8.

The present invention further provides a non-transitory, computer-readable storage medium comprising programming instructions thereon that, when executed by a processing device, cause the processing device to perform the method according to any one of claims 1-8.

The systems and method provided herein further relate to bodily expressed emotion understanding (BEEU), for both static and dynamically changing emotional states, and from stored or live visual information, incorporating motor element analysis. Preliminary psychological research demonstrated a strong relationship between motor elements and emotions.

For this purpose, a body motor elements dataset (BoME) is created consisting of a set of video clips each annotated with motor element labels. Any movement model can be used. For illustrative purpose, as a non-limiting example, the Laban Movement Analysis (LMA), the most internationally recognized system for describing and comprehending human bodily movement, is adopted.

Each segment of movement is composed of several motor elements. Different movements performed by different individuals may share the same set of motor elements. By recognizing these elements, movements can be coded. Due to the fact that LMA elements have a more objective definition than emotion categories, as the presence of LMA elements in a human video depends solely on the body movement, whereas emotion labels may also be influenced by the annotators' emotional state, incorporating the human movement features learned from BoME into BEEU can enhances bodily expressed emotion understanding. In summary, emotion and LMA element labels are related, and LMA element labels are easier for deep neural networks to learn.

Furthermore, once a machine learns to recognize the relevant motor elements, it can identify them in any type of movement, even those not seen during training.

A deep neural network is trained and test on the BEEU benchmark dataset-body language dataset (BoLD), using the BoME dataset as an additional training source, to recognize the body motor elements and use the body motor elements as intermediate features to recognize the emotion categories. In order to enhance BEEU by using the BoME dataset as an additional source of supervision, a dual-branch, dual-task network including an emotion branch and a motor element branch is designed, whose branches produce predictions for bodily expressed emotion and LMA labels, respectively and concurrently. To effectively utilize the movement representation in emotion recognition, the LMA branch features are merged into the emotion branch. A fusion operation is deployed by adding the motor element labels as input to emotion recognition of the emotion branch, whereby the emotion category labels are predicted with the assistance of motor element branch.

A bridge loss is used to allow the motor element labels to supervise emotion prediction, based on the correspondence between the body motor elements and the emotion categories. A threshold in the bridge loss is provided to control an extent to which the motor element labels supervises the emotion prediction. “Supervision” in the context of machine learning refers to the method by which a model is trained on a dataset that includes both the input data and the corresponding correct outputs (or “labels”). Here, the motor element labels are used to train the model for emotion prediction.

In one example, eleven LMA element labels are used and each label is assigned a discrete score from a multi-value scale.

The deep neural network may comprise a video recognition network such as RGB-based or skeleton-based algorithms.

The present invention further provides a system, comprising a processing device and a non-transitory, computer-readable storage medium communicatively coupled to the processing device, the non-transitory, computer readable storage medium comprising one or more programming instructions thereon that, when executed by the processing device, cause the processing device to perform the method according to any one of claims 11-16.

The systems and methods disclosed herein can not only be applied to a subject of interest in an image, but also can be applied to a crowd or a plurality of subjects of interest in a single image using context-aware emotion recognition.

The systems and methods provided herein further relate to context-aware emotion recognition in an uncontrolled real-world setting allowing for simultaneous processing of multiple subjects of interest within a single scene.

To achieve this goal, transformers representing a class of neural networks that rely on attention mechanisms are used. A transformer may comprise a unified encoder and a context-aware decoder. A unified encoder may comprise an image encoder for extracting spatial features of the entire image in a single operation regardless of the number of subjects of interest present within the image and a prompt encoder embedding the positional information of each subject of interest in the image. The context-aware decoder may be configured to simultaneously decode emotions of all subjects in a parallel manner using the spatial features and positional prompts.

Regardless of the number of subjects of interest present within the image, relevant spatial features are retrieved in a parallel manner for each subject and context query from the image, by a cross-attention operation. The embedded positional prompts serve to direct a decoder to correspond to the specific subject of interest and discriminate it from others present in the image, thereby using a single self-attention operation to capture both inter-subject and subject-context dynamics.

### BRIEF DESCRIPTION OF THE DRAWINGS

FIG. 1 is an illustration that emotions emerge naturally in human communication through verbal and nonverbal cues;

FIG. 2 is an Illustration of EmotionCLIP;

FIG. 3 shows that traditional approaches (on the left) ignore the dependencies between context and subject, and encode a portion of the image redundantly, while the approaches of the present invention (right two diagrams) efficiently model the subject and context in a synchronous way;

FIG. 4 is a sample batch where both the positive pair (first) and the false negative pair (fourth) exist. The bar 1 and bar 2 represent the similarity between all text and the positive video before and after reweighting;

FIGS. 5A and 5B are plots showing the effect of applying subject-aware attention masking until different self-attention layers in the frame encoder;

FIG. 6 shows attention weights for the HMN token from layer 1-4 (left to right) of the frame encoder in one trained network (Each row represents one frame. The green and yellow spots are the high-attention areas);

FIGS. 7A and 7B are plots showing the effect of varying the strength of reweighting in SNCE (The larger the B, the stronger the suppression of negative samples);

FIG. 8 is a plot showing the distribution of the neutral scores on the TV dataset;

FIG. 9 is a plot showing the effect of filtering with neutral scores on sample size and model performance;

FIGS. 10A-10F are plots showing the effect of filtering out text with a neutral score greater than 0.05 on the distribution of the predicted probability of other emotion categories;

FIG. 11 are video clips showing examples from TV Dataset;

FIG. 12 shows a word cloud generated from the collected TV dataset;

FIG. 13 is video clips showing the attention weights for HMN token at layer 1-4 (left to right) for each frame (Note that changing the bounding box location causes the attention weights to change accordingly);

FIG. 14 is video clips showing the attention weights for CLS token at layer 1-4 (left to right) for each frame (Note that changing the bounding box location does not change the attention weight);

FIGS. 15A-15D are video clips showing the different failure cases for the attention weights of HMN token at layer 1-4 (left to right) for each frame in BoLD dataset. (A) The bounding boxes are absent (B) The subjects are partially off the frame (C) The subjects bounding boxes are incorrect (D) The subjects are too small.

FIGS. 16A-16D are example video clips from the BoME dataset. (A) Head-drop, Arms-to-upper-body, (B) Sink, Head-drop, (C) Head-drop, Arms-to-upper-body, (D) Spread, Up and Rise;

FIG. 17 is a plot showing distribution of the five-level labels for each LMA element;

FIG. 18 is a bar plot on emotion category counts;

FIG. 19 is a graph showing correlation among LMA elements and emotions;

FIGS. 20A and 20B are illustrations of RGB-based and skeleton-based pipelines for estimating the LMA elements. (FIG. 20A: the RGB-based pipeline extracts frames from the input clip, crops the target human, and feeds the resultant frames into a neural network. FIG. 20B: the Skeleton-based pipeline leverages the 2D/3D human pose extracted from the frames as the input for a neural network. The figure incorporates frames from the film ‘Wagner’ (1983, directed by Tony Palmer));

FIG. 21 shows example LMA element estimation results on the BoME dataset;

FIGS. 22A-22J are precision-recall curves for various models on ten LMA elements (The x-axis represents the recall, and the y-axis represents the precision. The AP (Average Precision) score of the corresponding model is indicated in parentheses after the model name in the legend);

FIG. 23 is an illustration of the framework of the proposed Movement Analysis Network (MANet);

FIG. 24 shows example bodily expressed emotion understanding results on the BoLD validation set;

FIGS. 25A and 25B are precision-recall curves for sadness and happiness on the BoLD validation set (Models of Baseline-1, Baseline-2, and Ours are identical to those in FIG. 24);

FIGS. 26A-26B show comparison of different formulations for context-aware emotion recognition. (FIG. 26A: The conventional multi-stage approach isolates individual subjects with manual cropping, leading to computational redundancy and contextual disconnection. FIG. 26B: the present end-to-end approach simultaneously decodes the emotions of all subjects within the scene based on the context and positional prompts, thereby increasing efficiency and capturing subtle contextual relationships);

FIG. 27 is an illustration of the proposed TRACER model;

FIG. 28 is an illustration of the context-aware decoder;

FIG. 29 The visualization on attention maps of spatial feature retrieval per decoder layer. It's clear that the model can retrieve emotion-related spatial features from the scene with the guidance of positional prompts; and

FIG. 30 is a diagram illustrating hardware components of a computer device according to an embodiment of the present invention.

### DETAILED DESCRIPTION OF THE INVENTION

### Overview

A. Learning Emotion Representations from Verbal and Nonverbal Communication

Emotion understanding is an essential but challenging component of artificial general intelligence. The absence of extensive annotated datasets has significantly impeded advancements in this field.

Inspired by how humans comprehend emotions, the present invention provides a new paradigm for emotion understanding that learn directly from human communication how they express their emotions by exploring the consistency between verbal and nonverbal affective cues of the same individuals in daily communication. The present invention provides a pre-training paradigm to extract visual emotion representations from verbal and nonverbal communication using only uncurated data. Examples of the verbal expressions include utterance and dialogue. Examples of nonverbal expressions include facial expression, body language, and contextual environment. Communication naturally contains emotion information. Acquiring emotion representations from communication is more congruent with the human learning process. The paradigm of the present invention attends to nonverbal emotion cues through subject-aware context encoding and verbal emotion cues using sentiment-guided contrastive learning. These techniques enable the model to precisely capture and understand emotional expressions in a way that mirrors human learning.

The present method bypasses the problems in emotion data collection by leveraging uncurated data from daily communication. Limited by the data collection strategy, existing datasets usually only contain annotations for a limited number of emotion categories, which is far from covering the space of human emotional expression. Moreover, the categorical labels commonly used in existing datasets fail to precisely represent the magnitude or intensity of a certain emotion. In the present method, use of verbal expressions preserves fine-grained semantics to the greatest extent possible. The present approach also provide a way to directly model expressed emotion instead of perceived emotion.

B. Context-Aware Emotion Recognition with Transformers

Emotion recognition in real-world environments presents a distinct challenge compared to controlled, laboratory settings. Such natural scenarios often involve multiple individuals, each interacting with others and the surroundings, forming a complex tapestry of relationships known as context. A further paradigm of the present invention, i.e., TRACER (TRAnsformer for Context-aware Emotion Recognition), offers a methodology for emotion recognition in complex, multi-person scenes. TRACER conceptualizes emotion recognition as a parallel decoding task and allows for the simultaneous processing of all subjects of interest within a single scene, rather than isolating and analyzing them separately, eliminating the necessity of manual cropping and reliance on pre-computed features, thereby enhancing computational efficiency and enabling holistic contextual modeling. By leveraging the power as an end-to-end framework, TRACER requires only the full image as input, offering a streamlined and single-stage solution for emotion recognition.

### C. Bodily Expressed Emotion Understanding Through Integrating Laban Movement Analysis

As mentioned above, nonverbal expressions can include facial expression and body language, and etc. Body movements carry important information about a person's emotions or mental state and are essential in daily communication.

With the development of the Body Language Dataset (BoLD), a large-scale in-the-wild dataset for bodily expressed emotion, and the corresponding benchmark deep neural network models, research on emotion recognition has increasingly focused on bodily expressed emotion understanding (BEEU) which aims to automatically recognize emotional expressions from body movements. However, existing bodily expressed emotion understanding utilize techniques developed for video or action recognition, directly inputting human movement videos into a video recognition network and predicting emotion categories behavior or classifying actions by recognizing low-level movement features such as speed and acceleration of various joints, without considering motor element understanding.

The present invention further provides a new paradigm for BEEU that incorporates motor element analysis.

Each segment of human movement is composed of several motor elements. Different movements performed by different individuals may share the same set of motor elements. By recognizing these elements, human movements can be coded. The relationship between human movement and motor elements is similar to that between music and notes, where a piece of music can be represented as a string of notes, and multiple notes can be played simultaneously, as in a chord.

To characterize motor elements, any movement model can be adopted. For illustrative purpose, as a non-limiting example, the Laban Movement Analysis (LMA), the most extensively developed system for encoding human movement is adopted. Several psychological studies have demonstrated that some LMA elements are strongly associated with emotions and that certain LMA elements, when presenting in a movement, can elicit four fundamental emotions (i.e., anger, fear, sadness, and happiness), allowing it to be classified as expressing one of these four fundamental emotions.

The LMA is an internationally recognized framework for describing and comprehending human bodily motions. It characterizes human movements into five categories: Body, Effort, Shape, Phrasing, and Space, and includes about a hundred detailed elements. The Body category lists moving body parts (such as the head and arms) and some typical actions (such as jumping and walking). The Space category represents the body's spatial direction when moving, including vertical (up, down), sagittal (forward, backward) and horizontal (right side/left side). The Shape category defines how the body changes its shape, including whether it encloses or spreads, rises or sinks. The Effort category specifies the inner attitude of the mover toward the movement, comprising four factors-Weight, Space, Time, and Flow. Weight-Effort refers to the amount of force applied by the mover, with a spectrum ranging from Strong (applying high force) to Light (applying weak force) to none (i.e., Passive Weight). Space-Effort ranges from Direct to Indirect, indicating whether the mover moves directly toward a target in space or indirectly. Time-Effort ranges from Sudden to Sustain, denoting the movement's acceleration. Flow-Effort ranges from Bound to Free flow, expressing the level of control exerted over the movement. Phrasing describes how the motor elements change over time.

The present invention establishes the BoME (Body Motor Elements) dataset, consisting of 1,600 clips of human movements with high-precision, expert-supplied movement labels. We use the AVA video dataset as the video source and applied the Laban Movement Analysis (LMA) system to describe the motor elements. Based on the preliminary psychological research on the relationship between LMA and emotion, eleven emotion-related LMA elements associated with sadness and happiness are selected to focus the annotation effort. A Certified Movement Analyst (CMA), an expert in LMA, is invited to annotate whether the LMA elements are present in the human movement clip. For each LMA element, a multi-level score such a a five-level score is given based on the duration and intensity of the element in the clip, with level 0 indicating no presence and level 4 indicating maximum presence. The five-level label can also be treated as a binary label, with level 0 representing a negative label and non-zero levels representing a positive label.

For each human clip in BoME, a value of 0 or 1 is assigned to the happiness and sadness emotion categories, respectively, based on the emotion label. Using these values, the correlation between the LMA elements and the two emotion categories (happiness and sadness) is calculated across the entire dataset.

Using the established BoME dataset, deep neural networks are utilized to learn an effective representation of human movement. Several state-of-the-art video recognition networks are deployed on BoME to estimate the LMA elements on the BoME dataset. Due to the fact that LMA elements have a more objective definition than emotion categories, as the presence of LMA elements in a human video depends solely on the body movement, whereas emotion labels may also be influenced by the annotators' emotional state, incorporating the human movement features learned from BoME into BEEU can enhances bodily expressed emotion understanding. In summary, emotion and LMA element labels are related, and LMA element labels are easier for deep neural networks to learn.

To achieve our goal of improving BEEU, we need to train and test on the BEEU benchmark dataset BoLD, using the BoME dataset as an additional training source. Therefore, we train the model on the BoLD training set and the entire BoME dataset and then evaluate the model on the BoLD validation and test sets.

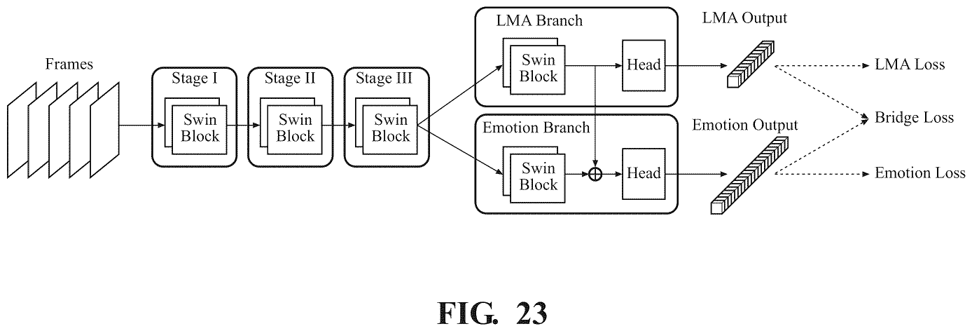

In order to enhance BEEU by using the BoME dataset as an additional source of supervision, a dual-branch, dual-task network called Movement Analysis Network (MANet), as shown in FIG. 23, is designed, whose branches produce predictions for bodily expressed emotion and LMA labels, respectively. To effectively utilize the movement representation in emotion recognition, the LMA branch features are merged into the emotion branch. A new Bridge loss is provided that allows the LMA prediction to supervise the emotion prediction.

MANet takes processed frames from video clips as input. The network is composed of a backbone and two distinctive branches—the LMA and Emotion branches. Both branches ingest the output of the backbone, extract relevant features, and subsequently yield separate LMA and Emotion outputs. Of note, within the Emotion branch, a fusion operation takes place, integrating the emotion features with the LMA features. The network training is facilitated by the application of three loss functions: LMA, Bridge, and Emotion.

Automatic emotion recognition based solely on emotion labels is limited to recognizing emotions from movements that are similar to those included in the training dataset. However, once a machine learns to recognize the relevant motor elements, it can identify them in any type of movement, even those not seen during training. This is why adding motor element labels as input to the emotion recognition process leads to higher recognition rates compared to those obtained from learning based solely on emotion labels.

Learning Emotion Representations from Verbal and Nonverbal Communication

The present disclosure relates generally to systems, methods, and computer-readable media a pre-training paradigm to extract visual emotion representations from verbal and nonverbal communication using only uncurated data. The systems and methods described herein attend to nonverbal emotion cues through subject-aware context encoding and verbal emotion cues using sentiment-guided contrastive learning. Extensive experiments demonstrate the effectiveness and transferability of the systems and methods described herein. Using merely linear-probe evaluation protocol, the systems and methods described herein outperform the state-of-the-art supervised visual emotion recognition methods and competes with many multimodal methods on various benchmarks. The systems and methods described herein address the problem of data scarcity in emotion understanding, thereby promoting the development of related fields.

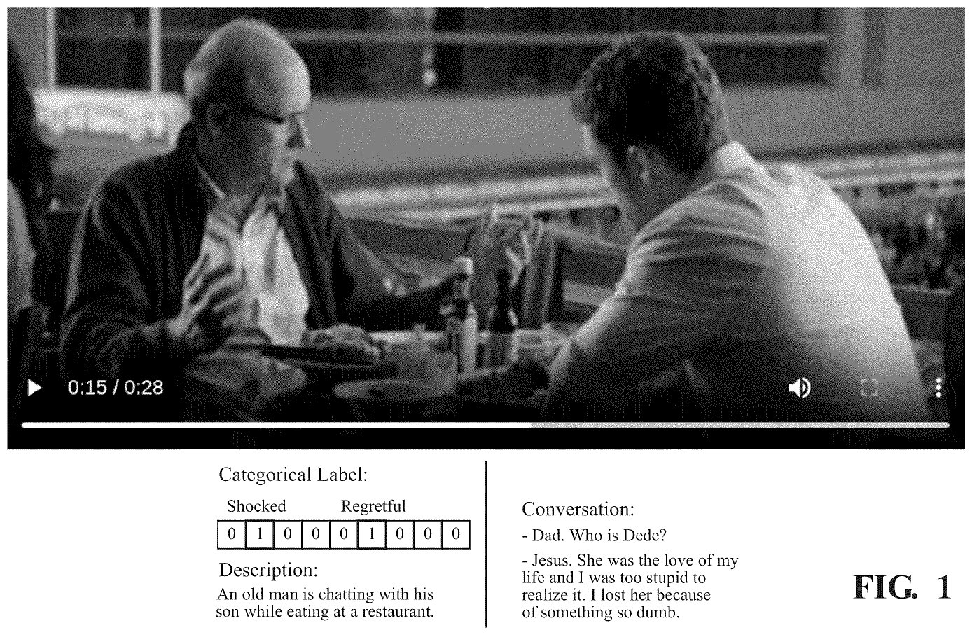

Inspired by how humans comprehend emotions, the systems and methods described herein use new paradigm for emotion understanding that learn directly from human communication. The core of the systems and methods described herein is to explore the consistency between verbal and nonverbal affective cues in daily communication. FIG. 1 shows how communication reveals emotion. The rich semantic details within the expression can hardly be represented by human-annotated categorical labels and descriptions in existing datasets.

The systems and methods described herein have several advantages:
The systems and methods described herein bypass the problems in emotion data collection by leveraging uncurated data from daily communication. Existing emotion understanding datasets are mainly annotated using crowdsourcing. For image classification tasks, it is straightforward for annotators to agree on an image's label due to the fact that the label is determined by certain low-level visual characteristics. However, crowdsourcing participants usually have lower consensus on producing emotion annotations due to the subjectivity and subtlety of affective labels. This phenomenon makes it extremely difficult to collect accurate emotion annotations on a large scale. Our approach does not rely on human annotations, allowing us to benefit from nearly unlimited web data.
The use of verbal expressions preserves fine-grained semantics to the greatest extent possible. Limited by the data collection strategy, existing datasets usually only contain annotations for a limited number of emotion categories, which is far from covering the space of human emotional expression. Moreover, the categorical labels commonly used in existing datasets fail to precisely represent the magnitude or intensity of a certain emotion.
The approach provides a way to directly model expressed emotion. Ideally, AEI should identify the individual's emotional state, e.g., the emotion the person desires to express. Unfortunately, it is nearly impossible to collect data on this type of “expressed emotion” on a large scale. Instead, the current practice is to collect data on “perceived emotion” to approximate the person's actual emotional state, which inevitably introduces noise and bias to labels.

In general, learning directly from how humans express themselves is a promising alternative that gives a far broader source of supervision and a more comprehensive representation. This strategy is closely analogous to the human learning process and provides an efficient solution for extracting emotion representations from uncurated data.

The main contributions of the systems and methods described herein are as follows:
A vision-language pre-training paradigm using uncurated data to the visual emotion understanding domain.
The systems and methods described herein utilize two techniques to guide the model to capture salient emotional expressions from human verbal and non-verbal communication.
Extensive experiments and analysis demonstrate the superiority and transferability of the systems and methods described herein on various down-stream datasets in emotion understanding.

### Methodology

The core idea is to learn directly from human communication how they express their emotions, by exploring the consistency between their verbal and nonverbal expressions. The systems and methods described herein tackle this learning task under the vision-language contrastive learning framework, that is, the model is expected to learn consistent emotion representations from the verbal expressions (e.g., utterance and dialogue) and nonverbal expressions (e.g., facial expression, body language, and contextual environment) of the same individuals.

### Data Collection

Publicly available large-scale vision-and-language datasets do not provide desired verbal and nonverbal information because they either comprise only captions of low-level visual elements or instructions of actions. The captions mostly contain a brief description of the scene or activity, which is insufficient to reveal the underlying emotions; the instruction videos rarely include humans in the scene or express neutral emotions, which fail to provide supervision signals for emotion understanding. To overcome such problems, we gather a large-scale video-and-text paired dataset. More specifically, the videos are TV series, while the texts are the corresponding closed captions. We collected 3,613 TV series from YouTube, which is equivalent to around a million raw video clips. We processed them using the off-the-shelf models to group the words in closed caption into complete sentences, tag each sentence with a sentiment score, and extract human bounding boxes.

### Overview of EmotionCLIP

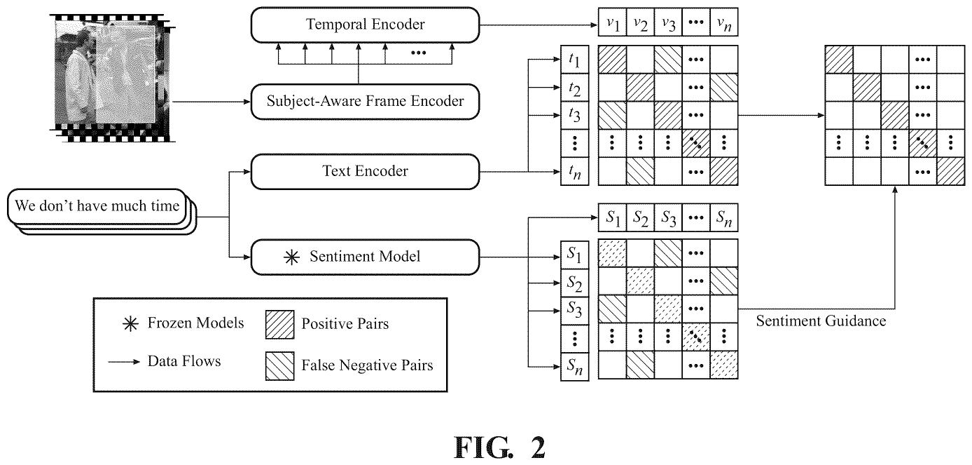

FIG. 2 presents an overview of the approach. We follow the wildly adopted vision-language contrastive learning paradigm where two separate branches are used to encode visual inputs (e.g., nonverbal expressions) and textual inputs (e.g., verbal expressions), respectively.

For nonverbal communication, subject and context information is modeled by a frame encoder and further aggregated into video-level representations by a temporal encoder. For verbal communication, textual information is encoded as text representations and sentiment scores by a text encoder and sentiment analysis model, respectively. The model learns emotion representations under sentiment guidance in a contrastive manner, by exploring the consistency of verbal and nonverbal communication.

Video Encoding. The visual branch of EmotionCLIP takes two inputs, including a sequence of RGB frames Xv and a sequence of binary masks Xₘ. The binary mask has the same shape as the frame and corresponds to the frame one-to-one, indicating the location of the subject within the frame. The backbone of the subject-aware frame encoder fᵢ is a Vision Transformer. In particular, it extracts m non-overlapping image patches from the frame and projects them into 1D tokens zᵢ∈R^{d}. The sequence of tokens passed to the following Transformer encoder is z=[z₁, . . . , zₘ, z_{cls}, zₕₘₙ], where z_{cls}, zₕₘₙ are two additional learnable tokens. The mask Xₘ is converted to an array of indices P indicating the image patches containing the subject. The frame encoder further encodes z, P into a frame-level representation. All frame representations are then passed into the temporal encoder fₚ to produce a video-level representation as v=fᵥ(z, P), where fᵥ=fₚ·fᵢ and V∈R^{d}.

Text Encoding. The textual branch of EmotionCLIP takes sentences Xₜ as inputs. The text encoder fₜ is a Transformer with an architecture modification, and the sentiment model fₛ is a pre-trained sentiment analysis model that is frozen during training. The input text is encoded by both models as t=fₜ(Xₜ) and s=fₛ(Xₜ), where t R^{d} is the representation of the text and s∈R⁷ is the pseudo sentiment score.

Training Objective. The training objective is to learn the correspondence between visual inputs and textual inputs by minimizing the sentiment-guided contrastive loss L.

### Subject-Aware Context Encoding

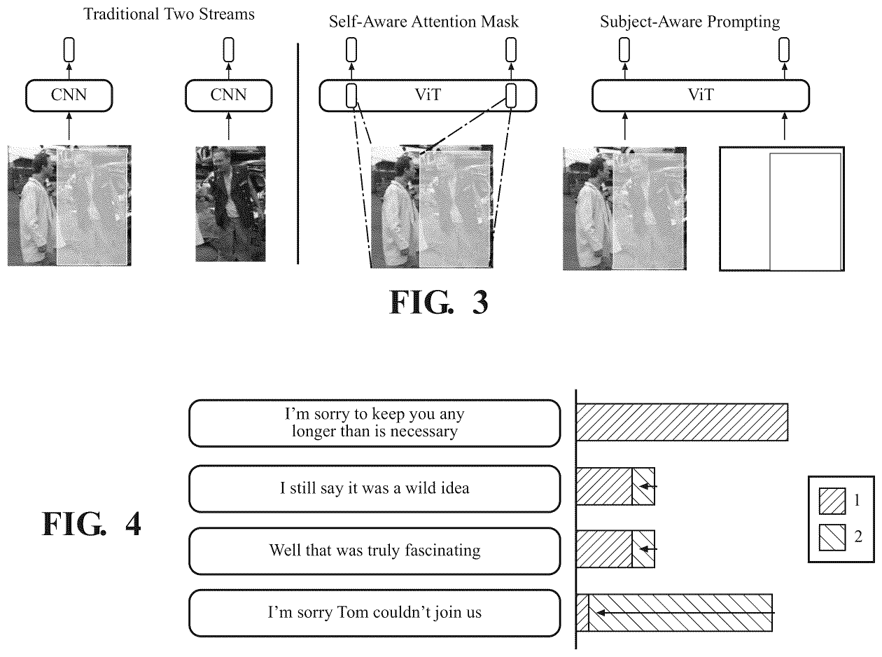

Context encoding is an important part of emotion understanding, especially in unconstrained environments, as it has been widely shown in psychology that emotional processes cannot be interpreted without context. The systems and methods described herein guide the model to focus on the interaction between the subject of interest and context. As shown in FIG. 3, the cropped character and the whole image are usually encoded by two separate networks and fused at the ends. This approach is inflexible and inefficient since it overlooks the dependency between subject and context and encodes redundant image portions. Following this line of thought, we propose two potential subject-aware context encoding strategies, e.g., subject-aware attention masking (SAAM) and subject-aware prompting (SAP). The former can be regarded as an efficient implementation of the traditional two-stream approach but avoids the problem of redundant encoding. The latter is a novel encoding strategy that enables adaptive modeling of the interaction between the context and the subject by providing necessary prompts.

Subject-Aware Attention Masking. The canonical attention module in a Transformer

is defined as:

$$Attention ( Q , K , V ) = softmax ( \frac{Q {K}^{T}}{\sqrt{d}} ) V . \qquad ( 1 )$$

The systems and methods described herein model the context and subject in a synchronous way by modifying the attention module to:

$$Attention * ( Q , K , V , U ) = {\underbrace{softmax ( \frac{Q {K}^{T}}{\sqrt{d}} ) ( J - A ) V}}_{context} + {\underbrace{softmax ( \frac{Q {K}^{T}}{\sqrt{d}} ) A U V}}_{subject} , \qquad ( 2 )$$

where J is a matrix with all ones, A is a learnable parameters containing values in range [0, 1], and U is a weight matrix constructed using P. Intuitively, we shift A amount of attention from a total of J amount of attention from the context to the subject. To partition the A amount of attention to all image patches containing subject, we compute U as the following:

$$U = softmax ( \frac{Q {K}^{T} + M}{\sqrt{d}} ) . \qquad ( 3 )$$

The masking matrix Mis defined as:

$$M = [ \begin{matrix}{M}^{( 1 )} & {M}^{( 2 )} \\ {M}^{( 3 )} & {M}^{( 4 )}\end{matrix} ] , \qquad ( 4 )$$

where

$${M}^{( 1 )} = {0}_{( m + 1 ) \times ( m + 1 )} , {M}^{( 4 )} = {0}_{1 \times 1} , {M}_{i ∉ P}^{( 2 )} = {M}_{i ∉ P}^{( 3 )} = - ∞ , {M}_{( m + 1 )}^{( 3 )} = - ∞ ,$$

and all other entries are zero.

$${Intuitively}_{( m + 1 )} ,$$

M⁽²⁾ and M⁽³⁾ represent the attention between all image patches zᵢ and the human token zₕₘₙ to model the subject stream; we mask out all attention between non-human patches and the human token. Moreover, we mask out attention from zₕₘₙ to z_{cls},

$${M}_{( m + 1 )}^{( 3 )} ,$$

to ensure zₕₘₙ only encodes the subject.

Subject-Aware Prompting. Prompting is a parameter-free method that restricts the output space of the model by shaping inputs. In our case, we hope to prompt the model to distinguish between the context and the subject. A recent visual prompting method, CPT, provides such a prompt by altering the original image, e.g., imposing colored boxes on objects of interest. It shows that a Transformer is able to locate objects with the help of positional hints. However, introducing artifacts on pixel space may not be optimal as it causes large domain shifts. To address this issue, we propose to construct prompts in the latent space based on positional embeddings, considering that they are inherently designed as indicative information. Formally, let eᵢ be the positional embedding corresponding to the patch token zᵢ, and P are the indicator set of the subject location. The prompting token is designed as zₕₘₙ=Li∈Pe.

We argue the sum of positional embeddings is enough to provide hints about the subject location. A previous study demonstrates a Transformer treats all tokens without positional embedding uniformly but with positional embedding differently. This result shows positional embeddings play a vital role in guiding model attention.

### Sentiment-Guided Contrastive Learning

We train the model to learn emotion representations from verbal and nonverbal expressions in a contrastive manner. In the traditional contrastive setting, the model is forced to repel all negative pairs except the only positive one. However, many expressions in daily communication indeed have the same semantics from an emotional perspective. Contrasting these undesirable negative pairs encourages the model to learn spurious relations. This problem comes from false negatives, e.g., the affectively similar samples are treated as negatives. We address this issue by introducing a trained sentiment analysis model from the NLP domain for the suppression of false negatives, thereby guiding our model to capture emotion-related concepts from verbal expressions. Specifically, we propose a sentiment-guided contrastive loss:

$$SNCE ( v , t , s ) = - {\sum }_{i ϵ B} ( log \frac{exp ( {v}_{i} \cdot {t}_{i} / τ )}{{\sum }_{j ϵ B} exp ( {v}_{i} \cdot {t}_{j} / τ - {w}_{i , j} )} ) , \qquad ( 5 )$$

where B is a batch. The reweighting term w_{i,j} is defined as

$${w}_{i , j} = \{ \begin{matrix}β \cdot K {L ( {s}_{i} \text{\vert \vert} {s}_{j} )}^{- 1} & i \neq j \\ 0 & i = j\end{matrix} , \qquad ( 6 )$$

where β is a hyper-parameter for controlling the reweighting strength. The total loss is defined as:

$$ℒ = \frac{1}{2 \vert B \vert} ( SNCE ( v , t , s ) + SNCE ( t , v , s ) ) . \qquad ( 7 )$$

As shown in FIG. 4, the false negative sample with similar emotion to the positive sample is greatly suppressed, while other negatives are not affected. Note that when i=j but sᵢ=sⱼ, we have w_{i,j}=∞, which is equivalent to removing jth sample from the negative pairs; when sᵢ and sⱼ are very different, w_{i,j} is negligible; we set w_{i,i}=0 to not affect the true positive pair. Since s is the sentiment score, the sentiment-related differences are emphasized and weighted more during training. Therefore, the proposed contrastive loss is expected to provide cleaner supervision signals for learning emotion-related representations.

### Experiments and Results

### Datasets and Evaluation Metrics

We evaluate the performance of EmotionCLIP on a variety of recently published challenging benchmarks, including three video datasets and an image dataset. The annotations of these datasets are mainly based on three physiological models: Ekman's basic emotion theory (7 discrete categories), a fine-grained emotion model (26 discrete categories), and a Valence-Arousal-Dominance emotion model (3 continuous dimensions). The evaluation metrics are consistent with previous methods.

BoLD is a dataset for understanding human body language in the wild, consisting of 9,827 video clips and 13,239 instances, in which each instance is annotated with 26 discrete categories and VAD dimensions.

MovieGraphs is a dataset for understanding human-centric situations consisting of graph-based annotations on social events that appeared in 51 popular movies. Each graph comprises multiple types of nodes to represent actors' emotional and physical attributes, as well as their relationships and interactions. Following the preprocessing and evaluation protocol proposed in previous work, we extract relevant emotion attributes from the graphs and group them into 26 discrete emotion categories.

MELD is an extension to the EmotionLines, which is an emotion corpus of multi-party conversations initially proposed in the NLP domain. It offers the same dialogue examples as EmotionLines and includes audio and visual modalities along with the text. It contains around 1,400 dialogues and 13,000 utterances from the Friends tv show, where each example is annotated with 7 discrete categories.

Liris-Accede is a dataset that contains videos from a set of 160 professionally made and amateur movies covering a variety of themes. Valence and arousal scores are provided continuously (e.g., every second) along movies.

Emotic is an image dataset for emotion recognition in context, comprising 23,571 images of 34,320 annotated individuals in unconstrained real-world environments. Each subject is annotated with 26 discrete categories.

### Ablation Study

### Analysis of Subject-Aware Context Encoding

In this series of experiments, we start with a vanilla model and analyze it by adding various subject-aware approaches. As shown in Table 1, decent results can be achieved in downstream tasks using the vanilla EmotionCLIP. This result supports our argument that models can learn non-trivial emotion representations from human verbal and nonverbal expressions by matching them together.

TABLE 1
Component-wise analysis of our method on BoLD

| | mAP | AUC | R² |
|---|---|---|---|
| EmotionCLIP (vanilla) | 21.97 | 68.85 | 0.130 |
| +SAAM | 21.53 [symbol] | 68.56 [symbol] | 0.137 [symbol] |
| +SAP | 22.28 [symbol] | 69.06 [symbol] | 0.131 [symbol] |
| +SAP & SNCE | 22.51 [symbol] | 69.30 [symbol] | 0.133 [symbol] |

[symbol]

indicates data missing or illegible when filed

The SAP achieves better results and improves over the baseline by a reasonable margin. This improvement demonstrates the design of SAP can incorporate location-specific information to guide the model in acquiring target-related content without impacting global information modeling.

Additionally, we note that the model with SAAM performs mediocrely. As discussed in the earlier section, the SAAM can be regarded as an efficient implementation of the multi-stream strategy in the Transformer. This result suggests that the multi-stream strategy commonly used in previous methods may not be optimal. Using the bounding box to crop the subject will allow only a tiny amount of context information to be retained. The late fusion strategy used in previous methods will force the model to encode this area separately and introduce unexpected bias.

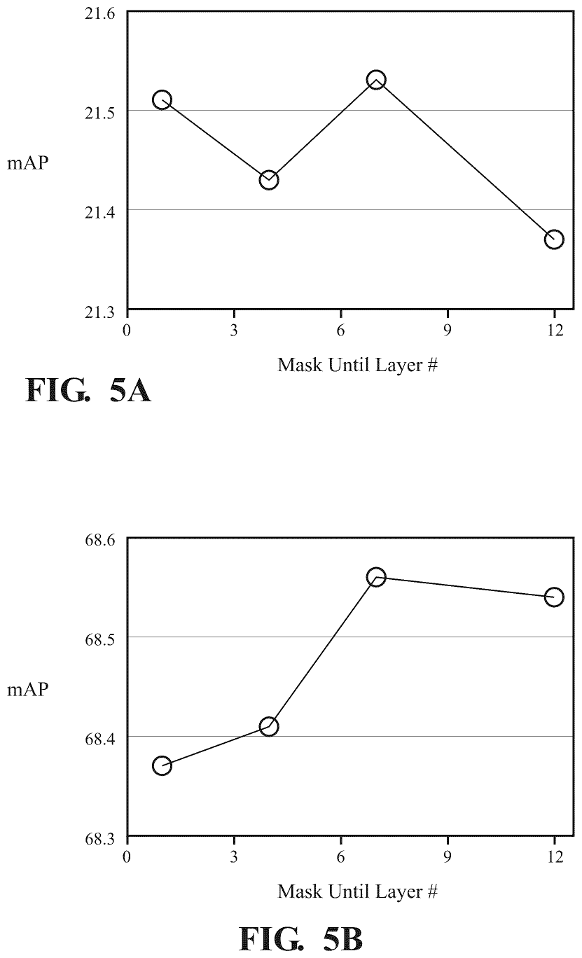

The SAAM can be applied up to a certain layer in the Transformer, which can be viewed as context and subject fusion from a certain layer. To rule out the possibility of fusion at inappropriate layers, we explore the impact of different fusion positions. As shown in FIGS. 5A-5B, the performance change does not correlate to the fusion layer change, and SAAM is outperformed by vanilla EmotionCLIP regardless of where to fuse. This result implies that imposing hard masks on the model's attention may produce unanticipated bias while modeling context-subject interaction adaptively (e.g., using SAP) is more reasonable. In subsequent experiments and discussions, we use SAP as the default implementation unless otherwise specified.

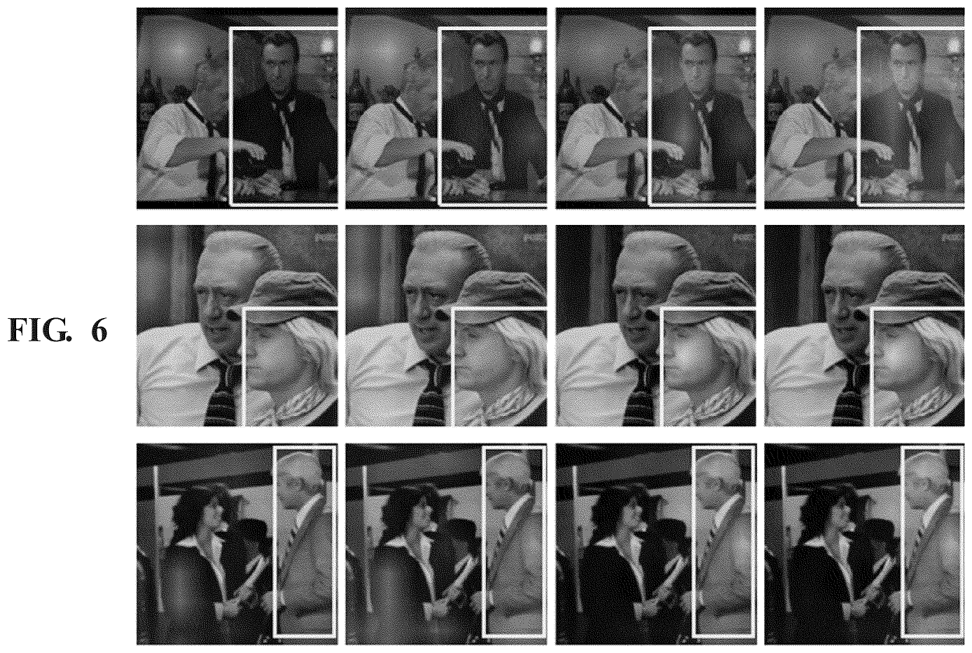

Qualitative Analysis. SAP offers merely a positional hint, as opposed to the mandatory attention-shifting in SAAM. Since the purpose of SAP is to ensure subject-aware encoding, it is necessary to understand if the attention guidance is appropriate. We analyze SAP by plotting HMN token's attention to all patches on the image. As shown in FIG. 6, HMN tokens first focus on random locations, but gradually turn their attention to the subject (e.g., the person with a bounding box) as we move to later layers, demonstrating that SAP offers sufficient guidance to the network attention.

### Analysis of Sentiment-Guided Contrastive Learning

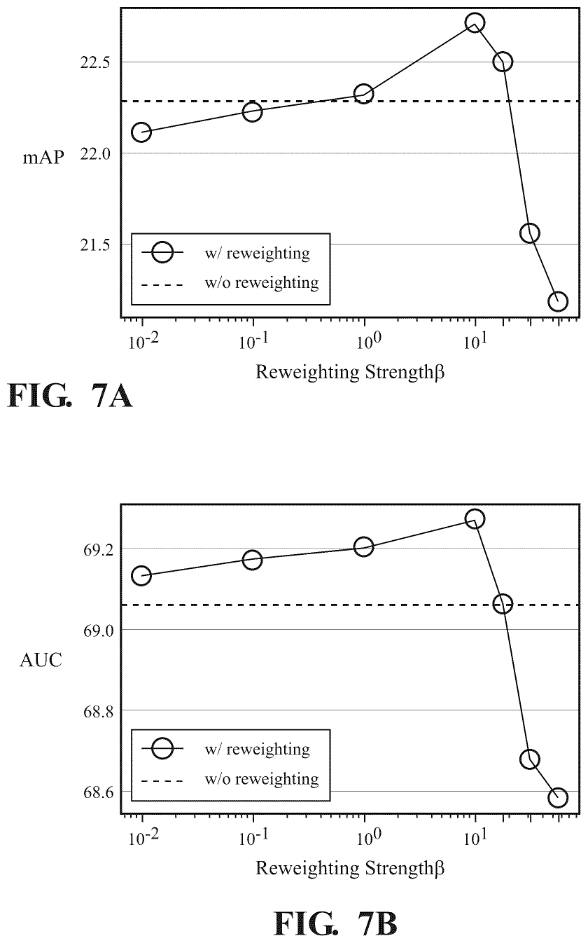

We first compare models trained with different β, the hyperparameter used to control the strength of reweighting in SNCE. Note that the training objective is equivalent to the vanilla infoNCE loss when β is set to zero. As β increases, more negative samples within the batch are suppressed. As shown in Table 1 and FIGS. 7A-7B, reweighting with appropriate strength can significantly increase the performance of the model as it guides the direction of learning by eliminating some significant false negatives. However, an excessively large β can hinder the training of the model, which is within expectation. First, the sentiment scores used in the reweighting process are weak pseudo-labels provided by a pre-trained sentiment analysis model, which is not entirely reliable and accurate. Second, previous work has clearly demonstrated that batch size has a decisive impact on self-supervised learning. A too-large β will cause too many negative samples to be suppressed, reducing the effective batch size and thus hindering the learning process.

Qualitative Analysis. We show how the text expressed different emotions are treated by our sentiment-guided loss. Given a positive pair, the logits are the scaled similarities between texts and the positive video; the model is penalized on large logits unless it is associated with the positive text. As shown in Table 2, the texts in the second and third rows provide undesired contributions to the loss as they express similar emotions as the positive sample. After reweighting, false negatives (2nd and 3rd) are effectively eliminated while true negatives (4th and 5th) are negligibly affected.

TABLE 2
An example batch containing both false negative and true negative
samples. The logits represent the similarity between every text
input and the positive video from a random epoch during training.

| Text | Logit |
|---|---|
| I'm sorry to keep you any longer | 10.65 |
| than is necessary. (positive sample) | |
| I'm sorry Tom couldn't join us. | 12.6 → −697 |
| I hate to say it guys but it's | 9.81 → −97.6 |
| getting late. | |
| I still say it was a wild idea. | 13.8 → 13.6 |
| Well that was truly fascinating. | 15.2 → 15.0 |

→ represents the sentiment-guided reweighting process.

### Analysis of Model Implementation

The frame and text encoders of our model are initialized with the image-text pre-training weights from CLIP. Research in neural science has demonstrated the necessity of basic visual and language understanding capabilities for learning high-level emotional semantics. To validate the effectiveness of using image-text pre-training for weight initialization, we evaluate variants with different implementations.

We first consider encoders with random initialization. As shown in Table 3, the model's performance drops sharply when training from scratch. This result is within expectation for two reasons. From an engineering perspective, previous works have demonstrated the necessity of using pre-training weights for large video models and vision-language models. From a cognitive point of view, it is nearly infeasible to learn abstract concepts directly without basic comprehension skills; if the model cannot recognize people, it is impossible to understand body language and facial expressions properly. We then consider frozen encoders with pre-training weights. This is a standard paradigm for video-language understanding that trains models with offline extracted features. As shown in Table 3, our model with variants using fixed encoders performs worse compared with the model using trainable encoders. This reflects the fact that affective tasks rely on visual and verbal semantics differently from low-level vision tasks, which is what CLIP and its successors overlooked.

TABLE 3
Ablation study on different model implementations.

| Text | Frame | Temporal | | |
|---|---|---|---|---|
| Encoder | Encoder | Encoder | mAP | AUC |
| ✓ | ✓ | — | 22.51 | 69.30 |
| — | ✓ | — | 12.43_{-45%} | 54.96_{-21%} |
| — | — | — | 11.02_{-51%} | 50.28_{-27%} |
| X | ✓ | — | 13.40_{-40%} | 57.38_{-17%} |
| X | X | — | 18.43_{-18%} | 65.08_{-6.0%} |
| ✓ | ✓ | ◯ | 21.17_{-5.9%} | 68.74_{-0.8%} |

✓ means trainable, initialization with pre-training weights.
X means frozen, initialization with pre-training weights.
— means trainable, random initialization.
◯ means no parameters.

We study the effect of the temporal encoder. We consider a variant where the temporal encoder is replaced by a mean pooling layer that simply averages the features of all frames. As shown in Table 3, the performance gap is obvious compared with the baseline. This phenomenon suggests that temporal dependency plays a vital role in emotion representations.

TABLE 4
Comparisons to the state-of-the-art across multiple datasets.
(a) BoLD [ [symbol] ]

| Method | mAP ↑ | AUC ↑ | R [symbol] ↑ |
|---|---|---|---|
| Supervised | | | |
| ST-GCN [ [symbol] ] | 12.63 | 55.96 | 0.044 |
| TSN [ [symbol] ] | 17.02 | 62.70 | 0.095 |
| [symbol] | 16.56 | 62.66 | 0.092 |
| [symbol] | 19.29 | [symbol] | 0.149 |
| Linear-Eval | | | |
| VideoCLIP [ [symbol] ] | 11.19 | 51.23 | −5.11 |
| X-CLIP [ [symbol] ] | 13.26 | 56.86 | −0.03 |
| EmotionCLIP | 22.72 | 69.27 | [symbol] |

(b) MovieGraphs [ [symbol] ]

| Method | Val Acc ↑ | Test Acc ↑ |
|---|---|---|
| Supervised | | |
| EmotionNet [ [symbol] ] | 35.60 | 27.90 |
| [symbol] | 39.88 | [symbol] |
| Linear-Eval | | |
| VideoCLIP [ [symbol] ] | 29.91 | 23.44 |
| X-CLIP [ [symbol] ] | 29.06 | 23.58 |
| EmotionCLIP | 40.38 | 32.48 |

(c)

[symbol]

| Method | mAP ↑ | AUC ↑ |
|---|---|---|
| Supervised | | |
| [symbol] | 20.84 | — |
| Affective Graph [ [symbol] ] | 28.42 | — |
| Fusion Model [ [symbol] ] | 29.45 | — |
| [symbol] | 32.03 | — |
| [symbol] | 35.48 | — |
| Linear-Eval | | |
| VideoCLIP [ [symbol] ] | 19.92 | 56.31 |
| X-CLIP [ [symbol] ] | 22.80 | 61.31 |
| EmotionCLIP | 32.86 | 71.49 |

(d) MELD [ [symbol] ]

| Method | Acc ↑ | [symbol] |
|---|---|---|
| Supervised | | |
| [symbol] | 45.63 | 32.44 |
| [symbol] | 67.85 | 66.71 |
| Linear-Eval | | |
| VideoCLIP [ [symbol] ] | 45.19 | 32.06 |
| X-CLIP [ [symbol] ] | 38.31 | 32.46 |
| EmotionCLIP | 48.70 | 34.93 |

(e)

[symbol]

| Method | V. MSE ↓ | A. MSE ↓ |
|---|---|---|
| Supervised | | |
| [symbol] | 0.115 | 0.171 |
| [symbol] | 0.102 | 0.149 |
| [symbol] | 0.117 | 0.138 |
| [symbol] | 0.092 | 0.140 |
| [symbol] | 0.090 | 0.136 |
| [symbol] | 0.084 | 0.133 |
| [symbol] | 0.071 | 0.137 |
| [symbol] | 0.068 | 0.128 |
| Linear-Eval | | |
| VideoCLIP [ [symbol] ] | 0.142 | 0.151 |
| X-CLIP [ [symbol] ] | 0.133 | 0.246 |
| EmotionCLIP | 0.097 | 0.154 |

| Abbreviation | Meaning |
|---|---|
| A. MSE | Arousal MSE |
| V. MSE | Valence MSE |
| W. F [symbol] | Weighted F [symbol] |
| Acc. | Top- [symbol] Accuracy |
| ↓ | Lower is better |
| ↑ | Higher is better |

Methods marked with * use multimodal inputs, e.g., audio and text. Bold numbers indicate the best results achieved using visual inputs only. [symbol]
indicates data missing or illegible when filed

### Comparison with the State of the Art

Based on our previous ablation experiments, we choose the model with SAP and SNCE as the default implementation and compare it with the state-of-the-art. In addition, we also compare with VideoCLIP and X-CLIP, both of which are state-of-the-art vision-language pre-training models for general video recognition purposes. To evaluate the quality of learned representations, we follow the practice in CLIP and use linear-probe evaluation protocol for vision-language pre-training models.

BoLD. As shown in Table 4(a), EmotionCLIP substantially outperforms the state-of-the-art supervised learning methods on the challenging 26-class emotion classification task and achieves comparable results on continuous emotion regression. It is worth noting that a complex multi-stream model is used to integrate the human body and context information, while we achieve better results with a single-stream structure using RGB information only. This difference reflects that the subject-aware approach we designed models the relationship between the subject and context. We also notice that other vision-language-based methods perform poorly on emotion recognition tasks, although they are designed for general video understanding purposes. This phenomenon is largely attributed to the lack of proper guidance; the model can only learn low-level visual patterns and fails to capture semantic and emotional information.

MovieGraphs. As shown in Table 4 (b), EmotionCLIP substantially outperforms the best vision-based method and even surpasses Affect2MM, a powerful multimodal approach that uses audio and text descriptions in addition to visual information. Instead, other vision-language pre-training models are still far from supervised methods.

MELD. EmotionCLIP performs well on MELD as shown in Table 4 (d); it achieves comparable results to the state-of-the-art vision-based methods. It is worth noting that this dataset is extended from an NLP dataset, so the visual data is noisier than the original text data. In fact, according to some ablation experiments, it is possible to achieve an accuracy of 67.24% using only text, while adding visual modality information only improves the accuracy by about 0.5%. This result explains why our method significantly lags behind multimodal methods using text inputs.

Liris-Accede. As shown in Table 4 (e), EmotionCLIP achieves promising results using visual inputs only. It even competes with many multimodal approaches that are benefited from the use of audio features.

Emotic. As shown in Table 4 (c), EmotionCLIP outperforms all RGB based supervised learning methods while other vision-language models perform poorly. The improvement of is attributable to the use of additional depth information. This result demonstrates the capability of EmotionCLIP in learning emotion-relevant features from complex environment.

### APPENDIX

### 1 Data

### 1.1 Data Collection

The video-text pairs for pre-training were obtained using Python implementation of YouTube API, youtube-search-python ¹. This API provides the exact query result as the YouTube webpage. We searched for keywords such as “TV series” and “TV shows,” and filtered only those with English closed captions from the resulting videos. Next, we filtered out all the “TV” videos that were less than 40 minutes long to remove some false results. We then manually removed videos appearing in downstream datasets based on YouTube id and movie title. This process resulted in 3,613 filtered videos or about 1.1 million video clips. Due to resource limitations, we only processed and stored the videos at 8 FPS. We refer to this dataset as the TV dataset. ¹ https://github.com/alexmercerind/youtube-search-python

We further processed the video frames, and the corresponding closed captions to obtain additional information. We extracted all the frames and resized the smaller edge to 256 without changing the aspect ratio. All the closed captions were processed using FullStop to produce complete sentences; each word obtained a punctuation label, and we split on the termination punctuation. Furthermore, we applied a sentiment model, a DistilROBERTa-base ², to generate sentiment scores of seven emotion categories (i.e., anger, disgust, fear, joy, sadness, surprise, and neutral) for texts. Moreover, all the frames were processed using YOLOv7 to generate bounding boxes for all humans. The detailed parameter for bounding boxes generation is in Table 5. ² https://huggingface.co/j-hartmann/emotion-english-distilroberta-base

TABLE 5
The important parameters for YOLOv7
to generate human bounding boxes.

| Image Size | Confidence Threshold | IOU Threshold |
|---|---|---|
| 640 × 640 | 0.25 | 0.45 |

### 1.2 Data Exploration

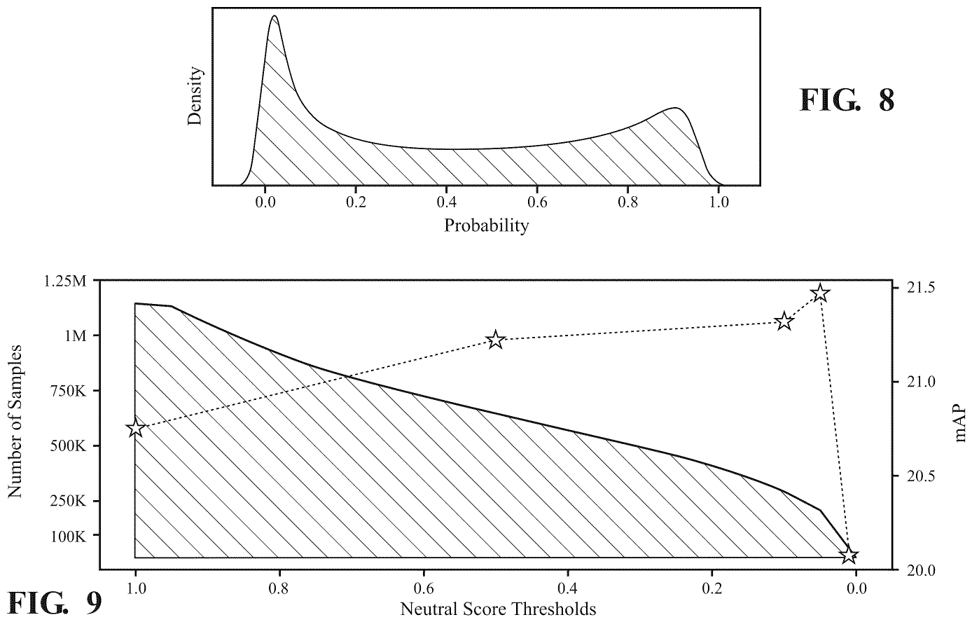

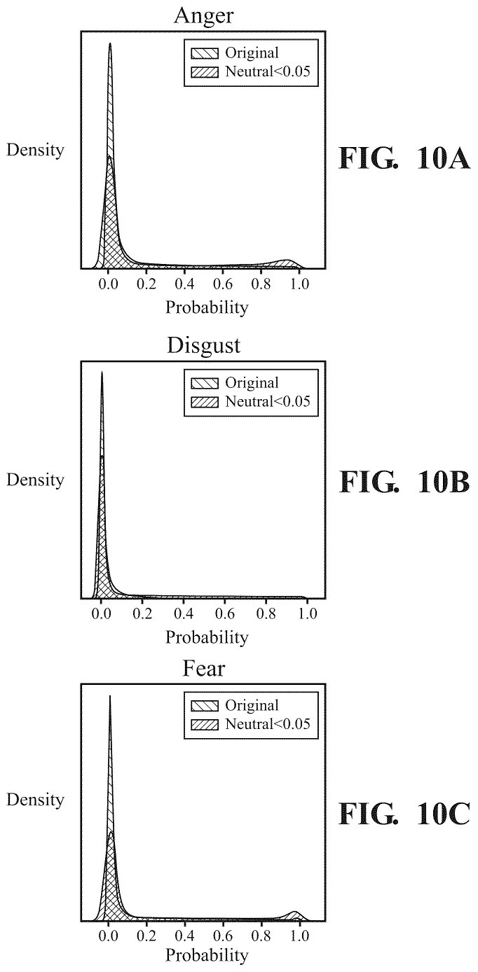

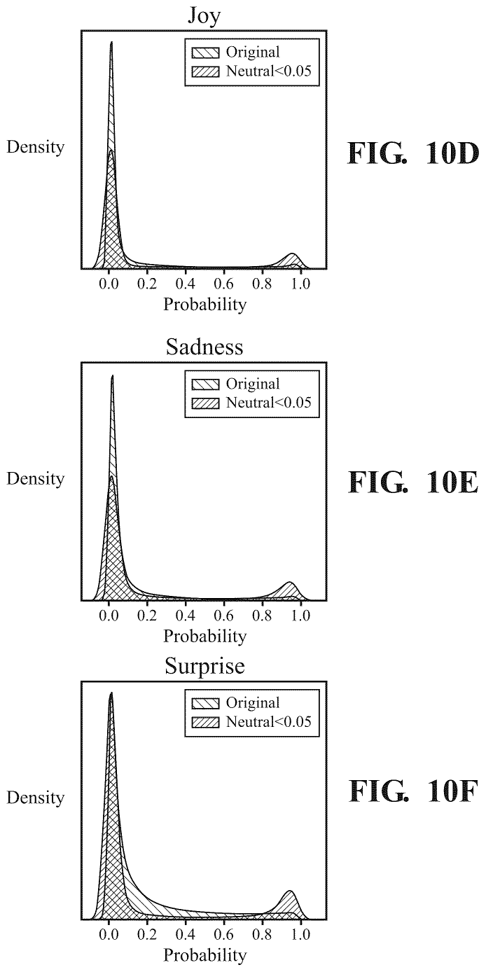

We first explore the textural data in the TV dataset. We notice that many texts are not helpful for emotion understanding; they do not provide desired emotional signals. As shown in Table 6, the neutral score is the probability that the trained sentiment model predicts that the text is neutral; we can see that the text expresses stronger emotion when the neutral score is low; the emotion signal is most apparent in the last three rows. This observation aligns with our intuition that instructional or descriptive language, are not usually emotional and support our motivation for collecting the TV dataset. Based on the above observation, we believe that the model may be misled if too many samples with high neutral scores were used. Therefore, we must limit the number of samples with a high chance of neutrality to better direct the model's attention toward other more valuable emotional expressions. Moreover, the distribution of the neutral scores for the TV dataset is in FIG. 8; it forms a bimodal distribution where more data are closer to the left (non-neutral). Clearly, the left peak represents the desirable emotional samples, and the right peak represents the instructional or descriptive samples that can be discarded. To confirm our intuitions and to find a good threshold for filtering useless examples, we tested multiple neutral score thresholds on the TV dataset. As shown in FIG. 9, the model's performance on downstream tasks increases when more neutral examples are eliminated, supporting our conjecture that too many neutral samples are not helpful for emotion understanding. Furthermore, the performance peaks at around 0.05 and drops dramatically as too few samples were left when using a small threshold. Based on this observation, we keep only the samples with a neutral score of less than 0.05. This filtering process results in about 250 k samples which is still much larger than the current emotion understanding datasets. Finally, we evaluate how the filtering process changed the probability distribution of other emotion labels. The comparison of the distribution before and after filtering for the other six emotion categories is in FIGS. 10A-10F; the distribution of the original TV dataset is highly skewed where the majority of samples had probabilities close to zero for each of the six emotions. Following filtering, the skewness is reduced and the proportion of samples containing relevant information signals is enhanced. The filtered TV dataset is expected to provide better supervision for EmotionCLIP.

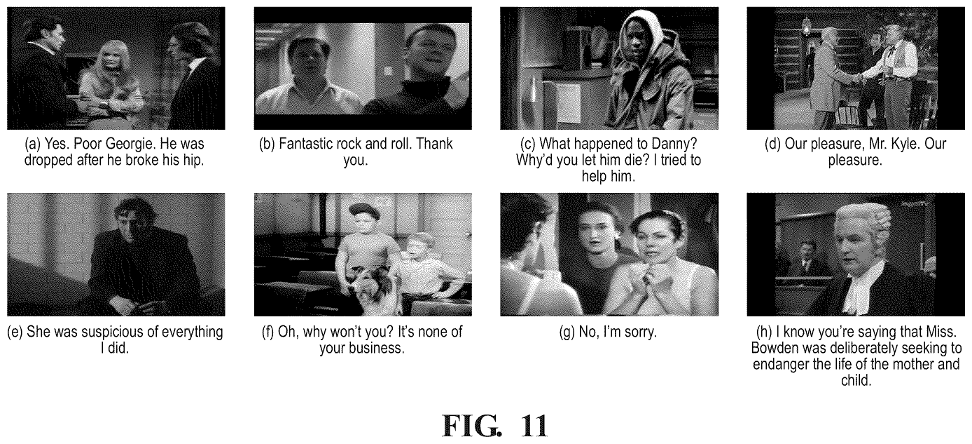

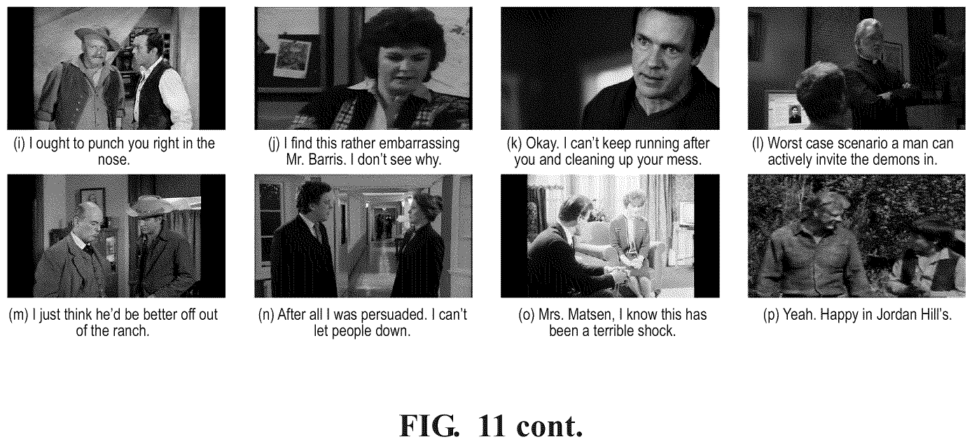

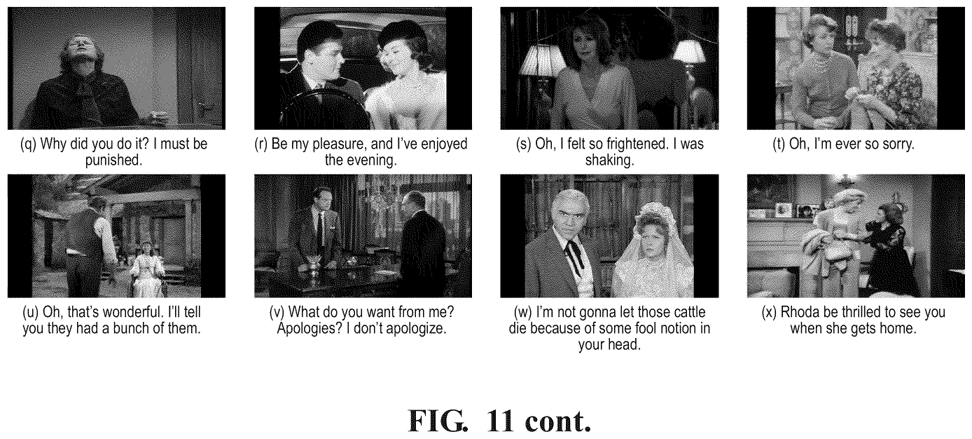

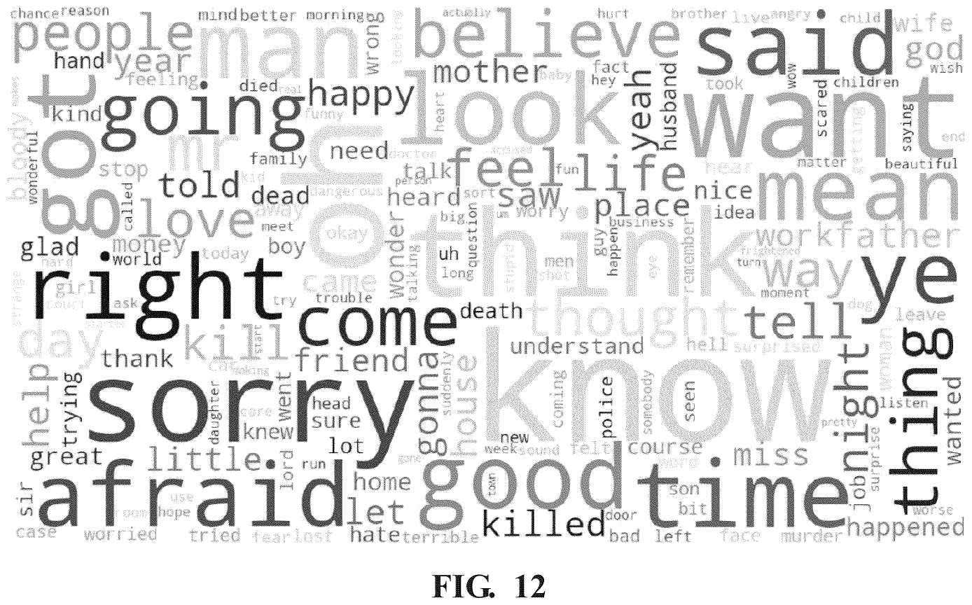

Some examples from the filtered TV dataset are shown in FIG. 11. It can be clearly felt that most of the examples showed strong emotional expression from both verbal and nonverbal cues. The word cloud in FIG. 12 is constructed based on the filtered TV dataset. We can see that some words related to emotional expression appear frequently in the dataset, such as ‘sorry’, ‘happy’, ‘afraid’, ‘fear’, ‘angry’, ‘worried’, ‘love’. In general, there are a large number of verbal communications with rich emotional expressions, which can hardly be covered by basic emotions.

TABLE 6
Example texts, and their corresponding neutral
score predicted by the sentiment model.

| Text | Neutral Score |
|---|---|
| Only then it will become picture perfect | 0.931 |
| I do know they once owned the painting | 0.924 |
| Valerie had to wait a few months for | 0.834 |
| hers and his mother | |
| Tell him that we will meet at 6. | 0.828 |
| can you tell us what you know about that | 0.734 |
| They have also received a bill | 0.717 |
| So many of them did not clear | 0.543 |
| he's the only collector | 0.519 |
| he was on his way to Pennsylvania the night | 0.452 |
| Do you want me to do it and bring a glass | 0.351 |
| I haven't taken my vows and I probably | 0.300 |
| never will | |
| some of his new patients like three-year-old | 0.253 |
| Harriet are definitely unusual | |
| yes in your statement you said you saw | 0.234 |
| the defendant running from the heat | |
| I don't want to lose the money any | 0.185 |
| more than you do | |
| any one of them might be guilty | 0.164 |
| I couldn't have done it myself I didn't | 0.031 |
| even think of it | |
| it's a whole new world for me | 0.027 |
| I know our dream house yes David | 0.009 |
| our dream house | |

### 2 Implementation Details

### 2.1 Model Details

EmotionCLIP adopts CLIP (ViT/B-32) as part of the frame encoder and text encoder. Specifically, the frame encoder is a ViT (L=12, Nₕ=12, d=768, p=32), the text encoder is a Transformer (L=12, Nₕ=8,d=512), and the temporal encoder is another Transformer (L=6, Nₕ=8, d=512), where L is the number of layers, Nₕ is the number of attention heads, d is the embedding dimension, and p is the patch size. The sentiment model a fine-tuned checkpoint of DistilROBERTa-base ³, which is frozen during training. Following the practice of CLIP, both the text encoder and sentiment model operate on a lower-cased byte pair encoding (BPE) representation of the text with a 49,152 vocab size. The max length of the text sequence is capped at 76 and bracketed with [SOS] and [EOS] tokens. The specific implementation of subject-aware context encoding in the frame encoder is as follows: ³ https://huggingface.co/j-hartmann/emotion-english-distilroberta-base

### Subject-Aware Attention Masking.

Follow the equation

$$Attention * ( Q , K , V , U ) = {\underbrace{softmax ( \frac{Q {K}^{T}}{\sqrt{d}} ) ( J - A ) V}}_{context} + {\underbrace{softmax ( \frac{Q {K}^{T}}{\sqrt{d}} ) A U V}}_{subject} , \qquad ( 1 )$$

defined in the main document, we make a few implementation choices to speed up the computation. First, we use V^{(l)} for the context encoding and V^{(l-1)} for the subject encoding, where l denotes the layer. Since each token at layer l is a weighted average of the token at layer l−1, the model is able to extract similar information to V^{(l)} by reweighting V^{(l-1)}. Next, we set A to the attention from each token to the current layer HMN token. This modification ensures all entries in A are in [0,1] and values are automatically learned by the model. The above two modifications allow us to reuse the original multi-head attention layer by setting the attention mask to M as defined in the main document.

### Subject-Aware Prompting.

As described in the main document, we set HMN as zₕₘₙ=Σ_{i∈P}eᵢ. Note that the indices in P represent the presence or absence of the subject in the non-overlapping image patches. This information is obtained from bounding boxes which may not align with the non-overlapping image patches. To address this issue, we add the indices of all tokens that have overlap oᵢ>0 with the bounding boxes to P and compute zₕₘₙ=Σ_{i∈P} oᵢeᵢ

### 2.2 Training Details

The frame encoder and text encoder are initialized using the pre-trained weights provided by OpenCLIP ⁴. We use the AdamW optimizer to train the model, where β₁=0.98, β₂=0.9, ∈=1e-10, λ=0.1. The base learning rate of the parameters in the frame encoder and text encoder is set to 5e-5 for gains and biases, and 1e-8 for the remaining parameters. The learning rate of the parameters in the temporal encoder is set to 1e-6. The decoupled weight decay regularization is applied to all weights that are not gains or biases. Models are trained for 25 epochs with a batch size of 128. The learning rate is linearly warmed up for 2500 steps and decayed to 1e-10 following a cosine schedule for the rest of the training. For each video, we randomly sample 8 frames in each iteration to form an input sequence. The input frames have a spatial resolution of 224×224 and are obtained by random cropping. The sequence of the subject mask is obtained with the same operation as the corresponding frame. ⁴ https://github.com/mlfoundations/open_clip

### 2.3 Evaluation Details

We follow the linear-probe evaluation protocol in CLIP. Specifically, we uniformly sample 8 frames from each video to form an input sequence and extract video features using the pre-trained EmotionCLIP. For classification tasks, we train a logistic regression classifier using scikit-learn's implementation with sag solver. The maximum iteration is set to 2,000, and the regularization strength is determined by a random search on the validation sets. For the datasets that contain a validation split in addition to a test split, we use the provided validation set to perform the hyperparameter search, and for the datasets that do not provide a validation split or have not published labels for the test data, we split the training dataset to perform the hyperparameter search. For the regression tasks, we train a linear regression model using scikit-learn's Ridge implementation with default hyperparameters, followed by a Savgolet filter.

For the other two vision-language baseline models, we used the official implementations with pre-trained weights and ran them with their default settings. Specifically, for VideoCLIP, we use the pre-trained model provided in Fairseq ⁵; for X-CLIP, we use the zero-shot X-CLIP-B/16 model trained on Kinetics-600 ⁶. For other supervised learning methods, we use the scores reported in their papers. ⁵ https://github.com/facebookresearch/fairseq⁶ https://github.com/microsoft/VideoX/tree/master/X-CLIP

### 3 Detailed Results

### 3.1 Qualitative Results

### Subject-Aware Prompting.

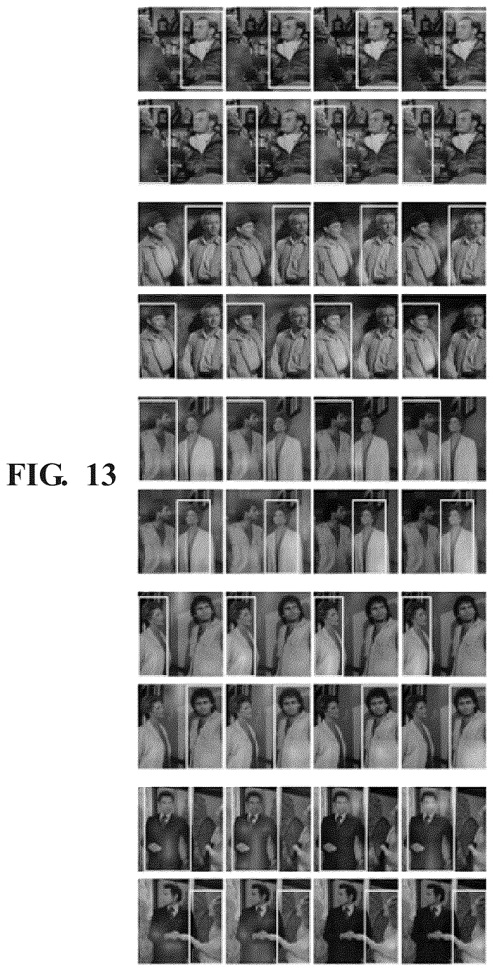

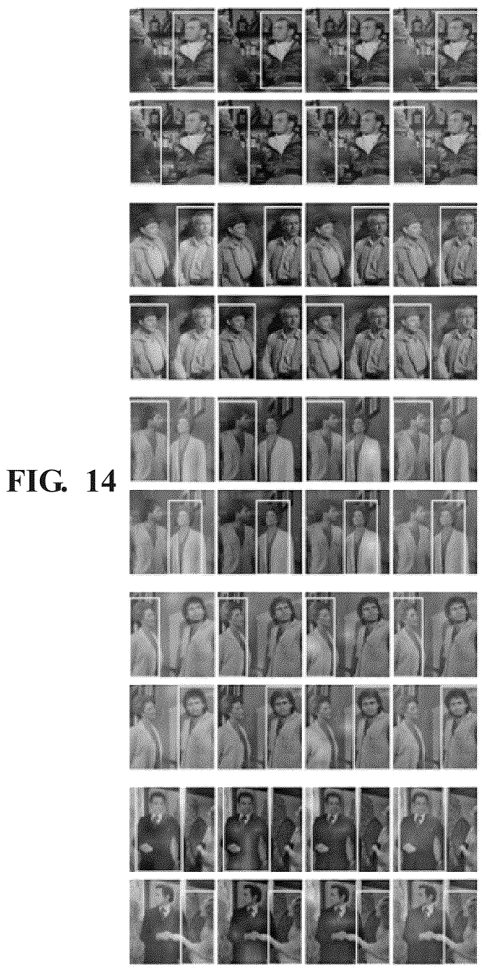

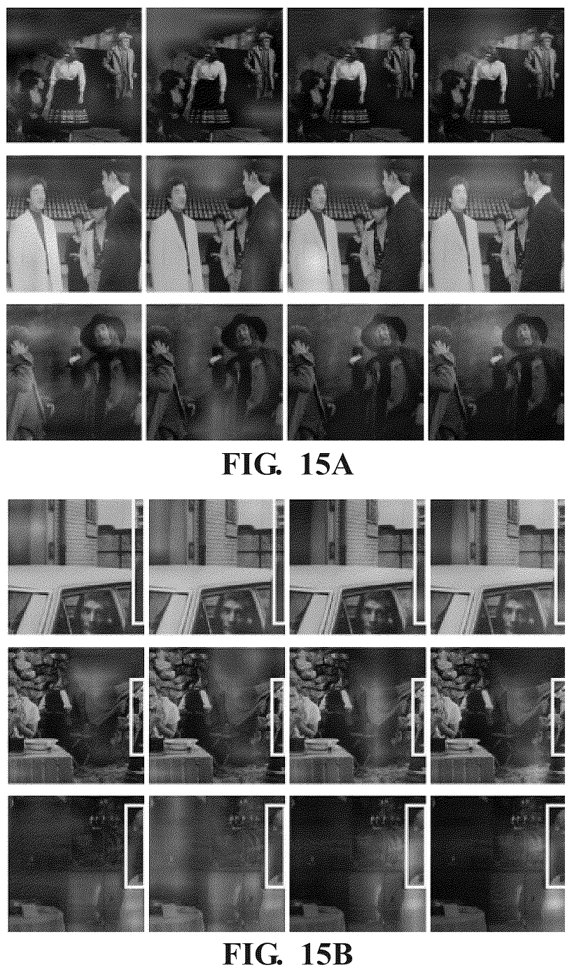

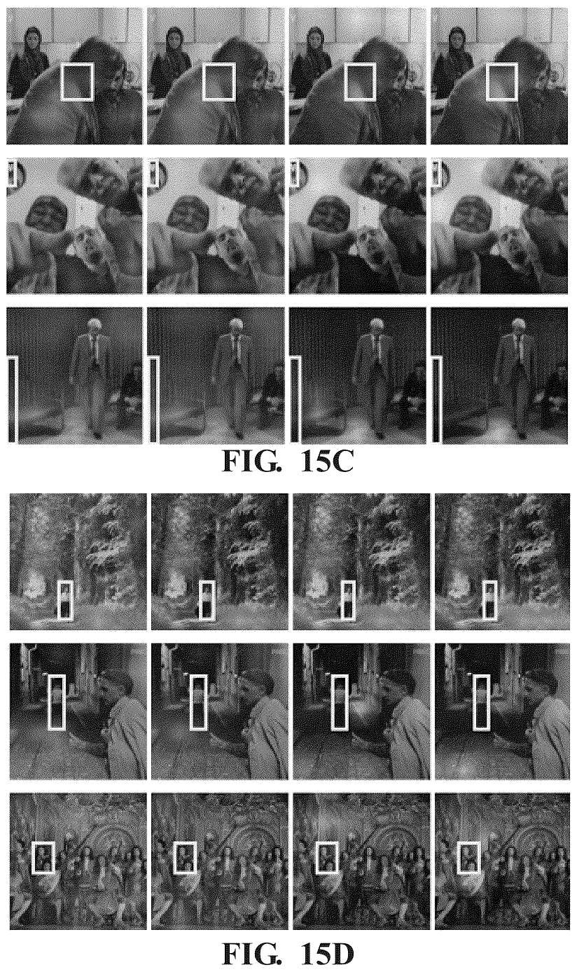

We present additional qualitative results for SAP. As shown in FIG. 13, the attention of HMN changes according to the positional hint for the subject, which shows SAP is subject-aware. Moreover, FIG. 14 shows the exact same set of frames as FIG. 13 but the attention comes from CLS token; it is clear that the attention for CLS token tend to focus on the entire scene and does not change regardless of the positional hint. This result shows SAP behaves similarly to two stream approaches where CLS models the context and HMN models the subject but is less affected by the artifacts introduced in traditional manual subject cropping. FIGS. 115A-15D show some examples where SAP fails to guide the attention. The majority of the failure cases are direct results of applying cropping during testing; some subjects are either entirely off the frame or partially off the frame. Moreover, there are cases where the bounding boxes are incorrect. Additionally, some subjects are too small compared to most of the subjects in the training dataset, leading to a large domain shift.

### Sentiment-Guided Contrastive Learning.

In this section, we demonstrate how the sentiment model guides the loss. Note that we use the inverse of the KL divergence between text from the positive sample and the negative samples to reweight the negative samples; the suppression strength is inversely proportional to the KL divergence. Table 8 shows some examples from the collected TV dataset; the text expressing similar emotion has a smaller KL divergence whereas the text expressing different emotion have a larger KL divergence. Since we treat the negative samples that express similar emotions to the positive samples as false negative samples, it is clear the proposed reweighting method suppresses the false negative samples.

### 3.2 Quantitative Results

We reported detailed emotion classification performance on BoLD and Emotic in Table 9. Both datasets have fine-grained emotion annotations on 26 categories. We observed an intriguing phenomenon that EmotionCLIP performs quite differently on some emotion categories compared with prior approaches based on supervised learning. As shown in Table 7, EmotionCLIP with linear classifier achieves comparable mAP with two other supervised learning methods using RGB inputs on Emotic. However, we notice that EmotionCLIP performs significantly better than supervised learning methods in some categories (e.g., sadness, suffering). The performance in the remaining categories is also different from that of supervised learning methods. This result shows that emotional representations learned from communication are different from those learned through annotations, which further demonstrates the complementarity of EmotionCLIP as a pre-training method to conventional supervised learning methods.

TABLE 7
Per-category performance (AP) on Emotic.

| | Kosti et al. | Emoticon | |
|---|---|---|---|
| Categories | [ [symbol] ] | [ [symbol] ] | EmotionCLIP |
| Affection | 27.85 | 36.78 | 45.81 |
| Anger | 9.49 | 14.92 | 26.67 |
| Annoyance | 14.06 | 18.45 | 21.94 |
| Anticipation | 58.64 | 68.12 | 58.07 |
| Aversion | 7.48 | 16.48 | 10.55 |
| Confidence | 78.35 | 59.23 | 76.94 |
| Disapproval | 14.97 | 21.21 | 19.23 |
| Disconnection | 21.32 | 25.17 | 29.44 |
| Disquietment | 16.89 | 16.41 | 21.82 |
| Doubt/Confusion | 29.63 | 33.15 | 22.70 |
| Embarrassment | 3.18 | 11.25 | 2.86 |
| Engagement | 87.53 | 90.45 | 87.79 |
| Esteem | 17.73 | 22.23 | 18.58 |
| Excitement | 77.16 | 82.21 | 71.05 |
| Fatigue | 9.70 | 19.15 | 20.21 |
| Fear | 14.14 | 11.32 | 12.08 |
| Happiness | 58.26 | 68.21 | 78.44 |
| Pain | 8.94 | 12.54 | 16.73 |
| Peace | 21.56 | 35.14 | 29.67 |
| Pleasure | 45.46 | 61.34 | 50.23 |
| Sadness | 19.66 | 26.15 | 43.01 |
| Sensitivity | 9.28 | 9.21 | 9.53 |
| Suffering | 18.84 | 22.81 | 43.96 |
| Surprise | 18.81 | 14.21 | 10.70 |
| Sympathy | 14.71 | 24.63 | 17.23 |
| Yearning | 8.34 | 12.23 | 10.29 |
| mAP | 27.38 | 32.03 | 32.91 |

[symbol]

indicates data missing or illegible when filed

TABLE 8
Examples of false negative targets (with low KL divergence) and true negative
targets (with high KL divergence). The KL divergence is calculated using
sentiment scores. The proposed sentiment-guided contrastive learning method
will down-weight the target if the KL divergence between the source and
target is relatively low, thereby eliminating emotional false negatives.

| Source | Target | KL Divergence |
|---|---|---|
| it would baffle the police | I don't think that you | 9.8e−4 |
| | could understand | |
| he'll be glad to hear | it's a very nice church | 5.2e−4 |
| you seem awfully anxious to make it | you're scared of them | 9.8e−4 |
| look like suicide | | |
| I had a great childhood | I just can't wait to get | 9.7e−4 |
| | back into some action | |
| I wonder if you would look at your | I just I was wondering if | 9.4e−4 |
| passport and find a visa for perco for me | he was here | |
| a man is dead | I have lost my son | 5.0e−4 |
| i guess i must be the luckiest | I'm very glad | 4.8e−4 |
| man around these parts | | |
| oh my goodness I didn't know I | oh my god Jimbo look who's here | 4.7e−4 |
| had such a devoted fans | | |
| oh really oh yes yes yes miss | I can't say I'm surprised though | 4.3e−4 |
| Travers I'm surprised | | |
| I'm sorry to keep you any longer | I'm sorry to have to keep requesting | 3.6e−4 |
| than is necessary | you like this | |
| she were my nurse and after that | I never thought I'd ever be | 5.01 |
| sickness come the greatest | cold again | |
| happiness of my life | | |
| i have consulted with them | she doesn't think she'll ever | 5.04 |
| | see him again | |
| I'm sorry to keep you any longer | I don't think this is something you | 5.48 |
| than is necessary | can come out of | |
| it would baffle the police | i promised i wouldn't harm him | 5.88 |
| well that was truly fascinating | I'm afraid of you | 5.92 |
| alright I'm sorry about yesterday | you'll be surprised | 6.00 |
| she let me down | I'm Tarsus glad to meet you | 6.03 |
| i've got to get my crew out of here | i think for nancy the thrill of the | 6.29 |
| | chase was half of the fun | |
| i should have known he'd be all right | the army turned me down | 7.44 |
| I like the way you laugh | he would never let you down | 7.25 |
| | deliberately | |

TABLE 9
Emotion classification performance on BoLD and Emotic.

| | |
|---|---|
| BoLD [ [symbol] ] | Emotic [ [symbol] ] |

| Categories | AP | AUC | AP | AUC |
|---|---|---|---|---|
| Affection | 41.70 | 83.90 | 45.54 | 79.49 |
| Anger | 16.00 | 71.29 | 23.25 | 76.57 |
| Annoyance | 20.99 | 61.24 | 21.07 | 73.28 |
| Anticipation | 32.63 | 60.81 | 58.26 | 62.14 |
| Aversion | 8.43 | 62.88 | 10.53 | 72.16 |
| Confidence | 40.53 | 66.93 | 78.05 | 77.25 |
| Disapproval | 14.57 | 57.44 | 18.87 | 79.42 |
| Disconnection | 10.21 | 56.43 | 29.17 | 71.47 |
| Disquietment | 23.17 | 68.02 | 21.56 | 63.65 |
| Doubt/Confusion | 21.94 | 62.31 | 22.73 | 61.03 |
| Embarrassment | 2.49 | 72.20 | 3.26 | 54.99 |
| Engagement | 45.32 | 64.25 | 88.37 | 70.83 |
| Esteem | 20.08 | 63.07 | 19.07 | 57.29 |
| Excitement | 26.88 | 73.48 | 71.85 | 74.16 |
| Fatigue | 13.57 | 70.81 | 18.71 | 67.93 |
| Fear | 18.99 | 71.29 | 11.41 | 71.35 |
| Happiness | 48.47 | 80.36 | 78.06 | 78.31 |
| Pain | 15.38 | 77.54 | 15.79 | 84.16 |
| Peace | 28.12 | 65.43 | 29.69 | 70.76 |
| Pleasure | 36.71 | 76.56 | 50.80 | 70.27 |
| Sadness | 24.58 | 82.03 | 41.39 | 84.77 |
| Sensitivity | 15.09 | 72.71 | 10.34 | 75.09 |
| Suffering | 30.14 | 80.16 | 40.72 | 87.82 |
| Surprise | 12.64 | 64.70 | 9.67 | 58.35 |
| Sympathy | 12.61 | 66.71 | 16.64 | 69.05 |
| Yearning | 9.46 | 68.38 | 10.42 | 62.29 |
| Average | 22.72 | 69.27 | 32.86 | 71.49 |

AP: average precision.
AUC: ROC-AUC [symbol]
indicates data missing or illegible when filed

### BEEU-LMA: Bodily Expressed Emotion Understanding Through Integrating Laban Movement Analysis

Bodily Expressed Emotion Understanding (BEEU) aims to automatically recognize human emotional expressions from body movements. Psychological research has demonstrated that people often move using specific motor elements to convey emotions. This work takes three steps to integrate human motor elements to study BEEU. First, we introduce BoME (Body Motor Elements), a highly precise dataset for human motor elements. Second, we apply baseline models to estimate these elements on BoME, showing that deep learning methods are capable of learning effective representations of human movement. Finally, we propose a dual-source solution to enhance the BEEU model with the BoME dataset, which trains with both motor element and emotion labels and simultaneously produces predictions for both. Through experiments on the BoLD in-the-wild emotion understanding benchmark, we showcase the significant benefit of our approach. These results may inspire further research utilizing human motor elements for emotion understanding and mental health analysis.

Recognizing human emotional expressions from images or videos is a fundamental area of research in affective computing and computer vision, with numerous applications in robotics and human-computer interaction. With the development of the Body Language Dataset (BoLD), a large-scale, in-the-wild dataset for bodily expressed emotion, and the corresponding benchmark deep neural network models, research on emotion recognition has increasingly focused on bodily expressed emotion understanding (BEEU).

In contrast to the extensively studied facial expression recognition, BEEU aims to automatically recognize emotion expression from body movements. Emotion recognition through body movements presents several advantages over reliance on facial inputs. First, in crowded scenes, a person's facial area may be obscured or lack sufficient resolution, but body movements and postures can still be reliably detected. Second, research has shown that the body may be more diagnostic than the face for emotion recognition. Third, facial areas may be inaccessible in some applications due to privacy and confidentiality concerns. Fourth, it may be difficult to fake subtle emotions through body movements, whereas facial expressions can often be manipulated. Lastly, using body movements as an additional modality can lead to more accurate recognition compared to relying solely on facial images or videos.

Facial expression recognition studies often rely on the facial action coding system (FACS) as an intermediate representation. This approach involves detecting Action Units (AUs), which are defined as the movements of specific facial muscles in FACS, and subsequently using these detections to recognize emotions. This method is based on the fact that certain muscles (AUs) contract to produce specific facial expressions, such as the corrugator muscle contracting to frown and express anger.

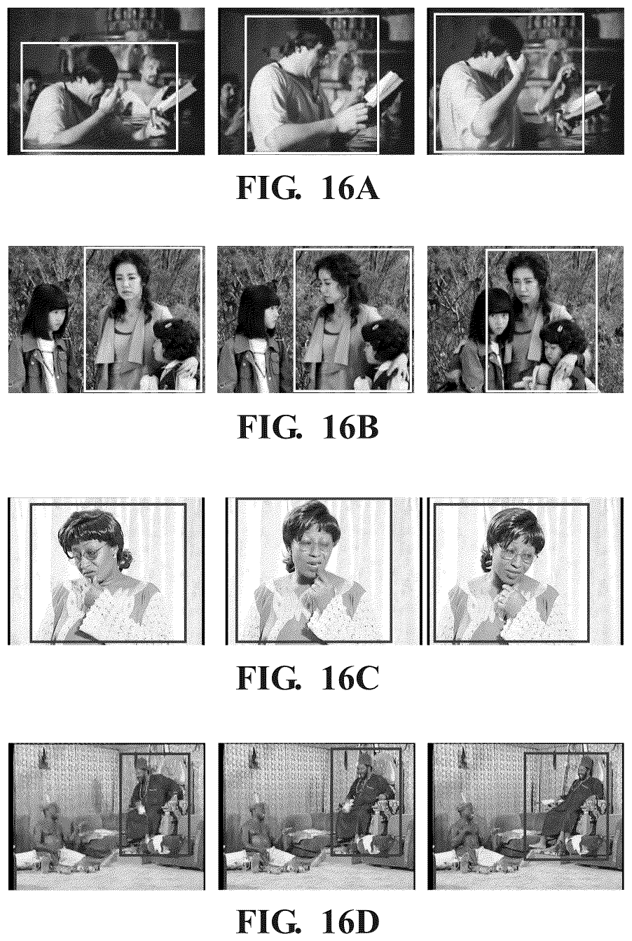

Similarly, people use particular body muscles and skeletal parts to communicate their emotions. For instance, individuals may touch their heads with their hands when feeling sad, as illustrated in FIG. 16A. By describing specific movements common to humans and the motor elements that make up these movements, we can establish the relationship between these motor elements and bodily expressed emotion, mirroring the role of FACS in facial expression recognition.

Compared to facial muscle movements, motor elements are often more readily detectable in a video of a person. Additionally, these motor elements are generally more clearly defined, rendering them simpler for AI to recognize. Consequently, motor elements can function as a suitable intermediate representation for BEEU, bridging the gap between low-level movement features (e.g., the velocity of human joints) and emotion category labels.

Although some previous studies on BEEU have incorporated motor elements, there remains a gap in the utilization of deep learning-based methods to construct the comprehensive representation of human motion. One pioneering work by camurri2003recognizing focused on dance movements and utilized handcrafted features such as Quantity of Motion (QoM) and Contraction Index (CI) to represent motion descriptors and expressive cues. The extracted features were then inputted into various classifiers, including multiple regression and Support Vector Machines (SVM). Subsequent studies followed a similar pipeline, with luo2020arbee employing only low-level movement features (e.g., velocity and acceleration of human joints) and subsequently using Random Forest for emotion classification. Supported by the European Union H2020 Dance Project, niewiadomski2019does designed handcrafted features to represent the Lightness and Fragility of human movement, while piana2016adaptive constructed multiple motion features from the 3D coordinates of human joints and employed linear SVM for classification. However, these methods did not utilize deep neural networks to extract profound learning representations, and handcrafted features often rely on 3D motion data (i.e., 3D coordinates of human joints) as input, which can only be obtained within a lab-controlled environment, thereby limiting their potential applications. A recent study supported by the European Union H2020 EnTimeMent Project employed a neural network for emotion recognition. However, the method still requires the use of a motion capture system to collect 3D motion data in a lab environment as input. Some other deep learning-based approaches on BEEU utilized techniques developed for video or action recognition, directly feeding human movement videos into a video-recognition network and predicting emotion categories without considering the understanding of motor elements.

In this work, we introduce a novel paradigm for BEEU that incorporates motor element analysis. Our approach leverages deep neural networks to recognize motor elements, which are subsequently used as intermediate features for emotion recognition.

A primary challenge in implementing this approach is the limited availability of extensive public image or video datasets suitable for deep learning-based motor element analysis. To tackle this issue, we created the BoME (Body Motor Elements) dataset, comprising 1,600 high-quality video clips of human movements. We consider different human movements within a single video as distinct clips. Each of these clips is annotated with precise, expert-provided movement labels. We used the AVA video dataset as the video source and applied the Laban Movement Analysis (LMA) system to describe the motor elements. LMA, which originated within the dance community in the early 20th century, has evolved into an internationally recognized framework for describing and comprehending human bodily motions. It characterizes human movements into five categories: Body, Effort, Space, Shape, and Phrasing, and includes over a hundred detailed motor elements. To balance the tradeoff between the number of LMA elements and the cost of annotation, we selectively included eleven emotion-related LMA elements. This decision was guided by preliminary psychological research exploring the relationship between emotions and motor elements as described by LMA. We designed a systematic procedure for dataset collection and invited a Certified Movement Analyst (CMA), an expert in LMA, to annotate the presence of LMA elements in the human movement clips. FIGS. 16A-16D show some examples of the BoME dataset. Three sample frames are shown for each clip. Instances of interest are bounded by red boxes. The LMA motor elements annotated based on the movement of the person in the red box are shown. Subfigures A to D incorporate frames from the films ‘Wagner’ (1983, directed by Tony Palmer), ‘Heaven's Garden’ (2011, directed by Jong-han Lee), ‘REVIVAL—Nigerian Nollywood Movie’ (2000), and ‘The Priest Must Die 2—Nigerian Nollywood Movie’ (2009), respectively.

Using the established BoME dataset, we examined whether deep neural networks can learn an effective representation of human movement. We deployed several state-of-the-art video recognition networks on BoME to estimate the LMA elements and investigated the impact of factors such as video sampling rate and pre-training datasets on network performance. The results showed that these methods, particularly the Video Swin Transformer, performed well on the BoME dataset, indicating that deep neural networks could learn an appropriate movement representation from BoME.

Lastly, we conducted experiments to enhance BEEU by using the BoME dataset as an additional source of supervision. We designed a dual-branch, dual-task network called Movement Analysis Network (MANet), whose branches produce predictions for bodily expressed emotion and LMA labels, respectively. To effectively utilize the movement representation in emotion recognition, we integrated the LMA branch features into the emotion branch. We also introduced a new Bridge loss that enables LMA prediction to supervise emotion prediction. Employing a weak supervision strategy, we trained MANet on both the BEEU benchmark BoLD and the BoME dataset. The BEEU results on the BoLD validation and test sets revealed that our approach significantly outperformed all single-task baselines (i.e., approaches that only consider BEEU).

### 2 Results

### 2.1 Statistical Analysis Confirms the Effectiveness of the LMA Motor Elements

In order to improve the ability of deep neural networks to learn human movement representation and subsequently enhance emotion recognition, we created a high-precision motor element dataset named BoME. This dataset consists of 1,600 human video clips, each expertly annotated with LMA labels. To achieve a balance between precision and utility, we annotated each clip with eleven LMA elements. Research has indicated that these elements are associated with sadness and happiness and are relevant for emotion elicitation and emotional expression, making them valuable for understanding bodily expression. Additionally, annotating eleven elements is not an overly laborious task for LMA experts, ensuring the quality of the dataset. Table 10 lists the eleven elements and their associated emotions, LMA categories, and descriptions. The Experimental Procedures section provides a comprehensive explanation of our choice of LMA elements and outlines the methodology employed for dataset collection.

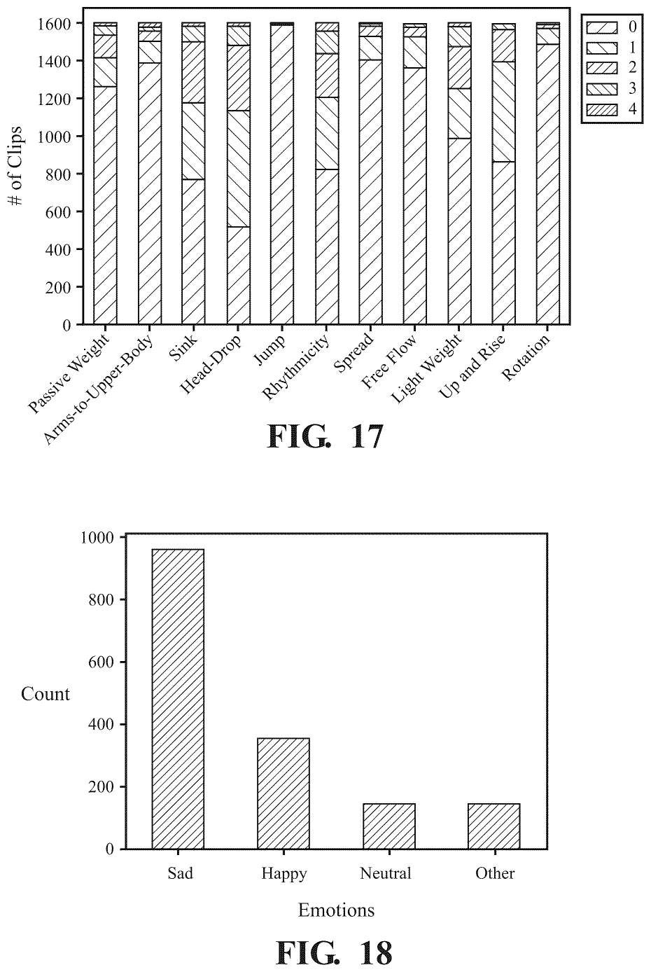

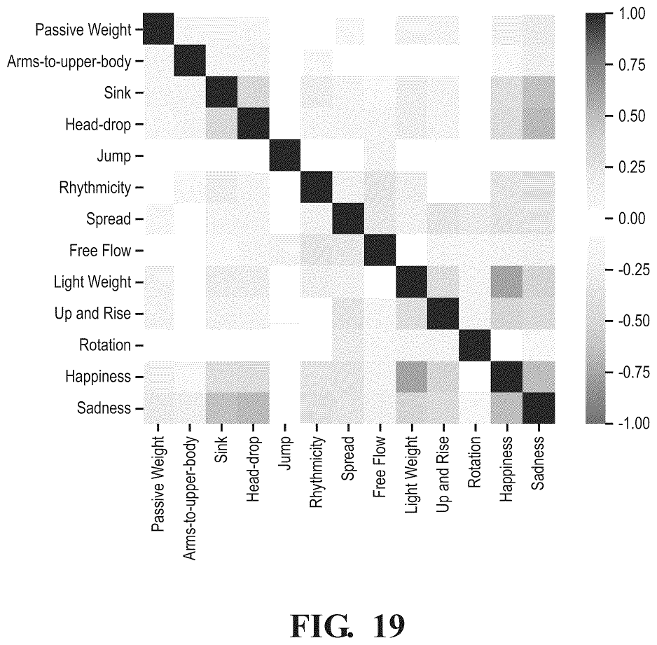

For each LMA element, we assigned a five-level label based on the element's duration and intensity in the clip, with level 0 indicating no presence and level 4 signifying maximum presence. The distribution of the five levels for each LMA element is shown in FIG. 17. The Head-drop element is relatively commonly present in videos, while Jump cases are rare. The five-level label can also be interpreted as a binary label, with level 0 representing a negative label and non-zero levels denoting a positive label. On average, each clip in the BoME dataset includes 3.2 positive LMA elements, with a minimum of one and a maximum of ten positive elements per clip. The frequency of each emotion categories is shown in FIG. 18. Here, we can see that the emotion categories are imbalanced with high count ratio between “sad” and “happy”. This may result from the fact that “sad” emotion is more easily recognizable for human annotators compared to the other emotion categories.

TABLE 10
The eleven LMA elements coded in the BoME dataset

| | LMA Element | LMA Category | Description |
|---|---|---|---|
| Sadness | Passive | Effort | Lack of active attitude towards weight, resulting in sagging, |
| | Weight | | heaviness, limpness, or dropping. |
| | Arms-to- | Body | Hands or arms touching any part of the upper body (head, |
| | upper-body | | neck, shoulders, or chest). |
| | Sink | Shape | Shortening of the torso and head and letting the center of |
| | | | gravity drop downwards, so the torso is convex on the front. |
| | Head-drop | Body | Releasing the weight of the head forward and downward, |
| | | | using the quality of Passive Weight. Dropping the head down. |
| Happiness | Jump | Body | Any type of jumping. |
| | Rhythmicity | Phrasing | Rhythmic repetition of any aspect of the movement, like |
| | | | bouncing, rocking, bobbing, twisting, from side to side, etc. |
| | Spread | Shape | When the mover opens his body to become wider. |
| | Free Flow | Effort | Lessening movement control, moving like you ‘go with the |
| | | | flow.’ |
| | Light Weight | Effort | Moving with a sense of lightness and buoyancy of the body or |
| | | | its parts; gentle or delicate movement with very little pressure |
| | | | and a sense of letting go upward. |
| | Up and Rise^{a} | Space/Shape | Up means going in the upward direction in the allocentric |
| | | | space. Rise means raising the chest up by lengthening the |
| | | | torso. |
| | Rotation | Space | Rotating a body part, or turning the entire body around itself in |
| | | | space, like in a Sufi dance. |

Psychological studies indicate that the first four elements are associated with sadness and the rest with happiness.
^{a}Up and Rise are two elements within the Space and Shape categories, respectively. We follow Shafir et al., Melzer et al.^{24, 25} to merge them into one element because these movements are affined, often occurring together.

To confirm the association of the LMA element labels in BoME with specific emotions, the annotator assigned an emotion label to each clip, which was limited to three categories: sadness, happiness, and other emotions. Although emotion recognition studies often require a larger number of emotional categories, we restricted ourselves to these three categories to validate the effectiveness of the LMA element labels.

For each human clip in BoME, we assigned a binary value (0 or 1) to the sadness and happiness emotion categories based on the emotion label, as well as a five-level label (ranging from 0 to 4) for each LMA element. Using these values, we calculated the correlation between LMA elements and the two emotion categories-sadness and happiness-encompassing all the samples marked with these two emotions within the dataset. The correlations are visually depicted in FIG. 19. This confirms the association between the selected LMA elements and the emotions of happiness and sadness. We discovered that Sink and Head-drop were strongly positively correlated with sadness, while Light Weight, Up, and Rise exhibited significant positive correlations with happiness. These results align with previous psychological studies. Conversely, Jump and Rotation did not demonstrate a substantial correlation with either sadness or happiness, which could be attributed to the relatively small sample size for these elements. Additionally, based on the emotion labels, we found that instances of sadness accounted for 59.9% of the BoME dataset, while cases of happiness accounted for only 22.2%. This imbalance may stem from the fact that sadness is more easily recognizable to human annotators compared to other emotion categories.

### 2.2 Deep Neural Networks are Capable of Estimating LMA Motor Elements

In order to examine the potential of deep learning methods to learn an effective representation of human movement, we applied deep neural networks to estimate LMA elements on the BoME dataset. We randomly divided the dataset into a training set consisting of 1,448 samples and a test set containing 152 samples. The original LMA element labels had five levels, but levels 3 and 4 had limited sample sizes, as demonstrated in FIG. 17. This posed a challenge for models to accurately estimate the LMA elements. Furthermore, deep neural networks may struggle to precisely determine the duration of each element in a clip, unlike LMA experts. To simplify the task, we treated the LMA element estimation problem as a multi-label binary classification task, with level 0 being designated as a negative label and all non-zero levels as positive labels.

We evaluated the classification performance using two metrics: average precision (AP), or the area under the precision-recall curve, and the area under the receiver operating characteristic curve (AUC-ROC). We reported the mean average precision (mAP) and mean AUC-ROC (mRA) across all categories of LMA elements. Notably, we only used ten elements and excluded the Jump element due to the dataset containing an insufficient number of samples (only 11) for Jump.

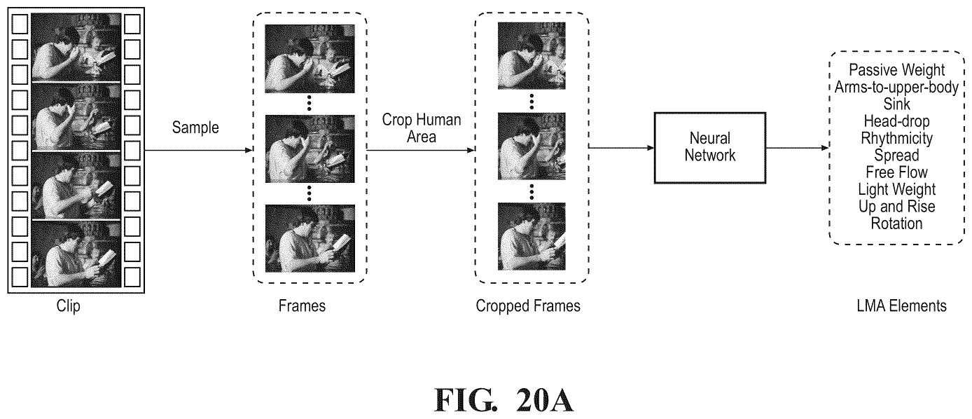

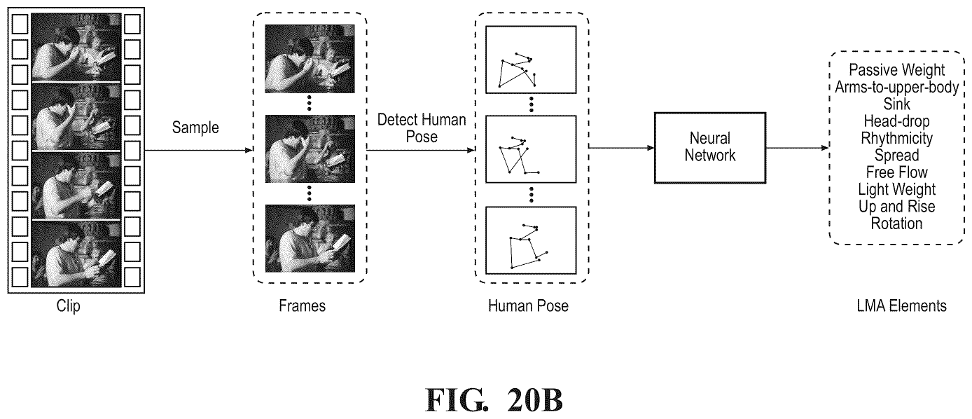

As a natural initial attempt, we employed a range of deep learning-based video recognition algorithms to estimate LMA elements from video clips. These algorithms can be categorized based on their input modality as either RGB-based or skeleton-based. FIGS. 20A and 20B show RGB-based and skeleton-based pipelines for estimating the LMA elements, incorporating frames from the film ‘Wagner’ (1983, directed by Tony Palmer). FIG. 20A shows that the RGB-based pipeline extracts frames from the input clip, crops the target human, and feeds the resultant frames into a neural network. FIG. 20B shows the skeleton-based pipeline leverages the 2D/3D human pose extracted from the frames as the input for a neural network.

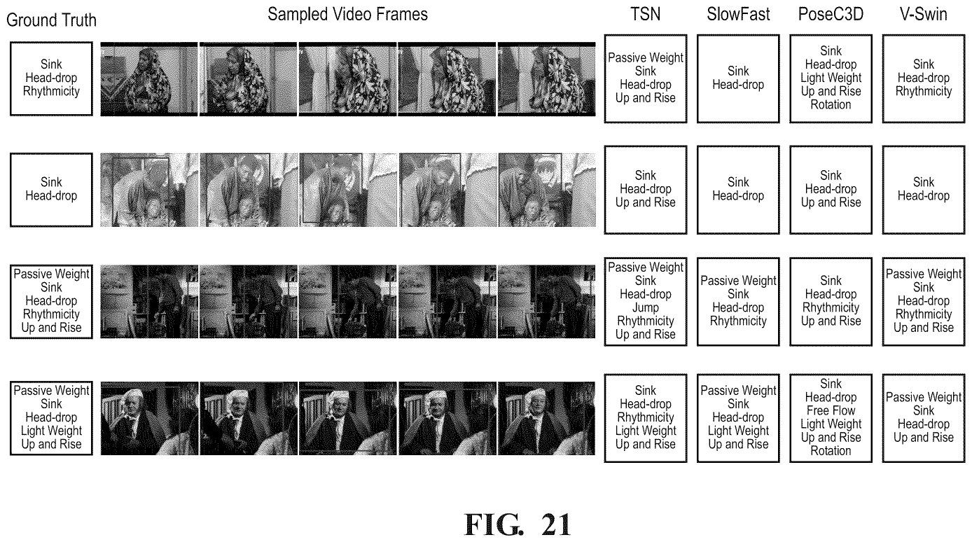

We illustrate the RGB-based and skeleton-based pipeline in FIG. 21. Five frames sampled from each clip are shown. The predicted LMA elements that are also in the ground truth list are shown in green color.

We selected four representative video recognition approaches from recent years to benchmark the BoME dataset: Temporal Segment Network (TSN), SlowFast, Video Swin Transformer (V-Swin), and PoseC3D. The first three methods are RGB-based, while PoseC3D is skeleton-based.

The performance of these four algorithms is compared in Table 11. The following outlines the input processing and neural network for each approach:
TSN partitions a single input clip into multiple sub-clips, selecting one random frame from each. Table 11 employs three sampling rates—the input clip is segmented into 8, 16, or 24 sub-clips, resulting in 8, 16, or 24 frames. For each frame, we cropped the human region from the entire RGB image and resized the area to 224×224 pixels. Region detection was facilitated using OpenPose. The processed frames were subsequently fed into a 2D convolutional neural network. We have chosen the widely used ResNet-50 as our 2D convolutional network. Note that while the original TSN incorporates both optical-flow images and RGB images as input, we exclusively used the RGB input without optical-flow to ensure a fair comparison with other RGB-based methods.
SlowFast samples 32, 48, or 64 frames from the entire input clip, maintaining a temporal stride of 2 between consecutive samples. Consistent with the TSN approach, we cropped the human region from the entire RGB image and resized the area to 224×224 for each frame. The extracted and cropped RGB images were then input into a 3D-convolutional network. We adopted a variant of the 3D convolutional ResNet-101 as the network, in accordance with the original paper.
V-Swin employs the same input processing procedure as SlowFast. However, V-Swin utilizes a 3D-Transformer network, adapted from the 2D Swin Transformer. We followed the base-Swin setting as outlined in the original paper.
PoseC3D uniformly samples 48, 72, or 96 frames from the entire input clip. Subsequently, 2D human pose inputs are detected by OpenPose. Finally, a 3D-convolutional network processes the human poses and generates predictions. We adopted the network structure provided by MMaction2.

All presented methods can be trained from scratch or pretrained using various existing datasets. Pretraining refers to the process of initially training a model on one dataset before fine-tuning it on the target dataset, in this case, BoME. In Table 11, we leveraged the image classification datasets ImageNet-1K/ImageNet-22K and the video recognition dataset Kinetics400 for pretraining purposes. For other aspects, such as the testing strategy, we followed the implementation guidelines provided by the MMaction2 codebase.

Our analysis of Table 11 yields several key insights. Firstly, pre-training significantly enhances the performances of all four algorithms. Specifically, pre-training with ImageNet leads to a notable improvement compared to training from scratch, with gains of 5.72 mAP (%) and 6.48 mRA (%) for TSN, and 3.57 mAP (%) and 2.99 mRA (%) for V-Swin. Pre-training on Kinetics-400 produces even more substantial improvements, with increases of 8.32, 10.07, 14.09, and 5.87 mAP (%) for TSN, SlowFast, V-Swin, and PoseC3D, respectively. This is expected, as the Kinetics-400 dataset is specifically designed for human activity classification, and some human characteristic features can be transferred to the LMA estimation task.

TABLE 11
Benchmarking the BoME dataset with four deep learning-based methods

| | | | | | | FLOPs | Param. |
|---|---|---|---|---|---|---|---|
| Method | Type | Pretrain | mAP(%) | mRA(%) | Samples | (×10⁹) | (×10⁶) |
| TSN | RGB-based | Scratch | 40.71 | 60.42 | 8 × 1 | 7.3 | 23.5 |
| TSN | RGB-based | ImageNet-1k | 46.43 | 66.90 | 8 × 1 | 7.3 | 23.5 |
| TSN | RGB-based | Kinetics-400 | 49.03 | 68.58 | 8 × 1 | 7.3 | 23.5 |
| TSN | RGB-based | Kinetics-400 | 51.02 | 69.91 | 16 × 1 | 7.3 | 23.5 |
| TSN | RGB-based | Kinetics-400 | 50.58 | 70.35 | 24 × 1 | 7.3 | 23.5 |
| SlowFast | RGB-based | Scratch | 39.20 | 59.28 | 1 × 32 | 174 | 62.0 |
| SlowFast | RGB-based | Kinetics-400 | 49.27 | 69.23 | 1 × 32 | 174 | 62.0 |
| SlowFast | RGB-based | Kinetics-400 | 48.62 | 68.19 | 1 × 48 | 260 | 62.0 |
| SlowFast | RGB-based | Kinetics-400 | 47.70 | 68.12 | 1 × 64 | 347 | 62.0 |
| V-Swin | RGB-based | Scratch | 39.58 | 59.33 | 1 × 32 | 282 | 88.1 |
| V-Swin | RGB-based | ImageNet-1k | 43.15 | 62.32 | 1 × 32 | 282 | 88.1 |
| V-Swin | RGB-based | ImageNet- | 48.88 | 66.49 | 1 × 32 | 282 | 88.1 |
| | | 21k | | | | | |
| V-Swin | RGB-based | Kinetics-400 | 53.67 | 72.82 | 1 × 32 | 282 | 88.1 |
| V-Swin | RGB-based | Kinetics-400 | 50.78 | 69.55 | 1 × 48 | 423 | 88.1 |
| V-Swin | RGB-based | Kinetics-400 | 46.79 | 64.42 | 1 × 64 | 564 | 88.1 |
| PoseC3D | Skeleton- | Scratch | 38.88 | 58.45 | 1 × 48 | 15 | 3.0 |
| | based | | | | | | |
| PoseC3D | Skeleton- | Kinetics-400 | 44.75 | 61.75 | 1 × 48 | 15 | 3.0 |
| | based | | | | | | |
| PoseC3D | Skeleton- | Kinetics-400 | 50.30 | 64.72 | 1 × 72 | 22 | 3.0 |
| | based | | | | | | |
| PoseC3D | Skeleton- | Kinetics-400 | 46.93 | 64.93 | 1 × 96 | 29 | 3.0 |
| | based | | | | | | |

“Samples” means number of sub-clip × number of frames per sub-clip in training when sampling one input clip.
“FLOPs” represent the computational complexity of a neural network.
“Param.” determines the network's size and capacity to learn.
The numbers highlighted in bold represent the best performance in each method.

Moreover, our results suggest that the sample rate at which the input clip is extracted into frames may impact performance. A higher density of frame samples within a clip may allow for more information to be extracted, but may also hinder the model's ability to analyze such densely packed frames, leading to a decrease in performance. TSN achieves the best performance when the clip is split into 16 sub-clips. SlowFast and V-Swin exhibit worse performance with denser sampling rates than the default rate. PoseC3D performs optimally with a sampling rate of 72 frames per clip, the densest among the four algorithms. This may be because PoseC3D uses skeleton coordinates as input, which may be easier for the neural network to interpret compared to images.

Lastly, our results show that V-Swin achieves the best performance (53.67 mAP (%) and 72.82 mRA (%)) among the four algorithms, with 32 samples per clip and pre-training on Kinetics-400. Despite using only skeleton input, PoseC3D attains competitive mAP performance compared to TSN and SlowFast.

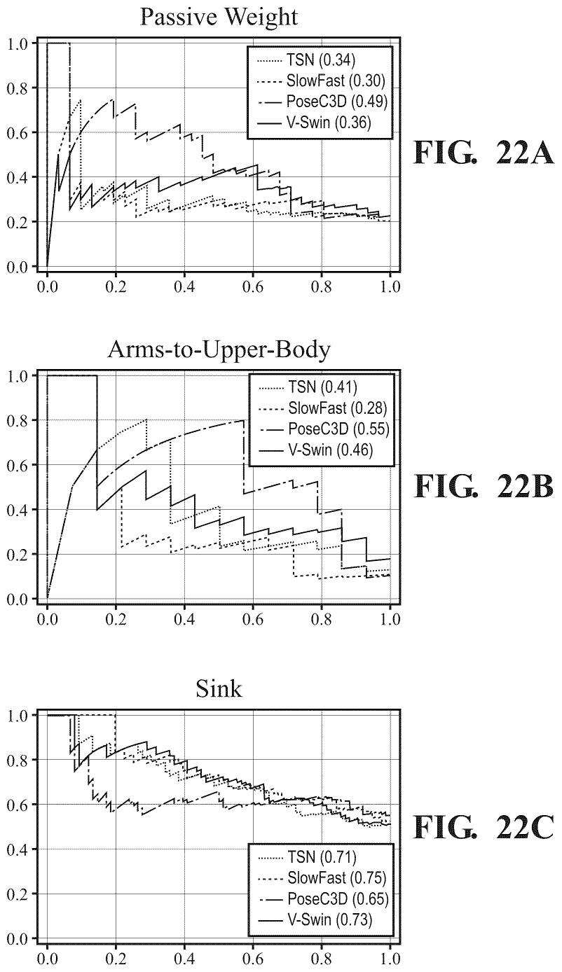

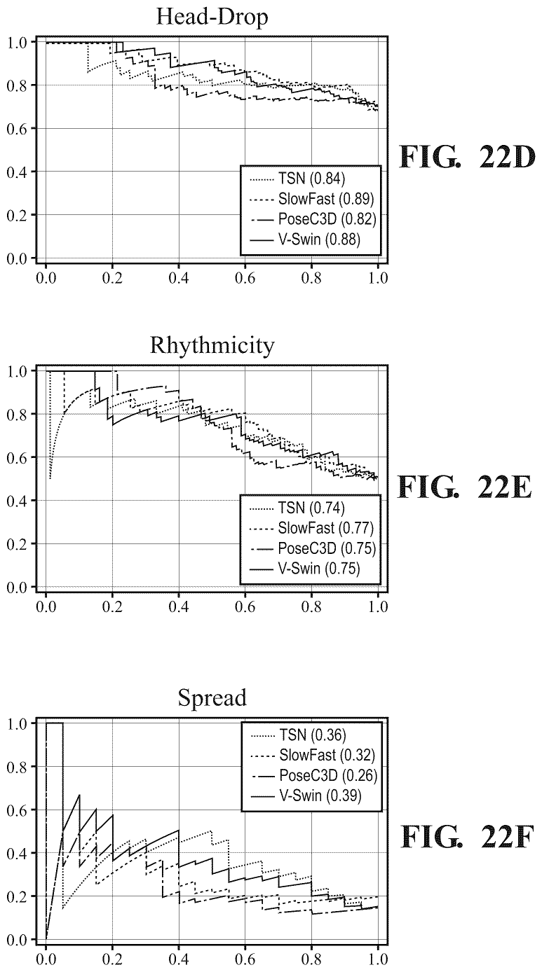

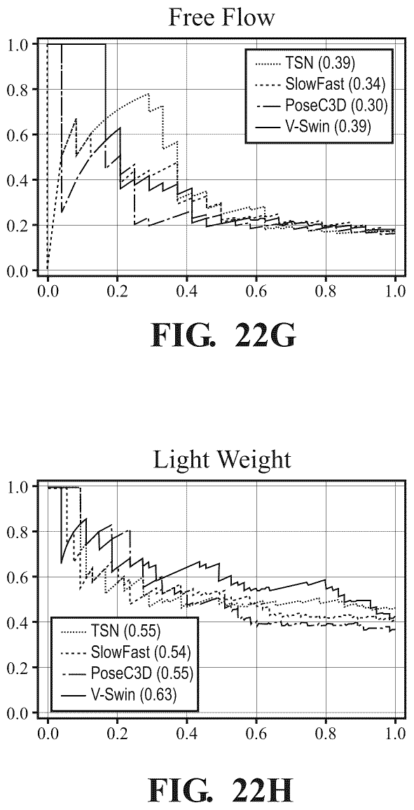

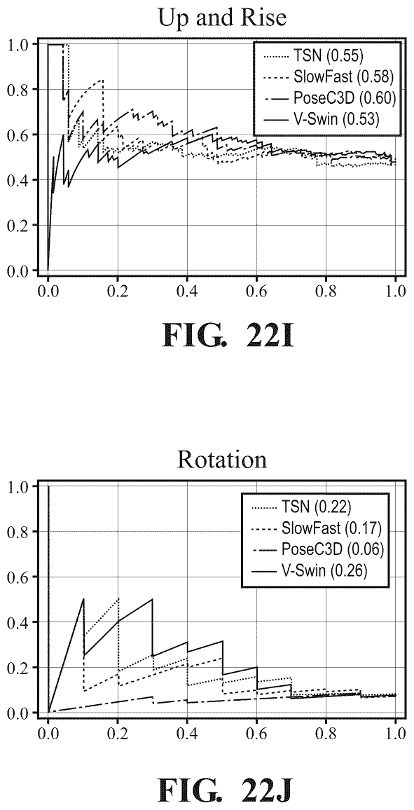

Based on the mAP values, we have selected the best-performing model for each algorithm. Some qualitative examples of LMA element estimation by different models, along with the ground truth (i.e., the labels provided by the CMA), are shown in FIG. 21. We also conducted a breakdown analysis. FIGS. 22A-22J present the precision-recall curves for various models across all the LMA elements. Notably, V-Swin outperforms the other algorithms on the Light Weight and Rotation elements. PoseC3D performs particularly well on the Passive Weight and Arms-to-upper-body elements, but poorly on the Spread and Rotation elements.

### 2.3 LMA Enhances Bodily Expressed Emotion Understanding

In this subsection, we aim to achieve the ultimate goal of enhancing BEEU by integrating LMA element labels. As aforementioned, several psychological studies have demonstrated a strong correspondence between the eleven LMA elements and emotion categories sadness and happiness. Our previous statistical analysis has confirmed this finding in the BoME dataset. Furthermore, we have shown that deep neural networks can learn an effective body movement representation from BoME. The optimal performance for LMA element estimation on BoME is 53.67 mAP (%) and 72.72 mRA (%), which is significantly higher than the best results achieved in BEEU (19.30 mAP (%) and 66.94 mRA (%)) on the bodily expression benchmark BoLD. This is likely due to the fact that LMA elements have a more objective definition than emotion categories, as the presence of LMA elements in a human clip depends solely on the body movement, whereas emotion labels may also be influenced by the annotators' emotional state. In summary, emotion and LMA element labels are related, and LMA element labels are easier for deep neural networks to learn. Thus, incorporating the human movement features learned from BoME into BEEU presents a promising approach.

To achieve our goal of improving BEEU, we need to train and test on the BEEU benchmark dataset BoLD, using the BoME dataset as an additional training source. In this set of experiments, we jointly trained on the BoLD training set and the entire BoME dataset, and then evaluated the model on the BoLD validation and test sets. It is worth noting that BEEU on BoLD, like LMA estimation, involves multi-label binary classification tasks. We have also adopted mAP and mRA as evaluation metrics.

FIG. 23 illustrates the proposed method involving the creation of a dual-branch, dual-task neural network, named MANet. We adopt the same input processing technique as SlowFast and V-Swin from the previous subsection. By sampling 48 frames from the input clip and subsequently employing OpenPose to detect the human region within these frames, we crop and resize the area to 224×224 as input, resulting in an input shape of 48×224×224. The processed frames then fed into the neural network.

We have implemented two essential design elements in the neural network to enable LMA annotations to support BEEU. First, as shown in FIG. 23, we designed a dual-branch network structure that allowed the model to produce LMA and emotion predictions concurrently. We employed Swin blocks (i.e., architecture building blocks in V-Swin) to construct the MANet's backbone, followed by the Emotion branch and the LMA branch. The LMA branch extracts LMA features from the backbone's output and utilizes a linear classifier to generate the LMA output. Second, we incorporated a fusion operation by combining the LMA branch features with the emotion features, enabling the emotion predictions to be informed by human movement features. In the Emotion branch, the fused features are fed into a linear classifier to yield the emotion output. We provide more details of the model structure in the Experimental Procedure section.

We employed various loss functions to supervise the training of MANet. As both emotion and LMA predictions involve multi-label binary classification tasks, we utilized the multi-label binary cross-entropy loss to compute Emotion loss and LMA loss by comparing their respective outputs with ground truth labels. Furthermore, we introduced the Bridge loss to create a connection between LMA and emotion prediction based on the relationship between LMA and specific emotion categories (i.e., sadness and happiness). Importantly, we used a threshold e in Bridge loss to control the extent of LMA prediction supervision over emotion prediction.

Moreover, we utilized a weakly supervised training approach to enable joint training despite some BoLD samples lack LMA labels and some BoME samples are missing emotion labels. Comprehensive information on the loss function design and training procedure can be found in the Experimental Procedures section.

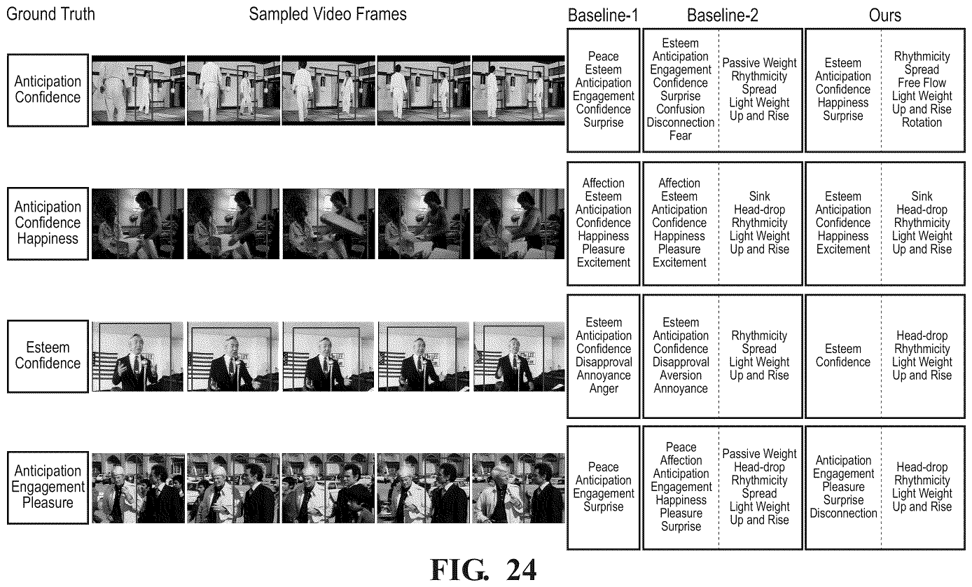

Table 12 presents the results of the ablation study. The first set of experiments evaluates the impact of the model structure on performance. The method without the dual-branch and fusion components refers to training emotion labels using only the original V-Swin architecture. In this case, the performance is 19.97 mAP (%) and 67.16 mRA (%) on the BoLD validation set. Incorporating the dual-branch structure, but omitting fusion, does not significantly improve performance compared to the original V-Swin. However, the fusion operation leads to a 0.46 mAP (%) and 0.60 mRA (%) increase over the original V-Swin. This suggests that multi-task training and feature fusion are both necessary for improving BEEU. The effectiveness of the Bridge loss is also analyzed. As detailed in Experimental Procedures, the initial version of the Bridge loss does not incorporate the threshold e, and its performance does not differ significantly from the model without the loss. However, by adding e and setting it to 0.9, the Bridge loss leads to a significant improvement of 0.82 mAP (%) and 0.56 mRA (%). Thus, the final MANet model consists of the Bridge loss, dual-branch structure, and fusion operation, yielding an overall mAP increase of 6.4% (from 19.97 to 21.25). Qualitative examples of bodily expression estimation using the final model and two baselines are shown in FIG. 24.

Categorical emotion labels are predicted based on a video clip of a person. Five frames sampled from each clip are shown. The predicted emotion labels that are also in the ground truth list are shown in blue color. Baseline-1 is the original V-Swin without dual-branch and fusion. Baseline-2 is the MANet model without the Bridge loss. Ours is the final model of MANet. We also present the predicted LMA elements in green color. Baseline-1 does not provide LMA predictions because it only outputs emotion prediction. The figure incorporates frames from the films, listed from top to bottom, ‘Return of the Tiger’ (1978, directed by Jimmy Shaw), ‘Ragin’ Cajun’ (1990, directed by William Byron Hillman), ‘Eye of the Stranger’ (1993, directed by David Heavener), and ‘Teheran Incident’ (1979, directed by Leslie H. Martinson).

TABLE 12
Ablation on the architecture and Bridge loss

| Dual-branch | Fusion | Bridge Loss | mAP(%) | mRA(%) |
|---|---|---|---|---|
| — | — | — | 19.97 | 67.16 |
| ✓ | — | — | 19.94 | 67.34 |
| ✓ | ✓ | — | 20.43 | 67.76 |
| ✓ | ✓ | w/o ε | 20.42 | 66.88 |
| ✓ | ✓ | ε = 0.7 | 19.78 | 67.44 |
| ✓ | ✓ | ε = 0.8 | 20.55 | 67.43 |
| ✓ | ✓ | ε = 0.9 | 21.25 | 68.32 |
| ✓ | ✓ | ε = 0.99 | 20.67 | 67.57 |

Evaluation is done on the BoLD validation set.

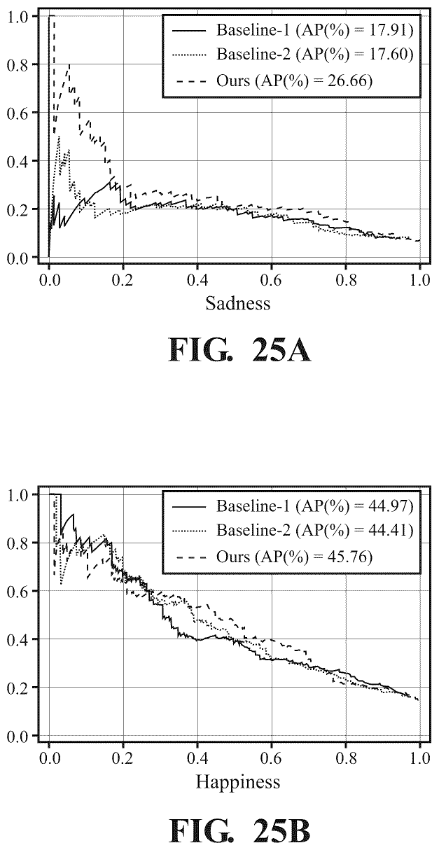

The central idea of the Bridge loss is to use LMA prediction to supervise the prediction of sadness and happiness. To further investigate the impact of the Bridge loss on these two emotion categories, we present precision-recall curves for sadness and happiness in FIGS. 25A-25B for the final model and two baselines. These results show that the Bridge loss leads to a significant improvement in sadness, with an increase of 8.75 AP (%) and 9.06 AP (%) over Baseline-1 and Baseline-2, respectively. There is also a notable improvement in the happiness category. Additionally, Table S1 in the supplemental information provides an analysis across all emotion categories.

TABLE 13
Comparison with the state of the art
on the BoLD validation and test set

| Set | Method | Year | mAP(%) | mRA(%) |
|---|---|---|---|---|
| Validation | TSN²⁹ | 2018 | 18.55 | 64.27 |
| | Filntisis et al.⁸ | 2020 | 16.56 | 62.66 |
| | Pikoulis et al.³⁸ | 2021 | 19.30 | 66.94 |
| | Beyan et al.^{20, b} | 2021 | 15.86 | 62.63 |
| | MANet | 2023 | 21.25 | 68.32 |
| Test | I3D³⁹ | 2017 | 15.37 | 61.24 |
| | TSN²⁹ | 2018 | 17.02 | 62.70 |
| | ST-GCN^{40, b} | 2018 | 12.63 | 55.96 |
| | Filntisis et al.⁸ | 2020 | 17.96 | 64.16 |
| | Random Forest^{6, b} | 2020 | 13.59 | 57.71 |
| | Pikoulis et al.^{38, a} | 2021 | 21.87 | 68.29 |
| | Beyan et al.^{20, b} | 2021 | 16.73 | 62.17 |
| | MANet | 2023 | 22.11 | 67.69 |
| | MANet^{a} | 2023 | 23.09 | 69.23 |

^{a}represents model ensembles.
^{b}represents skeleton-based method. The numbers highlighted in bold represent the best performance in the validation or test set.

Table 13 presents a comparison of MANet's performance with that of previous state-of-the-art methods on the BoLD validation and test sets. Our study re-implemented the state-of-the-art emotion work by beyan2021modeling. We achieved this using the public code they provided, applied specifically to the BoLD dataset. We collected performance data for other competitive models from their papers or from the ARBEE work. Results from the table show that MANet outperforms the approach by pikoulis2021leveraging by 1.95 mAP (%) and 1.38 mRA (%) on the BoLD validation set. On the test set, the single model of MANet delivers comparable performance to model ensembles of pikoulis2021leveraging. Employing the same ensemble strategy, the mAP of MANet surpasses the work of pikoulis2021leveraging by 5.6%. The superior performance of MANet is attributed to its use of BoME as an additional source of training data, despite its smaller size (approximately one-sixth of the BoLD training set). Compared to beyan2021modeling, our method exhibits substantially better performance. The difference in performance may arise from two factors. First, our study focuses on in-the-wild data, whereas beyan2021modeling concentrates on lab-collected data, leading to a domain gap. Second, beyan2021modeling relied on 3D motion capture data, which is not available for the BoLD dataset. Instead, we used OpenPose to extract 2D pose data as input, which may have reduced the performance of beyan2021modeling. Despite these differences, beyan2021modeling's state-of-the-art emotion work still outperforms some other skeleton-based methods.

### 3 Discussion

In this study, we present BoME, an innovative dataset grounded in Laban Movement Analysis (LMA) for human motor elements. We showcase the effectiveness of deep neural networks in capturing human movement representation through the utilization of this dataset. Furthermore, we propose MANet, a cutting-edge dual-branch model designed for the understanding of bodily expressed emotions. This model harnesses the supervisory information provided by BoME, employing a specialized model architecture, a custom loss function, and a weakly-supervised training strategy. As a result, MANet surpasses existing approaches in the domain of BEEU.

This study employs eleven distinct LMA elements known to be related to sadness and happiness to enhance BEEU. With the LMA system encompassing over 100 elements, there is considerable potential for additional elements to contribute to emotion recognition. To build upon this work, we suggest two main avenues for future endeavors. First, it is recommended to expand the dataset and enrich it with more annotations, incorporating a broader range of LMA element labels and emotion labels. Second, we anticipate that further research in the fields of psychology and affective computing could reveal valuable insights into the relationships between LMA elements and emotions. Such advancements would ultimately enhance BEEU research and facilitate a deeper understanding of human emotions as expressed through movement.

This work has established that LMA contributes significantly to the task of BEEU. LMA could potentially enhance other computer vision tasks as well, such as general human action recognition. It is evident that certain LMA elements are associated with specific human actions. For instance, in sports activities like tennis, players swing their rackets, and swimmers exhibit distinct strokes. The LMA system utilizes various labels to describe these actions. Similarly, in human social activities, certain actions, such as shaking hands, are characteristic, and the LMA system can assist in recognizing them. However, as mentioned earlier, this would necessitate additional LMA element annotation, as the current 11 elements are not sufficient. In the future, we may consider expanding the LMA annotation labels to facilitate the analysis of a broader range of human activities.

Our exploration of LMA and emotion recognition holds significant potential for practical applications across various domains, particularly those where explanation and understanding are crucial or preferred. One such area is the medical field, particularly in the care of mental health patients. By monitoring patients' body movement patterns, healthcare professionals can be alerted about a need to directly observe their emotional states and an explanation can be given. This approach could improve efficiency in patient care. Another notable application is in robotics and human-computer interaction. Empowering robots with the ability to recognize human emotions through body movements, and to adapt their models based on repeated observations of an individual's movements, paves the way for more informed interaction decisions grounded in the individuals' emotional states. With LMA motor element recognition, a robot can incorporate different types of movement into its decision-making process due to the diverse emotional significance each carries. This advancement fosters a more personalized, natural, and empathetic human-robot interaction experience. A recent review article discusses additional example applications of improved BEEU.

In summary, incorporating LMA elements has effectively enhanced BEEU and shows promise for further advancements in the future.

### 4 Experimental Procedures

### 4.1 Resource Availability

### 4.1.1 Data and Code Availability

All the codes used in the experiments were implemented with PyTorch. We developed the code based on the open-source codebase MMaction2. The BoLD dataset is publicly available at http://cydar.ist.psu.edu/emotionchallenge. The BoME dataset and code for the model training and evaluation are available at: https://data.mendeley.com/datasets/gbhpdkf8 pg/draft?a=73081aed-b195-4227-9ed5-65bdad542589. The reserved DOI is https://doi.org/10.17632/gbhpdkf8 pg.1. The BoME dataset is also available on GitHub: https://chenyanwu.github.io/BoME.

### 4.2 Selecting Motor Element Labels

To characterize motor elements, we adopted the LMA, the most extensively developed system for encoding human movement. Rudolf von Laban (1879-1958), a renowned dance artist, choreographer, and movement theorist, spearheaded the development of LMA in the early 20th century to analyze and record body movements in dance, theatre, education, and industry. The LMA system comprises over one hundred motor elements, organized into four main categories. The Body category lists moving body parts (such as the head and arms) and some basic actions (such as jumping and walking). The Space category represents the body's spatial direction when moving, including vertical (up, down), sagittal (forward, backward), and horizontal (right side/left side). The Shape category describes how the body changes its shape, including whether it encloses or spreads, rises or sinks. The Effort category specifies the mover's inner attitude toward the movement and is expressed in the quality of the movement. It is comprised of four factors-Weight, Space, Time, and Flow. Weight-Effort refers to the amount of force applied by the mover, with a spectrum ranging from strong (applying high force) to light (applying weak force). Space-Effort ranges from direct to indirect, indicating whether the mover moves directly toward a target in space or indirectly. Time-Effort ranges from sudden to sustain, denoting the movement's acceleration. Flow-Effort ranges from bound to free flow, expressing the level of control exerted over the movement. LMA also includes the Phrasing category, which describes how the motor elements change over time.

Several studies have demonstrated that certain LMA elements are strongly associated with emotions, particularly sadness and happiness. shafir2016emotion found that specific LMA elements, when present in a movement, can elicit four fundamental emotions, including sadness and happiness, among others. melzer2019we identified LMA elements that allow movements to be classified as expressing one of these four fundamental emotions. The association between happiness and certain LMA elements was also validated by van2021move. Furthermore, another experiment by the Shafir group, conducted by Gilor for her Master's thesis, studied LMA elements used for expressing sadness and happiness. These studies provide compelling evidence that certain LMA elements can evoke or be recognized as conveying sadness and happiness. Our work builds upon these psychological findings and, following shafir2016emotion and melzer2019we, we selected eleven LMA elements associated with sadness and happiness (see Table 10) as the labels for the BoME dataset. All experiments presented in this paper are based on these motor elements.

### 4.3 the Creation of the BoME Dataset

To create the BoME dataset, we followed the same process as the BoLD dataset by using movies from the AVA dataset as our data source. This has two advantages. First, real-world video recordings often have limited body movements, but movies provide a rich variety of visual features. Second, we can match video clips from the BoLD dataset, which have emotion category labels, for joint training and emotion modeling.

The films of the AVA dataset are sourced from YouTube, and all associated copyrights are retained by the original content creators. Additionally, the Common Visual Data Foundation (CVDF) hosts these videos. During our research, we retrieved the videos from the CVDF using their GitHub repository. The CVDF offers a stable and reliable platform for researchers. In adherence to copyright regulations and the procedures established by the AVA dataset, our BoME dataset includes only the YouTube IDs of the films. This allows users to access the corresponding videos from either YouTube or the CVDF using these identifiers. It should be noted that while the videos in this dataset are intended to comply with YouTube's guidelines, which strictly prohibit explicit content such as violence and nudity, users should remain aware of the potential presence of harmful or sensitive material. Despite the diligent oversight from both YouTube and our team, occasional oversights may occur, resulting in the inclusion of such content. Users are advised to exercise discretion while accessing these videos.

To segment the long movies from the AVA dataset into clips, we employed the kernel temporal segmentation (KTS) approach, consistent with BoLD. The selection of clips was carried out by the LMA annotator, adhering to certain criteria: (1) The human subject in the clip must display clearly discernable emotions, specifically sadness or happiness, as our study is focused on the eleven motor elements associated with these two emotions according to previous research. (2) The clip should be brief, with fewer than 300 frames in total, since longer clips may contain expressions of multiple emotions, making it difficult to attribute each LMA label to the correct emotion. (3) We excluded clips in which the human subject did not display any movement. After careful screening, we ultimately chose 1,600 clips to form the BoME dataset. In the BoME dataset, we supply the initial and terminal frame numbers for each clip, enabling users to precisely locate these segments within the context of the original film.

Because each video may contain multiple people, we need to identify which person to annotate. We adopted the method proposed by luo2020arbee for human identification. Specifically, we leveraged the pose estimation network OpenPose to extract the coordinates of the human joints, which allowed us to determine a bounding box around the person's body. By implementing a tracker on this bounding box, we assigned a unique identification number to the same person in all frames of the video clip, enabling consistent annotation across the entire duration of the clip.

We enlisted the assistance of an LMA expert to provide annotations for the study. This expert is a member of a team that has received specialized training in LMA coding for scientific research and has already coded numerous hours of movements for previous quantitative studies using the same standard annotation pipeline as in our research.

The annotator was instructed to ensure that the sound in the clips was turned off during annotation to prevent any influence from auditory cues, such as tone of voice or background music, which could impact the perceived emotion. Instead, the annotator was to focus solely on the observed movements. Each clip was watched multiple times by the annotator to code all eleven variables, which are the eleven motor elements that have been linked to motor expressions of sadness and happiness in previous psychological studies. The annotator coded some of the variables during each viewing and repeated the process until all variables were coded. The annotator then watched the clip one last time to verify the accuracy of the annotations. If the LMA expert was uncertain about the correct coding, she was instructed to move and match what she saw in the clip with her own body movement and even intensify it when necessary until it became clear which motor elements constituted the movement.

The LMA expert used a standardized and consistent rating scale of 0-4 to code each motor element, taking into account both its duration (i.e., the percentage of clip duration during which the motor element was observed) and intensity. To determine the duration score, the following criteria were used:
0: The motor element was not observed in the clip.
1: The motor element was rarely observed, appearing for up to a quarter of the clip duration.
2: The motor element was observed a few times, appearing for up to half of the clip duration.
3: The motor element was often observed, appearing for up to three-quarters of the clip duration.
4: The motor element was observed for most or all of the clip duration.

If the intensity of the motor element was low, 1 was subtracted from the duration score. Conversely, if the intensity was high, 1 was added to the duration score. However, the maximum score could not exceed 4.

### 4.4 Model Structure of MANet

As illustrated in FIG. 23, the network consists of a single backbone followed by two branches: the Emotion branch and the LMA branch. The backbone is responsible for extracting image features from the input frames, and it strictly adheres to the first three stages of V-Swin. Each stage comprises multiple 3D Swin Transformer blocks, the structure of which is detailed in the V-Swin paper. We employed the base setting of V-Swin, which includes 2, 2, and 18 blocks in the first three stages, respectively. The LMA branch utilizes two 3D Swin Transformer blocks to process the output from the backbone and obtain the LMA features. Subsequently, a linear classifier within the LMA branch generates the LMA prediction. Similarly, the Emotion branch employs two 3D Swin Transformer blocks to extract the emotion features. Following this, the emotion features and the LMA features are added through a feature fusion operation. The fused features are then input into a linear classifier, which ultimately produces the emotion output.

### 4.5 Loss Functions of MANet

As depicted in FIG. 23, MANet is trained by optimizing three loss functions: Emotion loss, LMA loss, and Bridge loss.

The emotion output is represented as a vector y=[y₀, y₁, . . . , y_{N}], with N denoting the number of emotion categories (26 for BoLD). Similarly, the LMA output is expressed as z=[z₀, z₁, . . . , z_{M}], with M representing the number of LMA elements (10 for BoME). We apply the sigmoid function to yᵢ, indicated as σ(yᵢ), to determine the probability that the input sample encompasses the i^{th} label. The same is applied to zⱼ.

Let the ground truth emotion and LMA labels be ŷ=[ŷ₀, ŷ₁, . . . , ŷ_{N}] and \hat{z}=[\hat{z}₀, \hat{z}₁, . . . , \hat{z}_{N}]. For an ŷᵢ, the value is either 1 or 0, indicating whether the i^{th} label is true or false for the sample. The same is applied to \hat{z}ⱼ.

We calculated the Emotion loss and LMA loss by computing the cross-entropy between the ground truth and output predictions as follows:

$${ℒ}_{Emotion} = - \frac{1}{N} {\sum }_{i = 1}^{N} {\hat{y}}_{i} ln σ ( {y}_{i} ) + ( 1 - {\hat{y}}_{i} ) ln ( 1 - σ ( {y}_{i} ) ) ,$$

$${ℒ}_{LMA} = - \frac{1}{M} {\sum }_{j = 1}^{M} {\hat{z}}_{j} ln σ ( {z}_{j} ) + ( 1 - {\hat{z}}_{j} ) ln ( 1 - σ ( {z}_{j} ) ) .$$

Previously, we established that the first four LMA elements were associated with sadness, while the remaining elements were associated with happiness. Utilizing this information, we developed the Bridge loss to guide the prediction of sadness and happiness. Specifically, for Z=[z₀, z₁, . . . , z_{M}], we selected the maximum predictions among the sadness- and happiness-related LMA elements, denoted as

$$max {\{ {z}_{i} \}}_{i = 1}^{4} and max {\{ {z}_{i} \}}_{i = 5}^{M} ,$$

respectively. By calculating the softmax of two values, we obtained the probabilities for sadness and happiness. Formally, we have,

$${p}_{sadness} = \frac{{e}^{max {\{ {z}_{i} \}}_{i = 1}^{4}}}{{e}^{max {\{ {z}_{i} \}}_{i = 1}^{4} +} {e}^{max {\{ {z}_{i} \}}_{i = 5}^{M}}} ,$$

$${p}_{happiness} = \frac{{e}^{max {\{ {z}_{i} \}}_{i = 5}^{M}}}{{e}^{max {\{ {z}_{i} \}}_{i = 1}^{4} +} {e}^{max {\{ {z}_{i} \}}_{i = 5}^{M}}} .$$

The variables pₕₐₚₚᵢₙₑₛₛ and p_{sadness} are considered as probabilities from the perspective of LMA predictions. Let the s^{th} and h^{th} elements of vector y denote sadness and happiness, respectively. By applying the softmax function to yₕ and yₛ, we derived the probabilities of sadness and happiness from the emotion output, represented as e^{y}^{ₕ}/(e^{y}^{ₕ}+e^{y}^{ₛ}) and e^{y}^{ₛ}/(e^{y}^{ₕ}+e^{y}^{ₛ}), respectively. Subsequently, we leveraged pₕₐₚₚᵢₙₑₛₛ and p_{sadness} to supervise e^{y}^{ₕ}/(e^{y}^{ₕ}+e^{y}^{ₛ}) and e^{y}^{ₛ}/(e^{y}^{ₕ}+e^{y}^{ₛ}) through the implementation of the soft cross-entropy loss:

$${ℒ}_{Bridge} = - {p}_{happiness} ln \frac{{e}^{{y}_{h}}}{{e}^{{y}_{h}} + {e}^{{y}_{s}}} - {p}_{sadness} ln \frac{{e}^{{y}_{s}}}{{e}^{{y}_{h}} + {e}^{{y}_{s}}} .$$

Occasionally, the happiness-sadness probability from the LMA branch may not be accurate, hindering its ability to supervise yₕ and yₛ. To address this issue, we introduced a threshold ∈. Only when pₕₐₚₚᵢₙₑₛₛ Or p_{sadness} exceeded ∈ would we compute the cross-entropy loss. Formally, this can be represented as:

$${ℒ}_{B r i d g e} = - 1 ( {p}_{h a p p i n e s s} > ϵ ) ln \frac{{e}^{{y}_{h}}}{{e}^{{y}_{h}} + {e}^{{y}_{s}}} - 1 ( {p}_{sadness} > ϵ ) ln \frac{{e}^{{y}_{s}}}{{e}^{{y}_{h}} + {e}^{{y}_{s}}} ,$$

where 1(P) is the indicator function, equating to 1 if the condition P is true and 0 otherwise. An ablation study was conducted to evaluate the performance of different [symbol] values, as shown in Table 12. The results suggest that the E-controlled loss function leads to improved performance, with ∈=0.9 achieving the best results.

### 4.6 Weakly Supervised Training for MANet

We have utilized both the BoME and BoLD datasets for the joint training of MANet to recognize emotion and LMA labels. These datasets share a common subset of 705 clip samples. The rest of the BoME samples are exclusive to LMA labels, whereas the remaining samples in the BoLD set contain only emotion labels. Consequently, drawing inspiration from the work of wu2020mebow, we adopted a weakly supervised training methodology, enabling us to effectively leverage data that lacks either emotion or LMA labels.

In particular, we employed the coefficient μ_{Emotion}, set to either 0 or 1, to indicate the presence or absence of an emotion label in a sample. Likewise, the coefficient μ_{LMA} was used for the LMA label. During training, all datasets were combined and shuffled together. We utilized the coefficients λ₁ and λ₂ to balance the three loss components. The total loss was calculated as follows:

$$ℒ = {μ}_{Emotion} {ℒ}_{Emotion} + {λ}_{1} {μ}_{LMA} {ℒ}_{LMA} + {λ}_{2} {ℒ}_{Bridge} ,$$

In practice, we set λ₁=0.25 and λ₂=0.1.

Throughout the training process, the network was trained for 50 epochs, with data augmentation techniques such as flipping and scaling applied to both the BoME and BoLD datasets. The learning rate was set at 5e-3, and the optimization algorithm employed was SGD. Two NVIDIA Tesla V100 GPUs were used to conduct a single experiment, which took approximately 8 hours to complete.

End-to-End Context-Aware Emotion Recognition with Transformers

In the pursuit of achieving emotional intelligence in artificial systems, the ability to discern human emotions in unscripted, real-world settings is paramount. Conventional approaches to emotion recognition, which are predominantly multi-stage and dependent on pre-computed features, fall short in practical applications. To overcome these deficiencies, we propose TRACER, a novel end-to-end architecture that transforms the landscape of emotion recognition in unconstrained environments. TRACER formulates in-context emotion recognition as a parallel decoding task. This paradigm shift allows for the simultaneous processing of multiple individuals within a single scene, thereby enhancing computational efficiency and enabling holistic contextual modeling. By eliminating the reliance on manual cropping and extra pre-computed attributes such as depth maps or facial landmarks, TRACER offers a streamlined, end-to-end approach to context-aware emotion recognition. Extensive experiments show that our design is able to achieve the state-of-the-art on various benchmarks. Our model can serve as a strong baseline for transformer-based emotion recognition. The code will be released.

### 1 Introduction

TRACER (TRAnsformer for Context-aware Emotion Recognition), a new architecture that revolutionizes the methodology for emotion recognition in complex, multi-person scenes is introduced. TRACER conceptualizes emotion recognition as a parallel decoding task. This innovative formulation allows for the concurrent processing of all subjects of interest in a single image, eliminating the necessity of manual cropping and reliance on pre-computed features. By leveraging the power as an end-to-end framework, TRACER requires only the full image as input, offering a streamlined and single-stage solution for emotion recognition. Beyond simplifying the procedure, TRACER establishes itself as a strong baseline, demonstrating superior performance on widely recognized benchmarks. Its effectiveness and reliability are validated through diverse testing scenarios.

We summarize our contributions as follows: Problem Reformulation. We present a novel perspective on emotion recognition, particularly in uncontrolled, real-world settings by re-framing the challenge as a parallel decoding task. This represents a significant shift from conventional sequential processing approaches, allowing for both simultaneous processing of multiple subjects in a scene and better capturing the dynamics of subject interactions and context. New Framework. We introduce TRACER, an end-to-end approach specifically designed for context-aware emotion recognition. This framework streamlines the process by eliminating the need for manual cropping and extra pre-computed features. Extensive experiments on various benchmarks consolidate the effectiveness and superiority of TRACER. Detailed Analysis. We provide an in-depth analysis of TRACER, including an examination of its design and discussions over its behaviors. Such analysis provides valuable insights and directions for future research in emotion recognition.

### 2 Preliminary

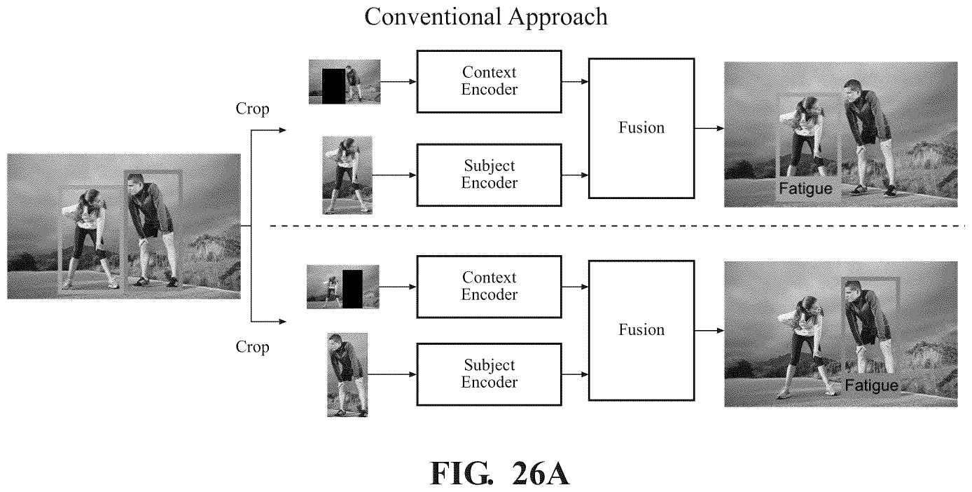

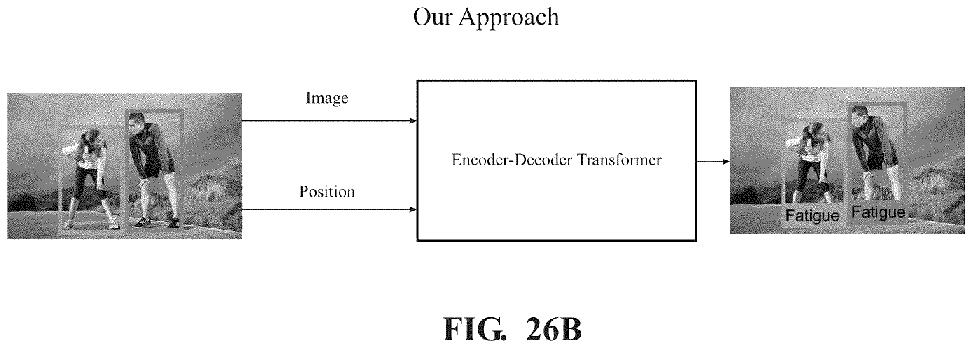

Emotion recognition in real-world environments presents a distinct challenge compared to controlled, laboratory settings. Such natural scenarios often involve multiple individuals, each interacting with others and the surroundings, forming a complex tapestry of relationships known as context. These interactions are crucial for accurate emotion recognition. Previous work, however, often overlooks this intricate interplay, favoring a reliance on extra pre-computed features rather than a more profound conceptualization of the problem. This section revisits conventional context-aware emotion recognition approaches, underscoring their limitations and contrasting them with our formulation, as shown in FIG. 26A.

Conventional Multi-Branch Multi-Stage Approach. Conventional emotion recognition models perceive the challenge as follows: For an image x, with k subjects, the goal is to determine each subject's emotional state. These subjects are identified by bounding boxes

$${\{ {p}_{i} \}}_{i = 1}^{k} ,$$

and their emotional states are represented as

$${\{ {y}_{i} \}}_{i = 1}^{k} .$$

For each subject depicted in the image, these methods typically generate a pair of cropped images: one focused on the subject x_{i,s} extracted using the bounding box pᵢ, and the other representing the contextual information x_{i,c} derived by masking out the subject from the image. Separate encoders are adopted for the subject z_{i,s}=fₛ(x_{i,s}) and context z_{i,c}=f_{c}(x_{i,c}) respectively, Their outputs are combined with a late-fusion module to predict the emotional state: ŷᵢ=σ(z_{i,s}, z_{i,c}).

Our End-to-End Approach. Instead of isolating each subject from the scene, we treat the whole image as a singular sample, capturing all subjects and their interrelations with surroundings in one comprehensive framework, as shown in FIG. 26B. Specifically, we propose to utilizes a unified encoder for the whole image to extract spatial features z=f_{enc}(x), followed by a decoder that simultaneously decodes emotions of all subjects in a parallel manner: ŷ₁, . . . , ŷk=f_{dec}(z, p₁, . . . , pₖ).

The advantages of our formulation include: Enhanced Efficiency: Given a dataset with N images, each containing M subjects; the time complexity of conventional approach is [symbol] (MN) for both training and inference due to the redundant processing of each image. In contrast, our approach exhibits a time complexity of [symbol] (N) as we process the entire image in a singular flow. Holistic Contextual Understanding: Conventional approach suffers from contextual disconnection by isolating subjects for individual analysis, while our approach maintains the integrity of contextual dynamics among subjects, leading to more nuanced and accurate emotion recognition. Bias Elimination: Manual cropping can introduce image artifacts, potentially compromising data quality and leading to biased or incorrect feature learning. By eliminating manual cropping from the pipeline, our approach mitigates these biases, enabling more efficient end-to-end optimization.

### 3 The TRACER Model

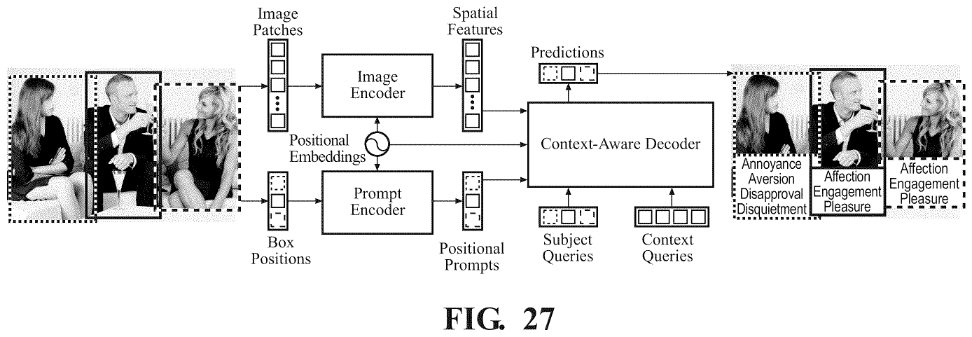

The architecture of TRACER is conceptually simple, as illustrated in FIG. 27. Its core is an encoder-decoder transformer. The encoder component is bifurcated into two sub-encoders: an image encoder to extract the spatial features from the image, and a prompt encoder to embed the positional prompts associated with the target. The decoder component is stacked by several decoder layers and is used to decode queries into emotional labels based on image spatial features and provided positional prompts.

The model employs an image encoder to extract spatial features from images and a prompt encoder for encoding positional prompts (i.e., locations of subjects). A context-aware decoder then concurrently decodes subject and context queries based on the spatial features with the guidance of positional prompts, simultaneously predicting emotions of all subjects of interest at one pass.

### 3.1 Encoders

Image Encoder. We use a ViT [Dosovitskiy et~al. (2020) Dosovitskiy, Beyer, Kolesnikov, Weissenborn, Zhai, Unterthiner, Dehghani, Minderer, Heigold, Gelly, et~al.] minimally adapted as the image encoder because of its remarkable performance across a variety of vision tasks. Specifically, given an image X∈ [symbol] , the ViT first extracts l non-overlapping patches from the image and projects them into 1D tokens X′∈ [symbol] , where

$$l = \frac{h w}{{patch\_size}^{2}}$$

is the number of tokens extracted from the image and d is the dimensionality of the feature space. Subsequently, the sequence of tokens, together with a learnable positional embedding P∈ [symbol] , is fed into a transformer encoder to extract the spatial features of the image. The output of the encoder is denoted as Z∈ [symbol] . Note that the image encoder processes the entire image in a single operation, regardless of the number of subjects of interest present within the image.

Prompt Encoder. The function of the prompt encoder is to embed the positional information of the subject of interest in the image. When there are multiple people in the scene, the embedded positional prompts serve to direct the decoder to correspond to the specific subject of interest and discriminate it from others present in the scene [Wang et~al. (2020) Wang, Shang, Lioma, Jiang, Yang, Liu, and Simonsen]. Specifically, given a set of positional prompts in the form of bounding boxes, each marking the position of a subject of interest, we transform each of them into a binary mask Mᵢ∈ [symbol] . The mask has the same dimensions as the corresponding image, with a value of 1 set within the bounding box and 0 for the rest. The positional prompt for subject i is then defined as:

$${S}_{i} = {\sum }_{k = 1}^{l} Flatten ( AvgPool ( {M}_{i} ) ) \cdot {P}_{k} , \qquad ( 1 )$$

where the kernel size of AvgPool is the same as the patch size of the image encoder. Additionally, we define the positional prompt of the context as:

$${S}_{c} = {\sum }_{k = 1}^{l} Flatten ( AvgPool ( J ) ) \cdot {P}_{k} , \qquad ( 2 )$$

where J is a matrix of all ones. The positional prompts of the subjects and the context are then concatenated together to form the final positional prompts of the image S=[S₁, S₂, . . . , Sₙ_{ₛ}, S_{c}, . . . , S_{c}]∈ [symbol] , where n=nₛ+n_{c} and nₛ, n_{c} correspond to the number of subjects and the context, respectively.

### 3.2 Context-Aware Decoder

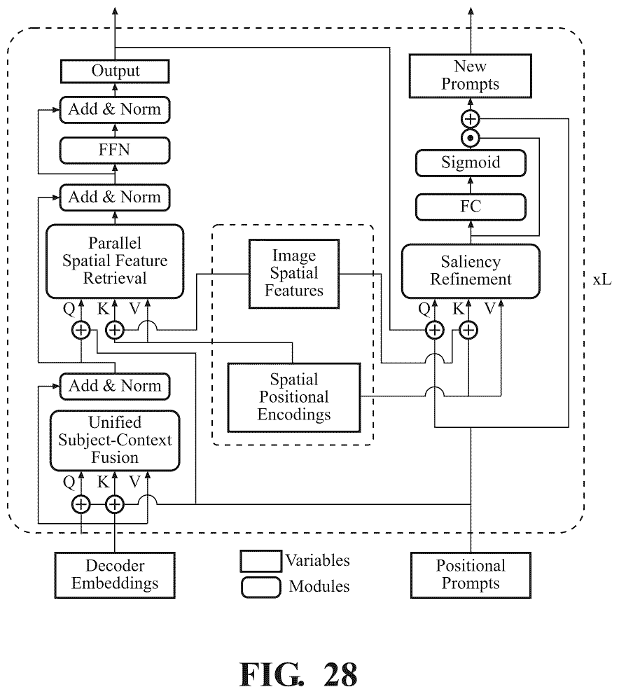

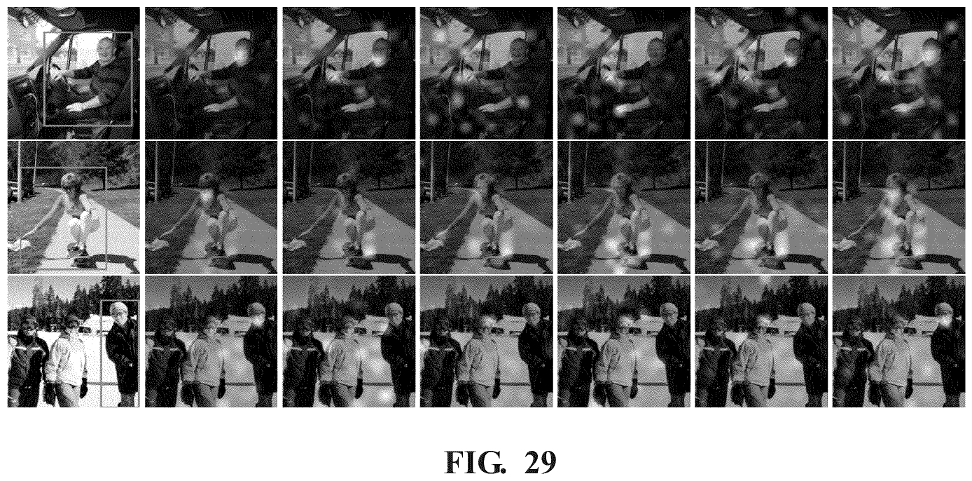

A context-aware decoder is implemented to decode subject queries into emotion predictions using spatial features and positional prompts. The structure is shown in FIG. 28. The decoder takes a set of learnable vectors T∈ [symbol] as inputs, comprising nₛ subject queries and n_{c} auxiliary context queries matching the positional prompts S. Subject queries adopt shared parameters, focusing on “subject” aspects, while context queries, differing in parameters, cater to various “context” types. This setup, diverging from common object detection models [Carion et~al. (2020) Carion, Massa, Syhnaeve, Usunier, Kirillov, and Zagoruyko, Liu et~al. (2022) Liu, Li, Zhang, Yang, Qi, Su, Zhu, and Zhang], is specifically designed for emotion recognition. It prioritizes emotional state identification over the spatial positioning of subjects. By decoupling spatial information from the decoder queries, our model emphasizes learning emotion-centric subject-context relationships.

The general structure of the context-aware decoder is a transformer decoder with L decoding layers. It is primarily built upon the well-known attention mechanism, which is defined as:

$$Attention ( Q , K , V ) = softmax ( \frac{{QK}^{T}}{\sqrt{{d}_{K}}} ) V , \qquad ( 3 )$$

where Q, K, V are the queries, keys and values, respectively. For simplicity, we abuse the notation of Attention (Q, K, V) to refer to the commonly used multi-head attention operation [Vaswani et~al. (2017) Vaswani, Shazeer, Parmar, Uszkoreit, Jones, Gomez, Kaiser, and Polosukhin]. We simplify our explanation by focusing on one decoder layer and omitting varied attention operations.

Unified Subject-Context Fusion. Emotional experiences are significantly shaped by interactions with others and the ambient environment. The presence and behaviors of others, along with the environmental context, greatly influence how emotions are perceived and expressed. Recognizing this complexity, a holistic approach to emotion recognition must consider these intricate dynamics among individuals and their surroundings. Previous methods often use separate modules to model these interactions, leading to suboptimal results. In contrast, our unified approach uses a single self-attention operation to efficiently capture both inter-subject and subject-context dynamics:

$${T}^{′} = Attention ( T + S , T + S , T ) \qquad ( 4 )$$

This fusion strategy offers distinct advantages by circumventing the biases and constraints inherent in manually designed modules, which often fail to capture the dynamic and context-dependent nature of emotional expressions. By enabling the model to autonomously discern and prioritize the most relevant inter-subject and subject-context interactions, our approach allows for a more flexible and accurate representation of emotional states. This level of adaptability ensures the model is not limited by predefined notions of interaction. Instead, it can learn from the data how different subjects and contexts contribute to the overall emotional expression.

Parallel Spatial Feature Retrieval. To effectively integrate the spatial features from the image with the enriched subject and context queries T′, we propose a Parallel Spatial Feature Retrieval delineated by the cross-attention operation:

$${T}^{″} = Attention ( {T}^{′} + S , Z + P , Z ) \qquad ( 5 )$$

The decoder retrieves relevant spatial features in a parallel manner for each subject and context query from the image, leveraging the attention mechanism. The queries T′ are augmented with the positional prompts S to ensure that the retrieval is contextually aligned with the subjects' positional information. The keys and values are derived from the spatial features Z, enhanced with positional embeddings P to maintain spatial coherence. This parallel processing allows the model to simultaneously consider the unique spatial characteristics pertinent to each subject and context, crucial for accurate emotion recognition. T″ is further processed through a Feed-Forward Network (FFN). This network functions as a channel-mixing stage, wherein it integrates the clues obtained from the attention steps for each subject. The output from this FFN is denoted as T*, representing the final output of the decoder layer.

Saliency Refinement. The initial positional prompts are derived from bounding boxes, indicating the approximate locations of subjects. However, these prompts might not always align with the salient regions crucial for emotion recognition. To address this, we refine the positional prompts layer-by-layer within the decoder, aiming to achieve more precise alignment with emotionally salient areas. This is facilitated again through the attention mechanism:

$${S}^{′} = Attention ( {T}^{*} + S , Z + P , P ) \qquad ( 6 )$$

$${S}^{*} = S + σ ( {S}^{′} ) \cdot {S}^{′}$$

In this operation, the refined queries T″, which now contain both subject-context information and spatial features, are combined with the positional prompts S to identify regions within the spatial features Z that are most salient for emotion recognition. The output S′ represents the incremental saliency information, which is then modulated using a sigmoid function o and added back to the original positional prompts S to produce the final refined prompts S*. This refinement step ensures that our model focuses on the most emotionally expressive areas of the image, thereby enhancing the accuracy and sensitivity of the emotion recognition process.

### 4 Experimental Results

### 4.1 Datasets

We evaluated the performance of TRACER on several recently released, challenging benchmarks. These datasets are particularly notable for their focus on images featuring individuals in real-world settings, annotated to reflect their apparent emotions.

Emotic [Kosti et~al. (2017) Kosti, Alvarez, Recasens, and Lapedriza] is a widely used dataset for emotion recognition in context, comprising 23,571 images of 34,320 annotated individuals in unconstrained real-world environments. Each subject is annotated with one or more of the 26 emotion labels [Demszky et~al. (2020) Demszky, Movshovitz-Attias, Ko, Cowen, Nemade, and Ravi], and the scenes contain up to 12 subjects each.

HECO [Yang et~al. (2022) Yang, Huang, Wang, Liu, Zhai, Su, Li, and Zhang] is a dataset consisting of 9,385 images with 19,781 subjects, containing rich context information and interactions. It annotates subjects in one of eight emotion categories [Ekman (1992)] and features scenes with up to 15 subjects.

CAER-S [Lee et~al. (2019) Lee, Kim, Kim, Park, and Sohn] provides a unique perspective with 70,000 static images from TV shows, focusing on single subjects per scene, each annotated with one of seven emotion categories [Ekman (1992)].

TABLE 14
!
The performance comparison on Emotic dataset. 51 denotes the use of extra pre-computed features.

| | | | | | | EmotiCON |
|---|---|---|---|---|---|---|
| | | | Emotic-Net | | | [Mittal |
| | | | [Kosti | | | et~al.(2020)Mittal [symbol] |
| | | CAER-Net [Lee | et~al.(2017)Kosti, | Affect-Graph | | [symbol] , Guhan, [symbol] |
| | | et~al.(2019)Lee, | Alvarez, | [Zhang | RRLA [Li | Bhattacharya, |
| | | Kim, Kim, Park, | Recasens, and | et~al.(2019)Zhang, | et~al.(2023)Li, | Chandra, Bera, [symbol] |
| | | and Sohn] | Lapedriza] | Liang, and Ma] | Dong, and Wang] | and Manocha] |
| 4* Feature | Face | 51 | — | 51 | — | 51 |
| | Pose | — | — | — | — | 51 |
| | Depth | — | — | — | — | 51 |
| | Object | — | — | 51 | 51 | — |
| 26* Category | Affection | 19.90 | 27.85 | 46.89 | 37.93 | 45.23 |
| | Anger | 11.50 | 9.49 | 10.87 | 13.73 | 15.46 |
| | Annoyance | 16.40 | 14.06 | 11.23 | 20.87 | 21.92 |
| | Anticipation | 53.05 | 58.64 | 62.64 | 61.08 | 72.12 |
| | Aversion | 16.20 | 7.48 | 5.93 | 9.61 | 17.81 |
| | Confidence | 32.34 | 78.35 | 72.49 | 80.08 | 68.65 |
| | Disapproval | 16.04 | 14.97 | 11.28 | 21.54 | 19.82 |
| | Disconnection | 22.80 | 21.32 | 26.91 | 28.32 | 43.12 |
| | Disquietment | 17.19 | 16.89 | 16.94 | 22.57 | 18.73 |
| | Doubt/Confusion | 28.98 | 29.63 | 18.68 | 33.50 | 35.12 |
| | Embarrassment | 15.68 | 3.18 | 1.94 | 4.16 | 14.37 |
| | Engagement | 46.58 | 87.53 | 88.56 | 88.12 | 91.12 |
| | Esteem | 19.26 | 17.73 | 13.33 | 20.50 | 23.62 |
| | Excitement | 35.26 | 77.16 | 71.89 | 80.11 | 83.26 |
| | Fatigue | 13.04 | 9.70 | 13.26 | 17.51 | 16.23 |
| | Fear | 10.41 | 14.14 | 4.21 | 15.56 | 23.65 |
| | Happiness | 49.36 | 58.26 | 73.26 | 76.01 | 74.71 |
| | Pain | 10.36 | 8.94 | 6.52 | 14.56 | 13.21 |
| | Peace | 16.72 | 21.56 | 32.85 | 26.76 | 34.27 |
| | Pleasure | 19.47 | 45.46 | 57.46 | 55.64 | 65.53 |
| | Sadness | 11.45 | 19.66 | 25.42 | 30.80 | 23.41 |
| | Sensitivity | 10.34 | 9.28 | 5.99 | 9.59 | 8.32 |
| | Suffering | 11.68 | 18.84 | 23.39 | 30.70 | 26.39 |
| | Surprise | 10.92 | 18.81 | 9.02 | 17.92 | 17.37 |
| | Sympathy | 17.13 | 14.71 | 17.53 | 15.26 | 34.28 |
| | Yearning | 9.79 | 8.34 | 10.55 | 10.11 | 14.29 |
| | mAP (%) | 20.84 | 27.38 | 28.42 | 32.41 | 35.48 |

[symbol]

indicates data missing or illegible when filed

### 4.2 Implementation Details

We trained models using the AdamW optimizer [Loshchilov and Hutter (2018)] with an initial learning rate of 1e-5 and a cosine decay schedule integrated with linear warmup [Loshchilov and Hutter (2016)]. The training involved batches of 64 images up to 50 epochs, using a weight decay [Loshchilov and Hutter (2018)] of 1e-3 and drop path regularization [Larsson et~al. (2016) Larsson, Maire, and Shakhnarovich] at 0.1. We employed a pre-trained ViT [Radford et~al. (2021) Radford, Kim, Hallacy, Ramesh, Goh, Agarwal, Sastry, Askell, Mishkin, Clark, et~al.] as the image encoder. To optimize training, batches were uniformly padded, with attention masks and loss masks applied accordingly [Gu et~al. (2018) Gu, Bradbury, Xiong, Li, and Socher].

### 4.3 Comparison with the State of the Art

We compared TRACER with several state-of-the-art models on various benchmarks. For Emotic and CAER-S, we used the default splits provided and referenced the performance metrics originally reported. We adopted a random split approach for HECO since it does not have default partitions. Specifically, we divided it into training, validation, and testing subsets in a 7:1:2 ratio, and reimplemented two representative methods to serve as benchmarks for comparison. We report mean average precision (mAP) on Emotic and top-1 accuracy (Acc) on HECO and CAER-S.

As shown in Table 14, 15a, and 15b, TRACER consistently achieves the state-of-the-art. Notably, our approach is end-to-end, using only the whole images and raw annotations of the dataset as inputs. Previous models, despite being heavily equipped with pre-computed features including facial landmarks, human pose, depth map, and object detection, still fall behind ours. The superiority in performance not only underscores the rationality of our formulation but also highlights the effectiveness of TRACER's design. It showcases the ability of TRACER to capture and model the crucial emotional information from subjects and context, bypassing the need for multi-stage manual processing typically seen in existing approaches. The combination of simplified processing and the model's superior performance positions TRACER as a robust baseline for emotion recognition.

TABLE 15
The performance comparison on CAER-S and HECO datasets.
51 denotes the use of extra pre-computed features.
[t]tw !
(a) CAER-S

| | Face | Pose | Depth | Object | Acc (%) |
|---|---|---|---|---|---|
| CAER-Net [Lee | 51 | — | — | — | 73.6 |
| et~al. (2019)Lee, | | | | | |
| Kim, Kim, Park, | | | | | |
| and Sohn] | | | | | |
| Emotic-Net [Kosti | — | — | — | — | 74.5 |
| et~al. (2017)Kosti, | | | | | |
| Alvarez, | | | | | |
| Recasens, and | | | | | |
| Lapedriza] | | | | | |
| RRLA [Li | — | — | — | 51 | 84.8 |
| et~al. (2023)Li, | | | | | |
| Dong, and Wang] | | | | | |
| EmotiCON | 51 | 51 | 51 | — | 88.6 |
| [Mittal et~al. | | | | | |
| (2020)Mittal, | | | | | |
| Guhan, Bhattacharya, | | | | | |
| Chandra, Bera, | | | | | |
| and Manocha] | | | | | |
| TRACER | — | — | — | — | 90.7 |

[t]tw !
(b) HECO

| | Face | Pose | Depth | Object | Acc (%) |
|---|---|---|---|---|---|
| Emotic-Net | — | — | — | — | 58.3 |
| [Kosti et~al. | | | | | |
| (2017)Kosti, | | | | | |
| Alvarez, | | | | | |
| Recasens, and | | | | | |
| Lapedriza] | | | | | |
| EmotiCON | 51 | 51 | 51 | — | 64.6 |
| [Mittal et~al. | | | | | |
| (2020)Mittal, | | | | | |
| Guhan, Bhattacharya, | | | | | |
| Chandra, Bera, | | | | | |
| and Manocha] | | | | | |
| TRACER | — | — | — | — | 69.4 |

### 4.4 Ablation

Decoder Components. Our evaluation of decoder components involved progressively adding elements to a basic decoder layer and observing performance changes, as shown in Table 16. Initial results with just spatial feature retrieval are promising, confirming our method's effectiveness in identifying individual emotions in a scene using positional prompts, and avoiding manual cropping. The addition of the subject-context fusion component further improved the model, highlighting its skill in leveraging interactions between subjects for deeper emotional insight. Notably, as we increased the number of decoder layers, the model's focus shifted more effectively toward relevant areas for emotion recognition. This layer-by-layer refinement strategy, reflected in performance gains with additional layers, emphasizes the importance of understanding subject interactions and context. Our findings demonstrate that effective emotion recognition relies not just on image feature learning but more critically on capturing the dynamic interplay within the scene, a process enhanced by increasing decoder layers for comprehensive, context-aware emotion analysis.

TABLE 16
Ablation study on decoder components.
!

| Components | L = 2 | L = 4 | L = 6 |
|---|---|---|---|
| Decoder (with | — | — | — |
| FFN) | | | |
| +Spatial Feature | 32.7 | 34.7 | 34.8 |
| Retrieval | | | |
| +Subject-Context | 35.8 | 36.5 | 36.9 |
| Fusion | | | |
| +Saliency | 35.6 | 36.9 | 37.8 |
| Refinement | | | |

Positional Encoding. Positional encoding is crucial in TRACER, especially as our method forgoes manual cropping in favor of using subject locations as prompts. Our approach places a premium on positional encodings for subject differentiation and interaction modeling. Our ablation study addresses two core issues: identifying the optimal positional encoding strategy and integrating these positional prompts effectively with the content.

We evaluated three types of encoding: sinusoidal [Devlin et~al. (2018) Devlin, Chang, Lee, and Toutanova], learnable [Dosovitskiy et~al. (2020) Dosovitskiy, Beyer, Kolesnikov, Weissenborn, Zhai, Unterthiner, Dehghani, Minderer, Heigold, Gelly, et~al.], and fixed from a pretrained model [Radford et~al. (2021) Radford, Kim, Hallacy, Ramesh, Goh, Agarwal, Sastry, Askell, Mishkin, Clark, et~al.]. The result in Table 17 shows encodings from the pre-trained model as the most effective, closely followed by sinusoidal encoding. Learning positional encoding from scratch was less successful, likely due to dataset biases that challenge the learning process. Pre-trained and sinusoidal encodings, treating positions more uniformly, seem better equipped to handle these biases. For positional prompts integration, we tested two methods: adding embeddings to decoder inputs and incorporating them during attention computation. The latter proved markedly superior, allowing subject queries to focus more on emotion-relevant information. Integrating positional prompts in the attention phase ensures their role in discerning spatial relations and interactions, thus bolstering TRACER's effectiveness.

TABLE 17
Ablation study on positional encodings.
!

| pos enc type | where to add | mAP (%) | Δ |
|---|---|---|---|
| sine | input | 35.9 | −1.9 |
| sine | attention | 37.6 | −0.2 |
| learnable | input | 35.7 | −2.1 |
| learnable | attention | 36.8 | −1.0 |
| pre-trained | input | 35.9 | −1.9 |
| pre-trained | attention | 37.8 | — |

Loss Function. Training models for emotion recognition, particularly given the granular nature of emotion categories and the multi-label, long-tail distribution of the dataset, presents unique challenges. Previous approaches have reported the use of mean squared error (MSE) loss for training classification models [Kosti et~al. (2017) Kosti, Alvarez, Recasens, and Lapedriza, Li et~al. (2023) Li, Dong, and Wang], a choice that is somewhat unconventional and warrants further investigation. We conducted experiments comparing different loss functions. As shown in Table 18, we found no advantage in using MSE loss, either in its standard or weighted form, for the emotion recognition task. In fact, our experiments encountered difficulties when training with MSE loss, leading us to hypothesize that its previous usage may have been a consequence of inappropriate problem formulation and limited engineering techniques available in the early days. Moreover, our exploration revealed no substantial improvements when employing balanced loss functions.

TABLE 18
Ablation study on loss functions.
!

| Loss | Form | Weight | mAP (%) |
|---|---|---|---|
| BCE | Σ yᵢlogŷᵢ + | none | 37.8 |
| | (1 − yᵢ)log(1 − ŷᵢ) | | |
| BCE | Σ wᵢ · [yᵢlogŷᵢ + | balanced | 37.2 |
| | (1 − yᵢ)log(1 − ŷᵢ)] | | |
| MSE | Σ (yᵢ − ŷᵢ)² | none | 23.2 |
| MSE | Σ wᵢ · (yᵢ − ŷᵢ)² | balanced | 21.6 |

Context Queries. We investigated the effect of additional context queries in TRACER, finding that they help gather global scene information, enhancing context understanding. A performance gain of 1.2 mAP is observed by incorporating single context queries. However, more context queries don't always improve performance; too many (i.e. nₛ≥50) can reduce model effectiveness with around 0.5 mAP. This is may due to our model's design, where spatial image retrieval through cross-attention acts as soft Region of Interest (ROI) pooling. With prompt refinement, the model efficiently extracts non-subject information as needed. Excess context queries can shift focus away from primary subjects, undermining the model's efficiency.

TABLE 19
Ablation study on positional prompts.
!

| prompt type | prompt quality | mAP | Δ |
|---|---|---|---|
| box | normal | 37.8 | — |
| box | shifted | 37.6 | −0.2 |
| point | center | 35.4 | −2.4 |
| point | shifted | 35.3 | −2.5 |

### 4.5 Emotion Recognition Beyond Bounding Box

Rethinking the conventional approach to emotion recognition necessitates a critical examination of the reliance on bounding boxes. Historically, these methods have been heavily dependent on bounding boxes to crop out and focus on subjects within images, to the extent that their functionality is severely limited without such spatial demarcations. This raises a fundamental question: What is the intrinsic purpose of bounding boxes, and are they truly essential for emotion recognition? Upon deeper analysis and problem formulation, it becomes evident that bounding boxes serve primarily as a form of positional prompts, a means to delineate and accentuate subjects within a scene.

Venturing beyond the bounding box, we consider another form of positional prompt commonly encountered in real-world scenarios: the point. Clearly, point annotations are simpler to obtain and can also effectively specify subjects. However, we realized that most of the existing methods shattered when deprived of bounding boxes, unable to adapt to this simpler positional prompt. This limitation underscores a critical inflexibility in previous approaches.

In contrast, the design of TRACER demonstrates remarkable adaptability, seamlessly accommodating different types of positional prompts, including points. This flexibility is attributed to the robust problem formulation underlying TRACER, which does not tie the model's functionality to a specific type of positional representation. Specifically, given a point, we convert it into a binary mask with the value of 1 at the point and 0 for the rest. The positional prompts can be defined accordingly, and the model operates as-is.

To rigorously evaluate the adaptability of TRACER, we constructed a specialized dataset that uses point annotations in lieu of bounding boxes. These points were derived by pinpointing the center of the bounding boxes, simulating scenarios where detailed bounding box information is unavailable. Furthermore, we investigated the model's resilience to inaccuracies in positional prompts. This was achieved by intentionally introducing perturbations to the positional prompts, shifting them by up to 10% in various directions. This aspect of the study aimed to emulate real-world situations where positional annotations may be imprecise or slightly misaligned.

As shown in Table 19, TRACER demonstrates a remarkable capability to work with point-based positional prompts, a significant deviation from the conventional approaches that rely on bounding boxes. Even more impressively, the model exhibits considerable robustness to prompt corruption, sustaining its performance despite the introduced perturbations. These results unequivocally confirm the robustness and flexibility of TRACER, highlighting its potential applicability in diverse real-world scenarios where positional data may vary in both form and precision.

### 4.6 Qualitative Results

In our qualitative analysis, we visualized attention maps generated during spatial feature retrieval at each decoder layer. FIG. 29 clearly illustrates how TRACER, steered by positional prompts, effectively focuses on salient regions within an image. A particularly intriguing observation is the model's apparent operational tendency. Initially, the focus is predominantly on the target subject, akin to establishing a “point of interest”. As the decoding progresses, this attention broadens, seemingly scouring the image for additional visual cues and context. Eventually, in what appears to be a synthesis phase, the model reconvenes its attention back onto the target subject, integrating the gathered information for final prediction. This evolving attention trajectory underscores the rationality of the TRACER to integrate direct subject focus with broader contextual awareness, which aligns with how humans tend to perceive and process emotional information in real-world settings.

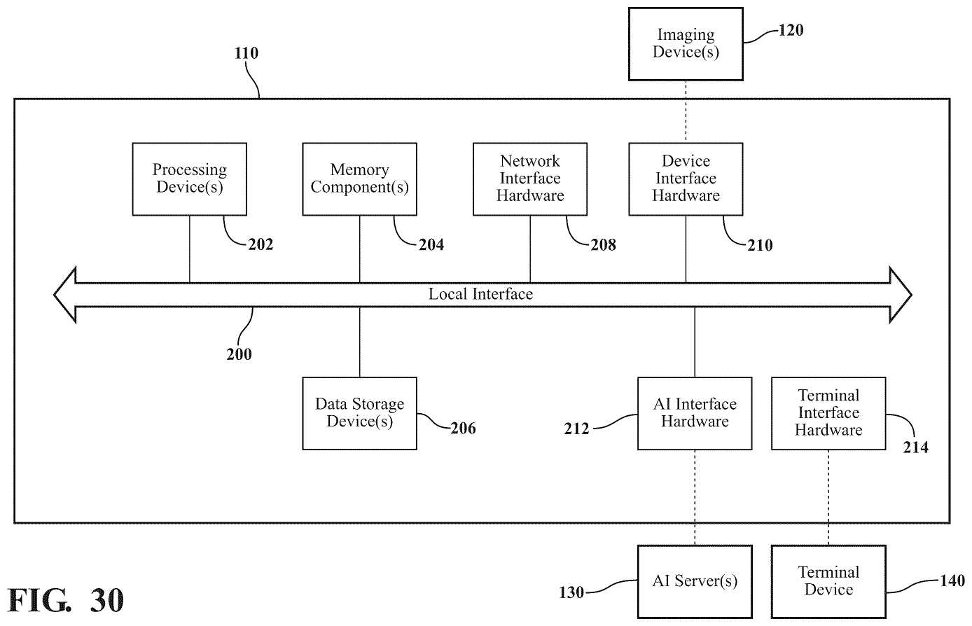

An illustrative example of hardware contained within a system that may be particularly configured for carrying out the methods of the present disclosure is depicted in FIG. 30. More specifically, FIG. 30 depicts illustrative hardware components of a computer device 110. While the hardware components of the computer device 110 are shown and described, the present disclosure is not limited to such. For example, similar hardware components may also be included within various other systems, devices, and/or components not specifically described herein.

A local interface 200 may interconnect the various components of the computer device 110. The local interface 200 may be formed from any medium that is capable of transmitting a signal such as, for example, conductive wires, conductive traces, optical waveguides, or the like. Moreover, the local interface 200 may be formed from a combination of mediums capable of transmitting signals. In one embodiment, the local interface 200 includes a combination of conductive traces, conductive wires, connectors, and buses that cooperate to permit the transmission of electrical data signals to components such as processors, memories, sensors, input devices, output devices, and communication devices. Accordingly, the local interface 200 may include a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The local interface 200 communicatively couples the various components of the computer device 110.

One or more processing devices 202, such as a computer processing unit (CPU), may be the central processing unit(s) of the computing device, performing calculations and logic operations required to execute a program. Each of the one or more processing devices 202, alone or in conjunction with one or more of the other elements disclosed in FIG. 30, is an illustrative processing device, computing device, processor, or combination thereof, as such terms are used within this disclosure. Accordingly, each of the one or more processing devices 202 may be a controller, an integrated circuit, a microchip, a computer, or any other computing device. The one or more processing devices 202 are communicatively coupled to the other components of the computer device 110 by the local interface 200.

One or more memory components 204 configured as volatile and/or nonvolatile memory, such as read only memory (ROM) and random access memory (RAM; e.g., including SRAM, DRAM, and/or other types of RAM), flash memories, hard drives, secure digital (SD) memory, registers, compact discs (CD), digital versatile discs (DVD), Blu-ray™ discs, or any non-transitory memory device capable of storing machine-readable instructions may constitute illustrative memory devices (i.e., non-transitory processor-readable storage media) that is accessible by the one or more processing devices 202. Such memory components 204 may include one or more programming instructions thereon that, when executed by the one or more processing devices 202, cause the one or more processing devices 202 to complete various processes, such as the processes described herein. Depending on the particular embodiment, these non-transitory computer-readable mediums may reside within the computer device 110 and/or external to the computer device 110. A machine-readable instruction set may include logic or algorithm(s) written in any programming language of any generation (e.g., 1GL, 2GL, 3GL, 4GL, or 5GL) such as, for example, machine language that may be directly executed by the one or more processing devices 202, or assembly language, object-oriented programming (OOP), scripting languages, microcode, and/or the like that may be compiled or assembled into machine readable instructions and stored in the non-transitory computer readable memory (e.g., the memory components 204). Alternatively, a machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

In some embodiments, the program instructions contained on the one or more memory components 204 may be embodied as a plurality of software modules, where each module provides programming instructions for completing one or more tasks.

The various logic modules described herein with respect to one or more memory components 204 of the computer device 110 are merely illustrative, and that other logic modules, including logic modules that combine the functionality of two or more of the modules described hereinabove, may be used without departing from the scope of the present application. Furthermore, various logic modules that are specific to other systems, devices, and/or components are also contemplated.

Still referring to FIG. 30, one or more data storage devices 206, which may each generally be a storage medium that is separate from the one or more memory components 204, may contain a data repository for storing data that is used for storing electronic data and/or the like relating to various data generated, captured, and/or the like, as described herein. The one or more data storage devices 206 may be any physical storage medium, including, but not limited to, a hard disk drive (HDD), memory, removable storage, and/or the like. While the one or more data storage devices 206 are depicted as local devices, it should be understood that at least one of the one or more data storage devices 206 may be a remote storage device, such as, for example, a server computing device or the like in some embodiments.

Illustrative data that may be contained within the one or more data storage devices 206 may include, but is not limited to, image data 222, pixel analysis data 224, point localization data 226, classification data 228, feature analysis data 230, and/or the like. The image data 222 may include, for example, data generated as a result of imaging processes completed by an imaging device 120, data provided from external image repositories, and/or the like, as described herein. Still referring to FIG. 19, the pixel analysis data 224 may generally be data that is generated as a result of one or more pixel analysis processes. The point localization data 226 may generally be data that is generated as the result of one or more point localization processes and/or data that is used for the purposes of executing one or more point localization processes. The classification data 228 may be data that is generated as a result of one or more classification processes and/or data that is used by one or more classification processes (e.g., reference data). The feature analysis data 230 may be data that is generated as a result of one or more feature analysis processes and/or data that is used by one or more feature analysis processes (e.g., reference data).

The types of data described herein with respect to one or more data storage devices 206 of the computer device 110 are merely illustrative, and that types of data may be used without departing from the scope of the present application. Furthermore, various types of data that are specific to other systems, devices, and/or components are also contemplated, such as data that is specific to the imaging device 120 and/or the like.

Network interface hardware 208 may generally provide the computer device 110 with an ability to interface with one or more external components of a network, including one or more devices coupled to a network via the Internet, an intranet, or the like. Communication with external devices may occur using various communication ports (not shown). An illustrative communication port may be attached to a communications network, such as the Internet, an intranet, a local network, a direct connection, and/or the like.

Device interface hardware 210 may generally provide the computer device 110 with an ability to interface with one or more imaging devices 120, including a direct interface (e.g., not via a network). Communication with such components may occur using various communication ports (not shown). An illustrative communication port may be attached to a communications network, such as the Internet, an intranet, a local network, a direct connection, and/or the like.

AI interface hardware 212 may generally provide the computer device 110 with an ability to interface with an artificial intelligence (AI) system, including a direct interface (e.g., not via a network). Communication with such components may occur using various communication ports (not shown). An illustrative communication port may be attached to a communications network, such as the Internet, an intranet, a local network, a direct connection, and/or the like.

User device interface hardware 214 may generally provide the computer device 110 with an ability to interface with a terminal device 140, including a direct interface (e.g., not via a network). Communication with such components may occur using various communication ports (not shown). An illustrative communication port may be attached to a communications network, such as the Internet, an intranet, a local network, a direct connection, and/or the like.

It should be understood that in some embodiments, the network interface hardware 208, the device interface hardware 210, the AI interface hardware 212, and/or the user device interface hardware 214 may be combined into a single device that allows for communications with other systems, devices, and/or components, regardless of location of such other systems, devices, and/or components.

It should be understood that the components illustrated in FIG. 30 are merely illustrative and are not intended to limit the scope of this disclosure. More specifically, while the components in FIG. 30 are illustrated as residing within the computer device 110, these are nonlimiting examples. In some embodiments, one or more of the components may reside external to computer device 110. Similarly, one or more of the components may be embodied in other computing devices not specifically described herein.

1. A method of understanding emotions, including static and dynamically changing emotional states, and from stored or live visual information, the method comprising the steps of:
obtaining a paired nonverbal and verbal information dataset consisting of nonverbal input and verbal input associated with the nonverbal input using uncurated data from daily communication;
using a subject-aware context encoding strategy to process the nonverbal input taking into account interaction between a subject of interest and a corresponding context;
using a text encoder to process the verbal input; and
training a machine learning model to learn a consistency between the nonverbal input and the associated verbal input by minimizing a sentiment-guided contrastive loss £ for understanding emotions.

2. The method according to claim 1, wherein the nonverbal input comprises facial expression, body language, and contextual environment, and the verbal input comprises utterance and dialogue.

3. The method according to claim 1, wherein using the subject-aware context encoding strategy comprises applying subject-aware attention masking (SAAM) which avoids redundant encoding.

4. The method according to claim 3, wherein applying subject-aware attention masking (SAAM) comprises modeling the subject of interest and the corresponding context in a synchronous way via the attention module
$${Attention}^{*} ( Q , K , V , U ) = {\underbrace{softmax ( \frac{{QK}^{⊤}}{\sqrt{d}} ) ( J - A ) V}}_{context} + {\underbrace{softmax ( \frac{{QK}^{⊤}}{\sqrt{d}} ) AUV}}_{subject} ,$$
where J is a matrix with all ones, A is a learnable parameters containing values in range [0,1], and U is a weight matrix constructed using P and is computed as the following:
$$U = softmax ( \frac{Q {K}^{⊤} + M}{\sqrt{d}} ) .$$
wherein the masking matrix M is defined as:
$$M = [ \begin{matrix}{M}^{( 1 )} & {M}^{( 2 )} \\ {M}^{( 3 )} & {M}^{( 4 )}\end{matrix} ] ,$$
where
$${M}^{( 1 )} = {0}_{( m + 1 ) \times ( m + 1 )} , {M}^{( 4 )} = {0}_{1 \times 1} , {M}_{i ∉ P}^{( 2 )} = {M}_{i ∉ P}^{( 3 )} = - ∞ , {M}_{( m + 1 )}^{( 3 )} = - ∞ ,$$
and all other entries are zero.

5. The method according to claim 1, wherein using the subject-aware context encoding strategy comprises applying subject-aware prompting (SAP) which enable adaptive modeling of interaction between the context and subject by providing necessary prompt indicating location of a subject in a frame.

6. The method according to claim 1, wherein the uncurated data is from human communication.

7. The method according to claim 1, wherein processing the nonverbal input comprises a method of bodily expressed emotion understanding (BEEU), comprising the steps of:
providing a BEEU dataset consisting of video clips each having emotion category labels;
providing a body motor elements dataset (BoME) consisting of a second set of video clips each annotated with motor element labels, the body motor elements having correspondence with emotion categories;
training a deep neural network on the BEEU dataset and the BoME dataset to recognize the body motor elements and use the body motor elements as intermediate features to recognize the emotion categories;
providing a dual-branch network structure including an emotion branch and a motor element branch, allowing the dual-branch network structure to output the motor element labels and the emotion category labels simultaneously;
deploying a fusion operation by adding the motor element labels as input to emotion recognition of the emotion branch, whereby the emotion category labels are predicted with the assistance of motor element branch; and
utilizing a bridge loss to allow the motor element labels to supervise emotion prediction, based on the correspondence between the body motor elements and the emotion categories.

8. The method according to claim 7, wherein the motor element labels are Laban Movement Analysis (LMA) element labels determined by applying Laban Movement Analysis to the video clips in the BoME.

9. A system, comprising a processing device and a non-transitory, computer-readable storage medium communicatively coupled to the processing device, the non-transitory, computer-readable storage medium comprising one or more programming instructions thereon that, when executed, cause the processing device to perform the method according to claim 1.

10. A non-transitory, computer-readable storage medium comprising programming instructions thereon that, when executed by a processing device, cause the processing device to perform the method according to claim 1.

11. A method of bodily expressed emotion understanding (BEEU), for both static and dynamically changing emotional states, and from stored or live visual information, using motor elements, the method comprising the steps of:
providing a BEEU dataset consisting of video clips each having emotion category labels;
providing a body motor elements dataset (BoME) consisting of a second set of video clips each annotated with motor element labels, the body motor elements having correspondence with emotion categories;
training a deep neural network on the BEEU dataset and the BoME dataset to recognize the body motor elements and use the body motor elements as intermediate features to recognize the emotion categories;
providing a dual-branch network structure including an emotion branch and a motor element branch, allowing the dual-branch network structure to output the motor element labels and the emotion category labels simultaneously;
deploying a fusion operation by adding the motor element labels as input to emotion recognition of the emotion branch, whereby the emotion category labels are predicted with the assistance of motor element branch; and
utilizing a bridge loss to allow the motor element labels to supervise emotion prediction, based on the correspondence between the body motor elements and the emotion categories.

12. The method according to claim 11, wherein the motor element labels are Laban Movement Analysis (LMA) element labels determined by applying Laban Movement Analysis to the video clips in the BoME.

13. The method according to claim 12, wherein the element labels comprise eleven LMA element labels and each label is assigned a discrete value from a multi-value scale.

14. The method according to claim 11, further comprising using a threshold in the bridge loss to control an extent to which the motor element labels supervises the emotion prediction.

15. The method according to claim 11, wherein the deep neural network comprises a video recognition network for estimation of body motor elements on the BoME dataset.

16. The method according to claim 15, wherein the video recognition network includes RGB-based or skeleton-based algorithms.

17. A system, comprising a processing device and a non-transitory, computer-readable storage medium communicatively coupled to the processing device, the non-transitory, computer readable storage medium comprising one or more programming instructions thereon that, when executed by the processing device, cause the processing device to perform the method according to claim 11.

18. The method according to claim 1, wherein the paired nonverbal and verbal information dataset comprises information from multiple subjects of interest, and the method is a method of context-aware emotion recognition allowing for simultaneous processing of multiple subjects of interest within a single image, the method of context-aware emotion recognition comprising:
processing an image frame from a video clip to extract spatial features in a single operation, regardless of the number of subjects of interest present within the image frame;
embedding positional information of each subject of interest in the image;
retrieving relevant spatial features in a parallel manner for each subject and context query from the image, by a cross-attention operation, the embedded positional prompts serving to direct a decoder to correspond to the specific subject of interest and discriminate it from others present in the image, thereby using a single self-attention operation to capture both inter-subject and subject-context dynamics.

19. A method of context-aware emotion recognition, for both static and dynamically changing emotional states, and from stored or live visual information, in an uncontrolled real-world setting allowing for simultaneous processing of multiple subjects of interest within a single image, comprising the steps of:
processing the entire image, or an image frame from a video, to extract spatial features in a single operation, regardless of the number of subjects of interest present within the image;
embedding positional information of each subject of interest in the image;
retrieving relevant spatial features in a parallel manner for each subject and context query from the image, by a cross-attention operation, the embedded positional prompts serving to direct a decoder to correspond to the specific subject of interest and discriminate it from others present in the image, thereby using a single self-attention operation to capture both inter-subject and subject-context dynamics.

20. A system for context-aware emotion recognition in an uncontrolled real-world setting allowing for simultaneous processing of multiple subjects of interest within a single image, comprising:
transformers representing a class of neural networks that rely on attention mechanisms, including:
a unified encoder, including:
an image encoder for extracting spatial features of the entire image in a single operation, regardless of the number of subjects of interest present within the image;
a prompt encoder embedding the positional information of each subject of interest in the image; and
a context-aware decoder configured to simultaneously decode emotions of all subjects in a parallel manner using the spatial features and positional prompts.
